(19) United States
(12) Patent Application Publication
(10) Pub. No.: US 2011/0026593 A1
(43) Pub. Date: Feb. 3, 2011

(54) IMAGE PROCESSING APPARATUS, IMAGE PROCESSING METHOD, PROGRAM AND INTEGRATED CIRCUIT

(76) Inventors: Wei Lee New, Singapore (SG); Viktor Wahadaniah, Singapore (SG); Chong Soon Lim, Singapore (SG); Michael Bi Mi, Singapore (SG); Takeshi Tanaka, Osaka (JP); Takaaki Imanaka, Osaka (JP)

Correspondence Address: WENDEROTH, LIND & PONACK L.L.P., 1030 15th Street, N.W., Suite 400 East, Washington, DC, 20005-1503, US

(21) Appl. No.: 12/936,528

(22) PCT Filed: Jan. 14, 2010
(86) PCT No.: PCT/JP2010/000179

§ 371 Date: Oct. 6, 2010

(30) Foreign Application Priority Data
Feb. 10, 2009 (JP) 2009-029032
Feb. 13, 2009 (JP) 2009-031506

(51) Int. Cl. H04N 11/04

(52) U.S. Cl. 375/240.12; 375/E07.243; 375/E07.026

(57) ABSTRACT

An image processing apparatus (10) capable of reducing the bandwidth and capacity required for a frame memory and preventing image quality degradation includes: a selecting unit (14) that selectively switches between first and second processing modes, a frame memory (12); a storing unit (11) that (i) down-samples an input image by deleting predetermined frequency information included in the input image and stores the input image as a down-sampled image in the frame memory (12) when the switching unit switches to the first processing mode, and (ii) stores the input image without down-sampling in the frame memory (12) when the switching unit switches to the second processing mode; and a reading unit (13) that (i) reads out the down-sampled image from the frame memory (12) and up-samples the down-sampled image when the switching unit switches to the first processing mode, and (ii) reads out the input image without down-sampling from the frame memory (12) when the switching unit switches to the second processing mode.

### TECHNICAL FIELD

The present invention relates to image processing apparatuses which process plural images sequentially, and in particular to an image processing apparatus which has functions of storing images in a memory and reading the images stored in the memory.

### BACKGROUND ART

An image processing apparatus which has functions of storing is images in a frame memory and reading the images stored in the frame memory is provided with, for example, an image decoding apparatus such as a video decoder which decodes a bitstream compressed according to video coding standards such as H.264. In addition, such image decoding apparatus is used for a digital high definition television, a video conferencing system, and the like.

High definition video is created using pictures each having a 1920×1080 pixel size, that is, pictures each including 2,073,600 pixels. A high definition decoder requires an additional memory, and thus is considerably more expensive than a standard definition (SDTV) decoder.

In addition, video coding standards such as H.264, VC-1, and MPEG-2 support high definition. Recent years have seen a wide spread use of the H.264 video coding standard in various systems.

This standard allows provision of good image quality at substantially lower bit rates than the MPEG-2 standard that has been conventionally widely used. For example, a bit rate in H.264 is approximately the half of a bit rate in MPEG-2. However, the H.264 video coding standard increases complexities in algorithm in order to achieve a low bit rate. As a result, the H.264 video coding standard requires a considerably higher frame memory bandwidth and frame memory capacity than those required in conventional standards. It is important to reduce the frame memory bandwidth and frame memory capacity required to decode high definition video in order to implement inexpensive image decoding apparatuses which support the H.264 video coding standard. Stated differently, it is required to implement inexpensive image processing apparatuses which reduce the bandwidth required for the frame memory (the bandwidth for access to the frame memory) and the frame memory capacity without degrading image quality.

One method of implementing an inexpensive image decoding apparatus is a method called down-decoding.

FIG. 47 is a block diagram showing a functional structure of a typical image decoding apparatus which down-decodes high definition video.

This image decoding apparatus 1000 supports the H.264 video coding standard. The image decoding apparatus 1000 includes a syntax parsing and entropy decoding unit 1001, an inverse quantization unit 1002, an inverse frequency transform unit 1003, an intra-prediction unit 1004, an adding unit 1005, a deblocking filter unit 1006, a compressing unit 1007, a frame memory 1008, an expanding unit 1009, a full resolution motion compensation unit 1010, and a video output unit 1011. Here, the image processing apparatus includes the compressing unit 1007, the frame memory 1008, and the expanding unit 1009.

The syntax parsing and entropy decoding unit 1001 obtains a bitstream, and performs syntax parsing and entropy decoding on the bitstream. The entropy decoding may include variable length decoding (VLC) and arithmetic coding (such as CABAC: Context-based Adaptive Binary Arithmetic Coding). The inverse quantization unit 1002 obtains entropy decoded coefficients that are output from the syntax parsing and entropy decoding unit 1001, and inversely quantizes the obtained entropy decoded coefficients. The inverse frequency transform unit 1003 generates a difference image by performing inverse discrete cosine transform on the inversely quantized entropy decoded coefficients.

When an inter-prediction is performed, the adding unit 1005 generates a decoded image by adding an inter-prediction image that is output from the full resolution motion compensation unit 1010 to the difference image that is output from the inverse frequency transform unit 1003. On the other hand, when an intra-prediction is performed, the adding unit 1005 generates a decoded image by adding an intra-prediction image that is output from the intra-prediction unit 1004 to the difference image that is output from the inverse frequency transform unit 1003.

The deblocking filter unit 1006 performs deblocking filtering on the decoded image to reduce block noise.

The compressing unit 1007 performs compressing processing. More specifically, the compressing unit 1007 compresses the deblocking filtered decoded image into an image having a low resolution, and writes the compressed decoded image as a reference image into the frame memory 1008. The frame memory 1008 has an area for storing plural reference images.

The expanding unit 1009 performs expanding processing. More specifically, the expanding unit 1009 reads out a reference image stored in the frame memory 1008, and expands the reference image into an image having the original high resolution (the pre-compression resolution of the decoded image).

The full resolution motion compensation unit 1010 generates an inter-prediction image using a motion vector that is output from the syntax parsing and entropy decoding unit 1001 and a reference image expanded by the expanding unit 1009. When an intra-prediction is performed, the intra-prediction unit 1004 generates an intra-prediction image by performing an intra-prediction on a current block to be decoded using the adjacent pixels of the current block to be decoded.

The video output unit 1011 reads out, from the frame memory 1008, the compressed decoded image that has been stored as the reference image in the frame memory 1008. The video output unit 1011 then up-samples or down-samples the decoded image to have a resolution for output on a display, and displays the decoded image on the display.

In this way, the image decoding apparatus 1000 which performs down-decoding is capable of reducing the capacity and bandwidth required for the frame memory 1008 by compressing the decoded image and writing the compressed decoded image into the frame memory 1008. Stated differently, the image processing apparatus reduces the bandwidth and capacity required for the frame memory 1008 by compressing a reference image when storing it in the frame memory 1008, and expanding the compressed reference image when reading it out from the frame memory 1008.

A many number of methods have been proposed to perform down-decoding that enables reduction in the bandwidth and capacity required for a frame memory (for example, see PTL 1 and NPL 1).

Among many down-decoding methods, the down-decoding in PTL 1 has a possibility of achieving the theoretically minimum decoding error using DCT (Discrete Cosine Transform).

FIG. 48 is an illustration of down-decoding in NPL 1.

The expanding processing in this down-decoding includes performing low resolution DCT on a reference image block, and adding high frequency components indicating 0 to a group of coefficients composed of plural transform coefficients generated through the low resolution DCT. The expanding processing further includes performing full resolution (high resolution) IDCT (Inverse Discrete Cosine Transform) on the group of coefficients with high frequency components added thereto to up-sample the reference image block to be used for motion compensation. In short, the up-sampling of an image is used as the expanding processing in this down-decoding.

The compressing processing in the down-decoding includes performing full resolution DCT on a full resolution decoded image block, and deleting high frequency components from the group of coefficients composed of plural transform coefficients generated through the full resolution DCT. The compressing processing further includes down-sampling of the full resolution decoded image block by performing low resolution IDCT on the group of coefficients from which the high frequency components have been deleted, and storing the down-sampled decoded image block into the frame memory. In short, the down-sampling of an image is used as the compressing processing in this down-decoding.

According to the algorithm of such down-decoding, the low resolution down-sampled image (decoded image block) stored in the frame memory is up-sampled using the discrete cosine transform and the inverse discrete cosine transform before original resolution (full resolution) motion compensation is performed.

In addition, in the down-decoding of PTL 1, compressed data instead of the down-sampled image is stored in the frame memory.

Each of FIGS. 49A and 49B is an illustration of down-decoding in PTL 1.

A first memory manager and a second memory manager shown in FIG. 49A correspond to the compressing unit 1007 and the expanding unit 1009 as shown in FIG. 47, respectively. A first memory and a second memory as shown in FIG. 49A correspond to the frame memory 1008 shown in FIG. 47. Stated differently, the first and second memory managers and the first and second memories constitute the image processing apparatus. Hereinafter, the first memory manager and the second memory manager are generally called as memory managers.

When a memory manager performs compressing processing, it executes a step for error dispersion and a step of discarding one pixel per four pixels, as shown in FIG. 49B. First, the memory manager compresses a group of four pixels each indicated as having 32 bits (4 pixels×8 bits) into a group of four pixels each having 28 bits (4 pixels×7 bits) using a 1-bit error dispersion algorithm. Next, the memory manager further compresses the group of four pixels into a group of three pixels each having 7 bits by discarding one pixel from the group of four pixels according to a predetermined method. Furthermore, the memory manager adds 3 bits indicating a discarding method at the end of the group of four pixels. As a result, the 32-bit group of four pixels is compressed into a 24-bit group of four pixels (3 pixels×7 bits+3 bits).

### CITATION LIST

### Patent Literature

### [PTL 1]

U.S. Pat. No. 6,198,773

### [Non Patent Literature]

### [NPL 1]

“Minimal error drift in frequency scalability for motion-compensated DCT coding”, IEEE Transactions on Circuits and Systems for VIDEO Technology, vol. 4, no. 4, pp. 392-406, August, 1994.

### SUMMARY OF INVENTION

### Technical Problem

However, each of the image processing apparatuses provided to the image decoding apparatuses which perform down-decoding in NPL 1 and PTL 1 entails a problem of always degrading image quality.

More specifically, down-decoding according to NPL 1 is susceptible to influence of drift errors which are caused when previous images are referred to. The image decoding apparatus 1000 which performs down-decoding may allow superimposition of an error on a decoded image when performing the compressing processing and expanding processing that are not defined by any video coding standards. If a next image is decoded with reference to the decoded image on which the error is superimposed, the error is accumulated on the next and succeeding images to be decoded. The error that is accumulated in this way is called a drift error. More specifically, at the time of down-sampling of a high definition image, the down-decoding according to NPL 1 irreversibly discards high order transform coefficients (high frequency transform coefficients) which have been generated through DCT and may have high energy in the high definition image. Such down-sampling causes a considerable amount of loss in the high frequency component information. As a result, the decoded image includes a large error which causes a drift error.

Visual distortion in down-decoding appears especially in decoding according to the H.264 video coding standard due to existence of intra-prediction in the standard (See the H.264 Advanced video coding for generic audiovisual services, by ITU-T). The intra-prediction unique to H.264 is intended to generate a prediction image within a picture (intra-prediction image) using the neighboring pixels that surround a current block to be decoded and have already been decoded. The decoded neighboring pixels may include an error superimposed as mentioned earlier. If a pixel with superimposed error is used for intra-prediction, the error is generated in units of a block (4×4 pixels, 8×8 pixels, or 16×16 pixels) for which the prediction image is used. Even in the case where only one pixel includes an error in the decoded image, the use of the pixel in intra-prediction causes an error in units of a larger block composed of 4×4 pixels or the like, resulting in a block noise that is easily visible.

The down-decoding according to PTL 1 includes discarding LSBs (Least Significant Bits) in 1-bit error dispersion in the first step of the compressing processing, and thus information in a flat region is irreversibly lost. This degrades the image quality in the flat region (a flat region is an area composed of plural pixels having highly similar pixel values). Therefore, in the case of a long group of pictures (GOP) including many flat regions, such information loss may cause serious distortion in the resulting images.

The present invention has been conceived in view of this. The present invention has an object to provide image processing apparatuses and image processing methods which can reduce the bandwidth and capacity required for a frame memory, and concurrently prevent degradation in image quality.

### Solution to Problem

In order to achieve the aforementioned object, an image processing apparatus according to an aspect of the present invention is intended to sequentially process a plurality of input images, and includes: a selecting unit configured to selectively switch between a first processing mode and a second processing mode, for at least one input image; a frame memory; a storing unit configured to (i) down-sample one of the at least one input image by deleting predetermined frequency information included in the one of the at least one input image, and store the one of the at least one input image as a down-sampled image into the frame memory when the selecting unit switches to the first processing mode, and (ii) store the one of the at least one input image into the frame memory without down-sampling the one of the at least one input image when the selecting unit switches to the second processing mode; and a reading unit configured to (i) read out the down-sampled image from the frame memory and up-sample the down-sampled image when the selecting unit switches to the first processing mode, and (ii) read out the input image that is not down-sampled from the frame memory when the selecting unit switches to the second processing mode.

In this way, when the selecting unit switches to the first processing mode, the input image is down-sampled and stored in the frame memory, and the down-sampled input image is read out from the memory and up-sampled. Thus, it is possible to reduce the bandwidth and capacity required for the frame memory. On the other hand, when the selecting unit switches to the second processing mode, the input image is stored in the frame memory without being down-sampled, and the input image is read out as it is. Thus, it is possible to prevent the input image from being degraded in the image quality. Since the first processing mode and the second processing mode are selectively switched for at least one input image, it is possible to achieve a good balance between the prevention of degradation in the image quality of the plural input images as a whole, and reduction in the bandwidth and capacity required for the frame memory.

Furthermore, the image processing apparatus may further include a decoding unit configured to generate a decoded image by decoding a coded image included in a bitstream, with reference to, as a reference image, either the down-sampled image read out and up-sampled by the reading unit or the input image read out by the reading unit, wherein the storing unit may be configured to: down-sample the decoded image generated by the decoding unit and used as the input image and store the decoded image as the down-sampled image into the frame memory when the selecting unit switches to the first processing mode; and store the decoded image generated by the decoding unit and used as the input image into the frame memory without down-sampling the decoded image when the selecting unit switches to the second processing mode, and the selecting unit may be configured to selectively switch to either the first processing mode or the second processing mode, based on information related to the reference image and included in the bitstream.

In this way, the coded image included in the bitstream is decoded with reference to, as the reference image, either the down-sampled image that is stored in the frame memory or the input image. Thus, it is possible to use the image processing apparatus as the image decoding apparatus. The first processing mode and the second processing mode are selectively switched based on the information related to the reference image, that is, the number of reference frames included in the bitstream, or the like. Thus, it is possible to keep a good balance between the prevention of image quality degradation and reduction in the bandwidth and capacity required for the frame memory.

Furthermore, the storing unit may be configured to replace a part of data indicating pixel values of the down-sampled image with embedded data indicating at least a part of the deleted frequency information when storing the down-sampled image into the frame memory, and the reading unit may be configured to up-sample the down-sampled image by extracting the embedded data from the down-sampled image, restoring the deleted frequency information based on the embedded data, and adding the deleted frequency information to the down-sampled image from which the embedded data has been extracted.

In conventional down-decoding, a decoded image is down-sampled by deletion of high frequency components, and is stored as a reference image (down-sampled image) in a frame memory. When a coded image is decoded with reference to the reference image, the reference image is up-sampled by addition of high frequency components indicating 0 so that the up-sampled reference image is referred to in the decoding of the coded image. Accordingly, the high frequency components of the decoded image are deleted, and the decoded image from which high frequency components have been deleted is up-sampled excessively and is referred to as the reference image. This produces visual distortions that degrade the image quality. In contrast, according to an aspect of the present invention, even when high frequency components such as the high order transform coefficients are deleted as the predetermined frequency information, the embedded data such as variable length codes (coded high order transform coefficients) indicating at least a part of the deleted high order transform coefficients is embedded in the reference image (down-sampled image) as described above. When the reference image is used in the decoding of the coded image, the embedded data is extracted from the reference image to restore the high order transform coefficients, and the restored high order transform coefficients are used to up-sample the reference image. Accordingly, not all the high frequency components included in the decoded image are discarded, and a part of the high frequency components are included in the image referred to in the decoding of the coded image. Therefore, it is possible to reduce visual distortions in a new decoded image generated by the decoding, that is, it is possible to perform down-decoding and concurrently prevent image quality degradation. Furthermore, since the part of the data indicating the pixel values of the reference image is replaced with the embedded data, it is possible to reduce the capacity and bandwidth required for the frame memory without increasing the data amount of the reference image.

According to another aspect of the present invention, it is possible to obtain high-quality high-definition video by utilizing a digital watermarking technique to reduce errors that are generated by image down-sampling and information compression in down-decoding. A digital watermarking technique is intended to modify an image in order to embed machine-readable data into the image. The embedded data as the digital watermark cannot be or almost cannot be recognized by viewers. The embedded data is embedded as digital watermark by modifying a data sample of media content in a spatial domain, a temporal domain or any other transform domain (a Fourier transform domain, a discrete cosine transform domain, a wavelet transform domain, or the like). According to another aspect of the present invention, a reference image with digital watermark is stored in the frame memory instead of complex compressed data. Thus, the video output unit that extracts the reference image from the frame memory and outputs it does not need to perform any special expanding processing on the reference image.

Furthermore, the storing unit may be configured to replace, with the embedded data, a value indicated by one or more bits including at least an LSB (Least Significant Bit) in the data indicating the pixel value of the down-sampled image.

Replacing LSBs with the embedded data in this way makes it possible to minimize errors in the pixel value of the down-sampled image.

Furthermore, the storing unit may further include a coding unit configured to generate the embedded data by performing variable length coding on the high frequency components that are deleted by the deleting unit, and the restoring unit may be configured to restore the high frequency components from the embedded data by performing variable length decoding on the embedded data.

Performing variable length coding on the high frequency components in this way makes it possible to reduce the data amount of the embedded data. As a result, it is possible to minimize errors resulting from replacement with the embedded data in the pixel values of the reference image (down-sampled image).

Furthermore, the storing unit may further include a quantization unit configured to generate the embedded data by quantizing the high frequency components that are deleted by the deleting unit, and the restoring unit may be configured to restore the high frequency components from the embedded data by inversely quantizing the embedded data.

Quantizing the high frequency components in this way makes it possible to reduce the data amount of the embedded data. As a result, it is possible to minimize errors resulting from replacement with the embedded data in the pixel values of the reference image (down-sampled image).

Although replacement with the embedded data results in a loss of the part of data indicating the pixel values in this way, the replacement embedded data securely yield information greater in amount than the partly lost information, that is, produce information gain.

Furthermore, the extracting unit may be configured to extract the embedded data indicated by the at least one predetermined bit in the data composed of a bit string indicating the pixel value of the down-sampled image, and set the pixel value from which the embedded data has been extracted to a median value within a possible range for the bit string, according to a value of the at least one predetermined bit, and the second orthogonal transform unit may be configured to transform the down-sampled image having the pixel value set to the median value from a pixel domain to a frequency domain.

Setting, to 0, all of the at least one predetermined bit value from which the embedded data has been extracted may produce a significant error in the corresponding pixel value. However, according to the present invention, the pixel value is set to the median value within the possible range for each bit string according to the at least one predetermined bit value, and thus it is possible to prevent such a significant error in the pixel value.

Furthermore, the storing unit may be configured to determine, based on the down-sampled image, whether or not the part of the data indicating the pixel values of the down-sampled image should be replaced with the embedded data, and when determining that the replacement should be performed, replace the part of the data indicating the pixel values of the down-sampled image with the embedded data, and the reading unit may be configured to determine, based on the down-sampled image, whether or not the embedded data should be extracted, and when determining that the extraction should be performed, extract the embedded data from the down-sampled image and add the frequency information to the down-sampled image from which the embedded data has been extracted.

In the case of a down-sampled image that is flat and having a small number of edges, that is, a down-sampled image with a small number of high order transform coefficients, replacing a part of the data indicating the pixel values of the down-sampled image with embedded data may degrade the image quality more significantly than in the case of no replacement is performed. To prevent this, another aspect of the present invention is intended to switch to replacement with embedded data, depending on a down-sampled image. With this, it is possible to reduce degradation in the image quality of any down-sampled image.

An image processing apparatus according to another aspect of the present invention is intended to process plural input images sequentially. The image processing apparatus includes: a frame memory; a down-sampling unit configured to down-sample one of at least one input image by deleting predetermined frequency information included in each input image, and store the input image as a down-sampled image into the frame memory; and an up-sampling unit configured to read the down-sampled image from the frame memory, and up-sample it. The down-sampling unit is configured to replace a part of the data indicating the pixel values of the down-sampled image with embedded data indicating at least a part of the information of the deleted frequency information when storing the down-sampled image into the frame memory. The up-sampling unit is configured to up-sample the down-sampled image by extracting the embedded data from the down-sampled image, restoring the frequency information from the embedded data, and adding the frequency information to the down-sampled image from which the embedded data has been extracted.

In this way, even when high frequency components such as high order transform coefficients are deleted as predetermined frequency information, the embedded data such as variable length codes (coded high order transform coefficients) indicating at least the part of the deleted high order transform coefficients is embedded in the down-sampled image. When the down-sampled image is read out from the frame memory, the embedded data is extracted from the down-sampled image to restore the high order transform coefficients, and the high order transform coefficients are used to up-sample the down-sampled image. Accordingly, since the image is obtained by reading and up-sampling the down-sampled input image from which not all the high frequency components have been discarded, the thus obtained image includes a part of the high frequency components.

Therefore, it is possible to reduce the bandwidth and capacity required for the frame memory and concurrently prevent degradation in the image quality, without switching between the first and second processing modes as described earlier.

An image processing apparatus according to another aspect of the present invention is intended to sequentially process plural coded images included in a bitstream. The image processing apparatus includes: a frame memory configured to store reference images that are used to decode the coded images; a decoding unit configured to generate a decoded image by decoding each of the coded images with reference to an image obtained by up-sampling a corresponding one of the reference images; a down-sampling unit configured to down-sample each decoded image generated by the decoding unit by deleting predetermined frequency information included in the decoded image, and store the down-sampled decoded image as the reference image into the frame memory; and an up-sampling unit configured to read out the reference image from the frame memory and up-sample it. The down-sampling unit is configured to replace a part of the data indicating the pixel values of the reference image with embedded data indicating at least a part of the deleted frequency information when storing the reference image into the frame memory. The up-sampling unit is configured to up-sample the reference image by extracting the embedded data from the reference image, restoring the frequency information from the embedded data, and adding the frequency information to the reference image from which the embedded data has been extracted.

In this way, even when high frequency components such as high order transform coefficients are deleted as predetermined frequency information, the embedded data such as variable length codes (coded high order transform coefficients) indicating at least the part of the high order transform coefficients is embedded in the reference image. When the reference image is used in the decoding of the coded image, the embedded data is extracted from the reference image to restore the high order transform coefficients, and the high order transform coefficients are used to up-sample the reference image. Accordingly, not all the high frequency components included in the decoded image are discarded, and a part of the high frequency components are included in the image referred to in the decoding of the coded image. Therefore, it is possible to reduce visual distortions in a new decoded image generated by the decoding. As a result, it is possible to perform down-decoding and concurrently prevent degradation in image quality, without switching between the first and second processing modes as described above. Furthermore, since the part of the data indicating the pixel values of the reference image is replaced with the embedded data, it is possible to reduce the capacity and bandwidth required for the frame memory without increasing the data amount of the reference image.

It is to be noted that the present invention can be implemented not only as image processing apparatuses as such, but also as integrated circuits, image processing methods performed by the image processing apparatuses, programs causing a computer to execute the processes included in the methods, and recording media for storing the program.

### Solution to Problem

Image processing apparatuses according to the present invention provide advantageous effects of being able to reduce the bandwidth and capacity required for a frame memory, and concurrently prevent degradation in image quality.

### BRIEF DESCRIPTION OF DRAWINGS

FIG. 1 is a block diagram showing a functional structure of an image processing apparatus according to Embodiment 1 of the present invention.

FIG. 2 is a flowchart indicating operations performed by the image processing apparatus according to Embodiment 1.

FIG. 3 is a block diagram showing a functional structure of an image decoding apparatus according to Embodiment 2 of the present invention.

FIG. 4 is a flowchart indicating outline of processing operations performed by an embedding and down-sampling unit according to Embodiment 2.

FIG. 5 is a flowchart indicating coding of high order transform coefficients performed by the image processing apparatus according to Embodiment 2.

FIG. 6 is a flowchart indicating embedding of high order transform coefficients performed by the image processing apparatus according to Embodiment 2.

FIG. 7 is a diagram showing a table used by the image processing apparatus according to Embodiment 2 when performing variable length coding on the high order transform coefficients.

FIG. 8 is a flowchart indicating outline of processing operations performed by an extracting and up-sampling unit of the image processing apparatus according to Embodiment 2.

FIG. 9 is a flowchart indicating extracting and restoring of high order transform coefficients performed by the image processing apparatus according to Embodiment 2.

FIG. 10 is a diagram showing a specific example of processing operations performed by the embedding and down-sampling unit of the image processing apparatus according to Embodiment 2.

FIG. 11 is a diagram showing a specific example of processing operations performed by the extracting and up-sampling unit of the image processing apparatus according to Embodiment 2.

FIG. 12 is a block diagram showing a functional structure of an image decoding apparatus according to a Variation of Embodiment 2.

FIG. 13 is a flowchart indicating operations performed by a selecting unit according to the Variation of Embodiment 2.

FIG. 14 is a flowchart indicating embedding coded high order transform coefficients performed by an embedding and down-sampling unit according to Embodiment 3 of the present invention.

FIG. 15 is a flowchart indicating extracting and restoring of high order transform coefficients by the extracting and up-sampling unit of the image processing apparatus according to Embodiment 3.

FIG. 16 is a block diagram showing a functional structure of an image decoding apparatus according to Embodiment 4 of the present invention.

FIG. 17 is a block diagram showing a functional structure of a video output unit of the image decoding apparatus according to Embodiment 4.

FIG. 18 is a flowchart indicating operations performed by the video output unit of the image decoding apparatus according to Embodiment 4.

FIG. 19 is a block diagram showing a functional structure of the image decoding apparatus according to a Variation of Embodiment 4.

FIG. 20 is a block diagram showing a functional structure of a video output unit of the image decoding apparatus according to the Variation of Embodiment 4.

FIG. 21 is a flowchart indicating operations performed by the video output unit according to the Variation of Embodiment 4.

FIG. 22 is a structural diagram showing a structure of a system LSI according to Embodiment 5 of the present invention.

FIG. 23 is a structural diagram showing a structure of a system LSI according to a Variation of Embodiment 5.

FIG. 24 is a block diagram indicating outline of a video decoder having a reduced memory according to Embodiment 6 of the present invention.

FIG. 25 is a schematic diagram related to a preparser which performs a sufficiency check on a reduced DPB to determine a video decoding modes (full resolution or decoding resolution) for a picture with respect to both in the higher parameter layer and the lower parameter layer according to Embodiment 6.

FIG. 26 is a flowchart of the sufficiency check on the reduced DPB for a lower layer syntax according to Embodiment 6.

FIG. 27 is a flowchart of look-ahead information generation (Step SP245) according to Embodiment 6.

FIG. 28 is a flowchart of storage of an on-time removal instance (Step SP2453) according to Embodiment 6.

FIG. 29 is a flowchart of a check (Step SP246) based on conditions to check the execution possibility of a full decoding mode according to Embodiment 6.

FIG. 30 is an example 1 of a sufficiency check on a reduced DPB for an exemplary lower layer syntax according to Embodiment 6.

FIG. 31 is an example 2 of a sufficiency check on a reduced DPB for an exemplary lower layer syntax according to Embodiment 6.

FIG. 32 is a schematic diagram of operations in Embodiment 6 in which either full resolution video decoding or reduced resolution video decoding is performed using a list of information indicating video decoding modes of all frames related to decoding of a frame supplied by the preparser according to Embodiment 6.

FIG. 33 is a schematic diagram of an exemplary down-sampling unit according to Embodiment 6.

FIG. 34 is a flowchart of coding of high order transform coefficients used by the exemplary down-sampling unit according to Embodiment 6.

FIG. 35 is a flowchart of a check for embedment of high order transform coefficients that are used in the exemplary down-sampling unit according to Embodiment 6.

FIG. 36 is a flowchart of embedding plural LSBs of pixels to be down-sampled by the exemplary down-sampling unit according to Embodiment 6 with VLC codes indicating high order transform coefficients.

FIG. 37 is an exemplary illustration for transform coefficient characteristics of four pixel lines each having even or odd characteristics according to Embodiment 6.

FIG. 38 is a schematic diagram of an exemplary up-sampling unit according to Embodiment 6.

FIG. 39 is a flowchart of an extraction check of high order transform coefficient information used in the exemplary down-sampling unit according to Embodiment 6.

FIG. 40 is a flowchart of decoding of high order transform coefficients used by the exemplary down-sampling unit according to Embodiment 6.

FIG. 41 is an exemplary illustration of quantization, VLC, and spatial digital watermarking methods for 4→3 down-decoding used in the exemplary down-sampling unit according to Embodiment 6.

FIG. 42 is a diagram showing an alternative simplified implementation of a video decoder that includes a reduced memory and does not require the preparser according to Embodiment 6.

FIG. 43 is a schematic diagram of an alternative simplified implementation of performing syntax parsing only on the higher parameter layer information for the DPB sufficiency check according to Embodiment 6.

FIG. 44 is a schematic diagram of operations in an alternative embodiment of performing either full resolution video decoding or reduced resolution video decoding using a list of information indicating video decoding modes for all frames related to decoding of a frame supplied by a syntax parsing and coding unit of the decoder itself according to Embodiment 6.

FIG. 45 is an exemplary illustration of an implementation of a system LSI according to Embodiment 6.

FIG. 46 is an exemplary illustration of an implementation of an alternative simplified system LSI that determines decoding modes each indicating either full resolution or reduced resolution without using any preparser, according to Embodiment 6.

FIG. 47 is a block diagram showing a functional structure of a conventional typical image decoding apparatus.

FIG. 48 is an illustration of down-decoding according to the conventional typical image decoding apparatus.

FIG. 49A is an illustration of other down-decoding according to the conventional typical image decoding apparatus.

FIG. 49B is an illustration of other down-decoding according to the conventional typical image decoding apparatus.

### DESCRIPTION OF EMBODIMENTS

An image processing apparatus according to Embodiments of the present invention will be described below with reference to the drawings.

### Embodiment 1

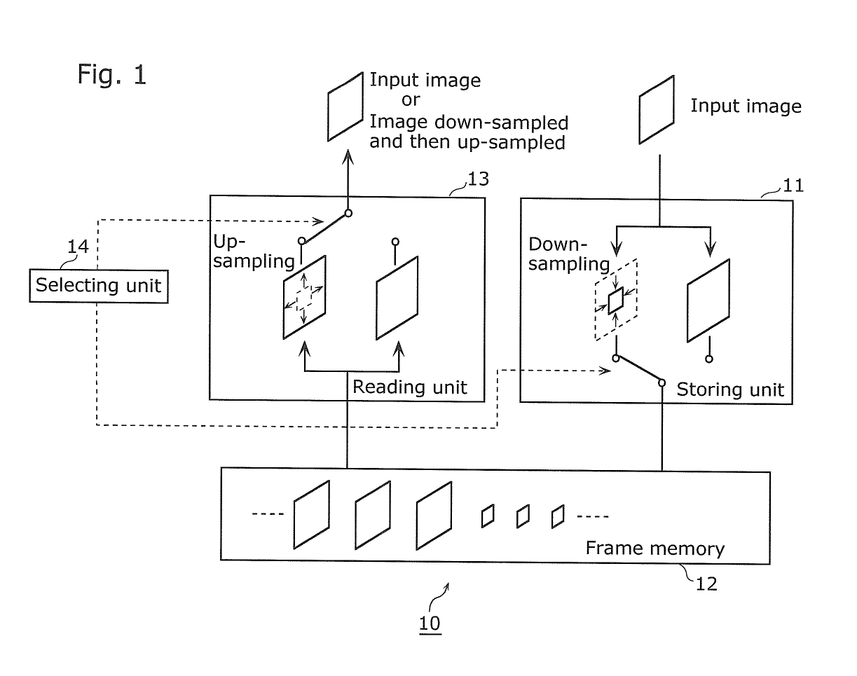

FIG. 1 is a block diagram showing a functional structure of an image processing apparatus according to this Embodiment.

The image processing apparatus 10 in this Embodiment is intended to process plural input images sequentially, and includes a storing unit 11, a frame memory 12, a reading unit 13, and a selecting unit 14.

The selecting unit 14 selectively switches between a first processing mode and a second processing mode for at least one input image. For example, the selecting unit 14 selects one of the first and second processing modes, based on a feature and nature of the input image, information related to the input image, and the like.

The storing unit 11 down-samples the input image by deleting information of predetermined frequencies (for example, high frequency components) included in the input image in the case where the selecting unit 14 switches to the first processing mode, and stores the input image as a down-sampled image into the frame memory 12. On the other hand, in the case where the selecting unit 14 switches to the second processing mode, the storing unit 11 stores the input image into the frame memory 12 without down-sampling the input image.

The reading unit 13 reads out the down-sampled image from the frame memory 12 and up-samples it in the case where the selecting unit 14 switches to the first processing mode. On the other hand, in the case where the selecting unit 14 switches to the second processing mode, the storing unit 11 reads out the input image that has not been down-sampled from the frame memory 12.

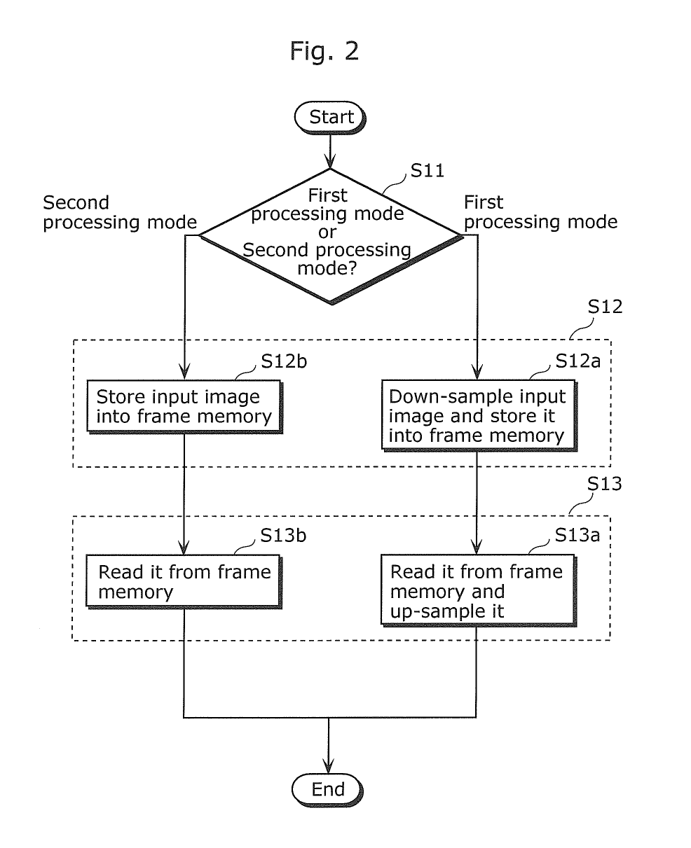

FIG. 2 is a flowchart indicating operations performed by the image processing apparatus 10 according to this Embodiment.

First, the selecting unit 14 of the image processing apparatus 10 selects either the first processing mode or the second processing mode (Step S11). Next, the storing unit 11 stores the input image into the frame memory 12 (Step S12). Stated differently, in the case where the switching is performed to the first mode in Step S11, the storing unit 11 down-samples the input image and stores the input image as the down-sampled image into the frame memory 12 (Step S12a). In the opposite case where the switching is performed to the second processing mode in Step S11, the storing unit 11 stores the input image into the frame memory 12 without down-sampling it (Step S12b).

Further, the reading unit 13 reads out the image from the frame memory 12 (Step S13). More specifically, the reading unit 13 reads out the down-sampled image stored in Step S12a from the frame memory 12 when the switching is performed to the first processing mode in Step S11 (Step S13a), and reads out the input image stored in Step S12b without being down-sampled when the switching is performed to the second processing mode in Step S11 (Step S13b).

In this Embodiment, the input image is down-sampled and stored in the frame memory 12 when the switching is performed to the first processing mode, and the down-sampled input image is up-sampled when the down-sampled input image is read out. In this way, it is possible to reduce the bandwidth and capacity required for the frame memory. In this Embodiment, the input image is stored in the frame memory 12 without being down-sampled when the switching is performed to the second processing mode, and the input image is read out as it is. The input image that is stored into and read out from the frame memory 12 is not down-sampled and up-sampled in this way. Thus, it is possible to prevent the input image from degrading in the image quality.

In short, it is possible to prevent the input image from degrading in the image quality by storing the input image into and reading it out from the frame memory as it is. However, this requires a frame memory with a wider bandwidth and a larger capacity. In contrast, it is possible to reduce the bandwidth and capacity required for the frame memory by always down-sampling or compressing the input image and up-sampling or expanding the input image as conventionally when storing it into and reading it out from the frame memory. However, this results in a degradation in the image quality of the input image.

In this Embodiment, the first processing mode and the second processing mode are selectively switched for at least one input image. This makes it possible to achieve a good balance between the prevention of degradation in the image quality of the plural input images as a whole, and reduction in the bandwidth and capacity required for the frame memory.

It is to be noted that the method of down-sampling an input image by the storing unit 11 and the method of up-sampling the down-sampled image by the reading unit 13 in this Embodiment may be the methods disclosed in the PTL 1 or NPL 1, or any other methods.

### Embodiment 2

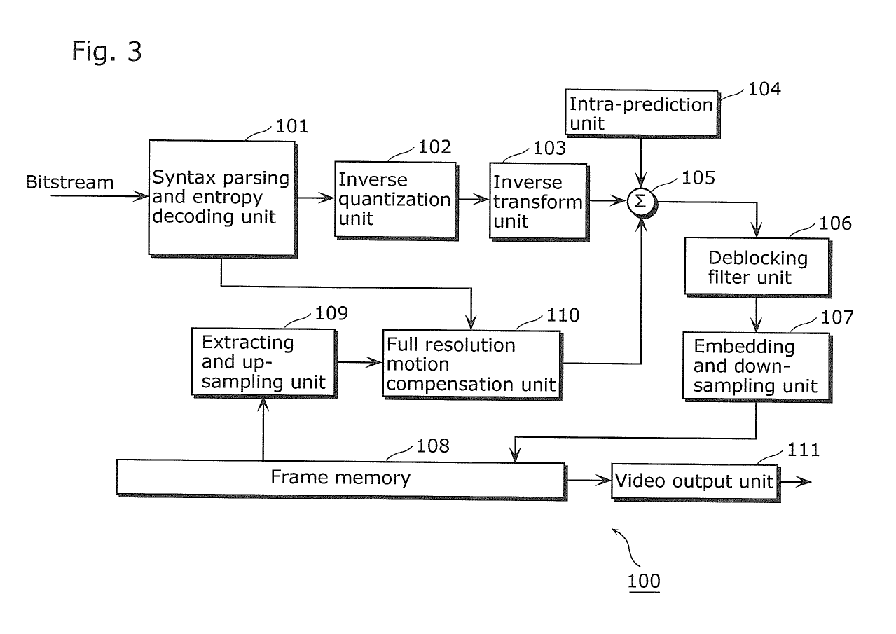

FIG. 3 is a block diagram showing a functional structure of an image decoding apparatus according to this Embodiment.

The image decoding apparatus 100 in this Embodiment supports the H.264 video coding standard. The image decoding apparatus 100 includes: a syntax parsing and entropy decoding unit 101, an inverse quantization unit 102, an inverse frequency transform unit 103, an intra-prediction unit 104, an adding unit 105, a deblocking filter unit 106, an embedding and down-sampling unit 107, a frame memory 108, an extracting and up-sampling unit 109, a full resolution motion compensation unit 110, and a video output unit 111.

The image decoding apparatus 100 in this Embodiment is characterized in processing performed by the embedding and down-sampling unit 107 and the extracting and up-sampling unit 109.

The syntax parsing and entropy decoding unit 101 obtains a bitstream representing plural coded images, and performs syntax parsing and entropy decoding on the bitstream. The entropy decoding may involve variable length decoding (VLC) and arithmetic coding (such as CABAC: Context-based Adaptive Binary Arithmetic Coding).

The inverse quantization unit 102 obtains entropy decoded coefficients that are output from the syntax parsing and entropy decoding unit 101, and inversely quantizes the obtained entropy decoded coefficients.

The inverse frequency transform unit 103 generates a difference image by performing inverse discrete cosine transform on the inversely quantized entropy decoded coefficients.

When an inter-prediction is performed, the adding unit 105 generates a decoded image by adding an inter-prediction image that is output from the full resolution motion compensation unit 110 to the difference image that is output from the inverse frequency transform unit 103. On the other hand, when an intra-prediction is performed, the adding unit 105 generates a decoded image by adding an intra-prediction image that is output from the intra-prediction unit 104 to the difference image that is output from the inverse frequency transform unit 103.

The deblocking filter unit 106 performs deblocking filtering on the decoded image to reduce block noise.

The embedding and down-sampling unit 107 performs down-sampling. More specifically, the embedding and down-sampling unit 107 generates a down-sampled decoded image having a low resolution by down-sampling the decoded image on which deblocking filtering has been performed. Furthermore, the embedding and down-sampling unit 107 writes the down-sampled decoded image as a reference image into the frame memory 108. The frame memory 108 has an area for storing plural reference images. Furthermore, the embedding and down-sampling unit 107 according to this Embodiment is characterized in generating a reference image by embedding coded high order transform coefficients (Embedded data) obtained by performing quantization and variable length coding on high order transform coefficients into the down-sampled decoded image as described later. The processing performed by the embedding and down-sampling unit 107 in this Embodiment is hereinafter referred to as embedding and down-sampling processing.

The extracting and up-sampling unit 109 performs expanding processing. More specifically, the extracting and up-sampling unit 109 reads out a reference image stored in the frame memory 108, and up-samples the reference image into an image having the original resolution (resolution of the decoded image that has not yet been up-sampled). Furthermore, the extracting and up-sampling unit 109 according to this Embodiment is characterized by extracting the coded high order transform coefficients embedded in the reference image, restoring the high order transform coefficients from the coded high order transform coefficients, and adds the high order transform coefficients to the reference image from which the coded high order transform coefficients have been extracted. The processing performed by the extracting and up-sampling unit 109 according to this Embodiment is hereinafter referred to as extracting and up-sampling processing.

The full resolution motion compensation unit 110 generates an inter-prediction image using a motion vector that is output from the syntax parsing and entropy decoding unit 101 and a reference image up-sampled by the extracting and up-sampling unit 109. When an intra-prediction is performed, the intra-prediction unit 104 generates an intra-prediction image by performing an intra-prediction on a current block to be decoded using the adjacent pixels of the current block to be decoded (that is, the block to be decoded in a coded image).

The video output unit 111 reads out the reference image stored in the frame memory 108, up-samples or down-samples the reference image to have a resolution for output on the display, and displays it on the display.

The following is a detailed description given of processing operations by the embedding and down-sampling unit 107 and the extracting and up-sampling unit 109 according to this Embodiment.

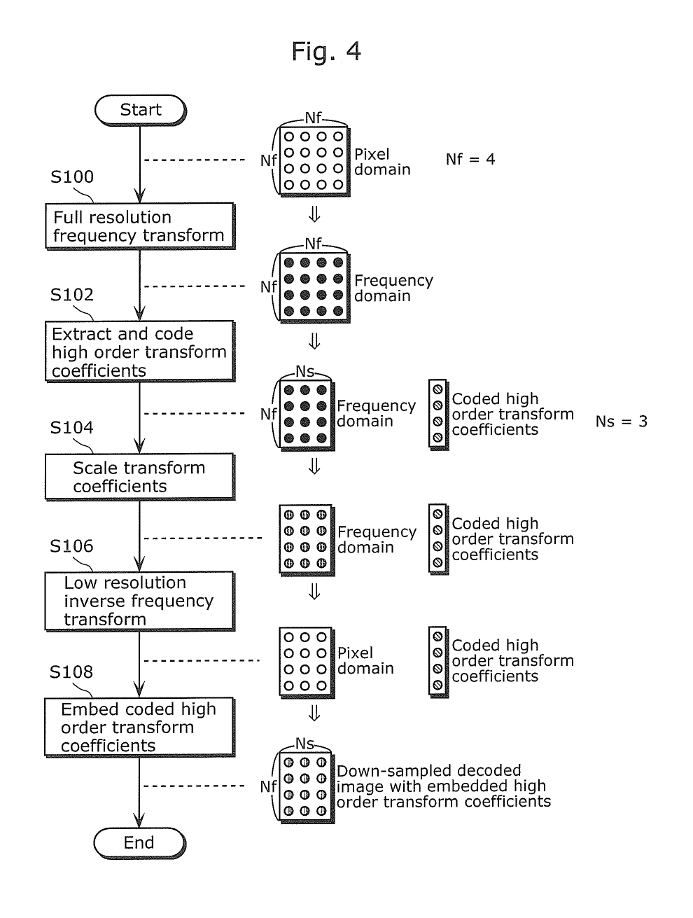

FIG. 4 is a flowchart indicating outline of processing operations performed by an embedding and down-sampling unit 107 according to this Embodiment.

First, the embedding and down-sampling unit 107 performs full resolution (high resolution) frequency transform (specifically, orthogonal transform such as DCT) on the decoded image in a pixel domain to obtain a group of coefficients in a frequency domain made of plural transform coefficients (Step S100). Stated differently, the embedding and down-sampling unit 107 performs full resolution DCT on the decoded image including Nf×Nf pixels to generate a decoded image represented by the group of coefficients of the frequency domain including Nf×Nf transform coefficients, that is, a decoded image represented by the frequency domain. Here, Nf is 4, for example.

Next, the embedding and down-sampling unit 107 extracts the high order transform coefficients (high frequency transform coefficients) from the group of coefficients in the frequency domain, and codes the high order transform coefficients (Step S102). Stated differently, the embedding and down-sampling unit 107 generates the coded high order transform coefficients by extracting the (Nf−Ns)×Nf number of high order transform coefficients representing high frequency components from the group of coefficients including Nf×Nf transform coefficients, and codes the high order transform coefficients. Here, Nf is 3, for example.

Furthermore, the embedding and down-sampling unit 107 scales the Ns×Nf transform coefficients in the frequency domain in order to perform low frequency inverse frequency transform in the next step to adjust gain of these transform coefficients (Step S104).

Next, the embedding and down-sampling unit 107 performs low resolution inverse frequency transform (specifically, inverse orthogonal transform such as IDCT) on the scaled Ns×Nf transform coefficients to obtain low resolution down-sampled decoded image represented in the pixel domain (Step S106).

Furthermore, the embedding and down-sampling unit 107 generates a reference image by embedding the coded high order transform coefficients obtained in Step S102 into low resolution down-sampled decoded image (Step S108).

The decoded image including Nf×Nf pixels is down-sampled to have a low resolution, that is, is transformed to be a reference image including Ns×Nf pixels through the processes. In short, the decoded image having Nf×Nf pixels is down-sampled only in the horizontal direction.

The embedding and down-sampling unit 107 in this Embodiment includes a first orthogonal transform unit which executes processing in Step S100, a deleting unit, a coding unit, and quantization unit which execute processing in Step S102, a first inverse orthogonal transform unit which executes processing in Step S106, and an embedding unit which executes processing in Step S108.

Here, detailed descriptions are given of DCT performed in Step S100 and IDCT performed in Step S106.

Two-dimensional DCT performed on the decoded image including N×N pixels is defined according to Math. (Expression) 1 shown below.

$$F ( u , v ) = \frac{2}{N} C ( u ) C ( v ) {\sum }_{x = 0}^{N - 1} {\sum }_{y = 0}^{N - 1} f ( x , y ) cos \frac{( 2 x + 1 ) u π}{2 N} cos \frac{( 2 y + 1 ) v π}{2 N} \qquad [ Math . 1 ]$$

In Expression 1, a condition of u, v, x, y=0, 1, 2, . . . , N−1 is satisfied, x and y are spatial coordinates in the pixel domain, and u and v are frequency coordinates in the frequency domain. In addition, each of C(u) and C(v) satisfies a condition of the following Math. (Expression) 2

$$C ( u ) , C ( v ) = \{ \begin{matrix}\frac{1}{\sqrt{2}} & u , v = 0 \\ 1 & otherwise\end{matrix} \qquad [ Math . 2 ]$$

Further, the two-dimensional IDCT (Inverse Discrete Cosine Transform) is defined as shown in the following Math. (Expression) 3

$$f ( x , y ) = \frac{2}{N} {\sum }_{u = 0}^{N - 1} {\sum }_{v = 0}^{N - 1} C ( u ) C ( v ) F ( u , v ) cos \frac{( 2 x + 1 ) u π}{2 N} cos \frac{( 2 y + 1 ) v π}{2 N} \qquad [ Math . 3 ]$$

It is to be noted that f(x, y) is a real number in Expression 3.

There is a need to perform two-dimensional DCT according to the above Expression 1 when down-sampling a decoded image in both the horizontal direction and vertical direction. However, it is only necessary to perform one-dimensional DCT when down-sampling a decoded image only in the horizontal direction, and Expression 1 is represented by the following Math. (Expression) 4.

$$F ( u ) = \frac{2}{N} C ( u ) {\sum }_{x = 0}^{N - 1} f ( x ) cos \frac{( 2 x + 1 ) u π}{2 N} \qquad [ Math . 4 ]$$

Stated differently, in this Embodiment, the embedding and down-sampling unit 107 performs one-dimensional DCT based on Expression 4 and N=Nf in Step S100 in order to down-sample the decoded image only in the horizontal direction.

Likewise, in the case of one-dimensional IDCT, Expression 3 is represented by Math. (Expression) 5

$$f ( x ) = \frac{2}{N} {\sum }_{u = 0}^{N - 1} C ( u ) F ( u ) cos \frac{( 2 x + 1 ) u π}{2 N} \qquad [ Math . 5 ]$$

Stated differently, in this Embodiment, the embedding and down-sampling unit 107 performs one-dimensional IDCT based on Expression 5 and N=Ns in Step S106 in order to down-sample the decoded image only in the horizontal direction. In this way, the decoded image including Ns×Nf pixels down-sampled in the horizontal direction is generated as a down-sampled decoded image.

Next, a detailed description is given of extracting and coding high order transform coefficients in Step S102.

The high order transform coefficients to be extracted are obtained as a result of DCT operation, and the number of high order transform coefficients is represented by Nf−Ns in the horizontal direction. More specifically, the high order transform coefficients to be extracted and coded are coefficients within a range from (Ns+1)-th to Nf-th from among the Nf transform coefficients in the horizontal direction.

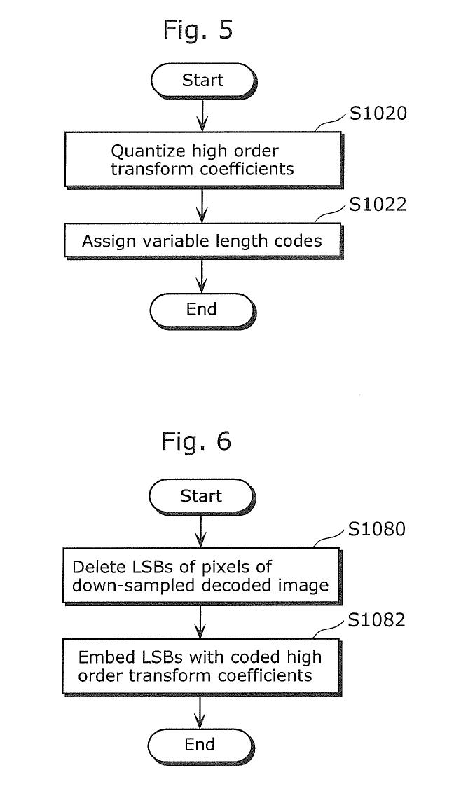

FIG. 5 is a flowchart indicating coding of high order transform coefficients in Step S102 of FIG. 4.

First, the embedding and down-sampling unit 107 quantizes the high order transform coefficients (Step S1020). Next, the embedding and down-sampling unit 107 performs variable length coding on the quantized high order transform coefficients (quantized values) (Step S1022). Stated differently, the embedding and down-sampling unit 107 assigns variable length codes as coded high order transform coefficients to the quantized values. Such quantization and variable length coding are detailed later together with embedment of coded high order transform coefficients in Step S108.

Next, a detailed description is given of scaling of transform coefficients performed in Step S104.

1/block size scaling is performed in a combination of DCT and IDCT. Thus, the embedding and down-sampling unit 107 scales each of the transform coefficients in order to adjust the gain before obtaining Ns−point IDCT pixel values of Nf−point DCT low frequency coefficients. In this case, the embedding and down-sampling unit 107 scales each of the transform coefficients using values calculated according to the following Math. (Expression) 6. Such scaling is detailed in the document “Minimal Error Drift in Frequency Scalability for MOTION—Compensated DCT coding”, Robert Mokry, and Dimitris Anastassiou, IEEE Transactions on Circuits and Systems for VIDEO Technology.

$$\sqrt{\frac{Ns}{Nf}} \qquad [ Math . 6 ]$$

Next, a detailed description is given of embedment of coded high order transform coefficients performed in Step S108.

The embedding and down-sampling unit 107 in this Embodiment embeds coded high order transform coefficients generated in Step S102 into the down-sampled decoded image including Ns×Nf pixels obtained in Step S106, using a spatial watermarking technique.

FIG. 6 is a flowchart indicating embedding of the high order transform coefficients in Step S108 of FIG. 4.

The embedding and down-sampling unit 107 deletes a value represented by bits whose numbers are determined depending on the code length of the coded high order transform coefficients in the bit string representing the pixel value of the down-sampled decoded image. At this time, the embedding and down-sampling unit 107 deletes the value represented by the lower bits including at least the LSBs (Least Significant Bits) (Step S1080). Next, the embedding and down-sampling unit 107 embeds the lower bits including the aforementioned LSBs with the coded high order transform coefficients generated in Step S102 (Step S1082). In this way, a down-sampled decoded image, that is, a reference image is generated in which the coded high order transform coefficients are embedded.

Next, the embedding method is described in detail taking a specific example.

In the case where Nf=4 and Ns=3 are satisfied, a high resolution decoded image including 4×4 pixels is down-sampled to a low resolution down-sampled decoded image having 3×4 pixels. The down-sampling is performed only in the horizontal direction, and thus only down-sampling in the horizontal direction is described here. Assuming that four transform coefficients in the horizontal direction in the high resolution decoded image are DF0, DF1, DF2, and DF3, the high order transform coefficient DF3 among these transform coefficients are quantized and variable length coded. In addition, assuming that three pixel values in the horizontal direction of the low resolution down-sampled decoded image are Xs0, Xs1, and Xs2, the high order transform coefficient DF3 quantized and variable length coded is to be embedded into the lower bits of the three pixel values Xs0, Xs1, and Xs2 preferentially from the LSBs. The bit string of each of the pixel values Xs0, Xs1, and Xs2 is represented as (b7, b6, b5, b4, b3, b2, b1, and b0) starting with the MSB (Most Significant Bit).

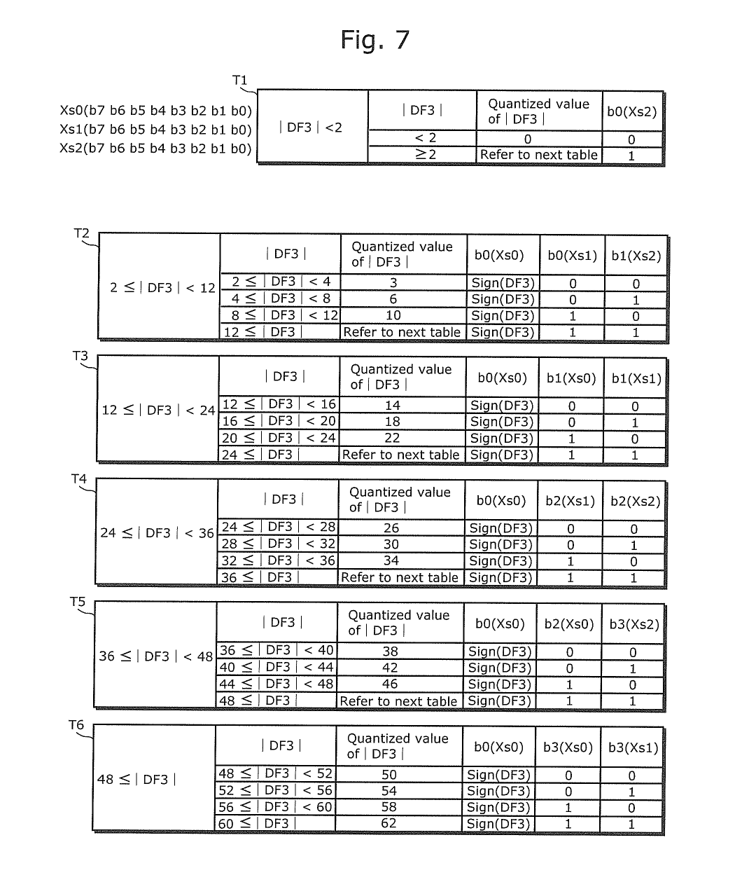

FIG. 7 is a diagram showing a table used to perform variable length coding on the high order transform coefficients.

In the case where the absolute value of the high order transform coefficient DF3 is 2 or less, the embedding and down-sampling unit 107 quantizes and variable length codes the high order transform coefficient DF3 using the table T1. In the opposite case where the absolute value of the high order transform coefficient DF3 is 2 or more and not more than 12, the embedding and down-sampling unit 107 quantizes and variable length codes the high order transform coefficient DF3 using the tables T1 and T2. Likewise, in the case where the absolute value of the high order transform coefficient DF3 is 12 or more and not more than 24, the embedding and down-sampling unit 107 quantizes and variable length codes the high order transform coefficients DF3 using the tables T1 to T3. In the opposite case where the absolute value of the high order transform coefficient DF3 is 24 or more and not more than 36, the embedding and down-sampling unit 107 quantizes and variable length codes the high order transform coefficient DF3 using the tables T1 to T4. Likewise, in the case where the absolute value of the high order transform coefficient DF3 is 36 or more and not more than 48, the embedding and down-sampling unit 107 quantizes and variable length codes the high order transform coefficient DF3 using the tables T1 to T5. In the opposite case where the absolute value of the high order transform coefficient DF3 is 48 or more, the embedding and down-sampling unit 107 quantizes and variable length codes the high order transform coefficient DF3 using the tables T1 to T6.

In addition, each of the tables T1 to T6 shows quantized values according to the absolute value of the high order transform coefficient DF3, a pixel value as an embedment destination and the bit thereof, and the value embedded to the bit. In addition, each of the tables T1 to T6 shows a positive or negative sign of the high order transform coefficient DF3 (Sign (DF3)) and the pixel value to which the Sign (DF3) is embedded and the bit thereof.

It is to be noted that in each of the tables T1 to T6, the bit bm in the pixel value Xsn is represented as bm(Xsn) (n=0, 1, 2, and m=0, 2, . . . , 7).

For example, in the case where the high order transform coefficient DF3 is 0, the embedding and down-sampling unit 107 selects the table T1 shown in FIG. 7 because the absolute value of the high order transform coefficient DF3 is smaller than 2. Next, the embedding and down-sampling unit 107 quantizes the high order transform coefficient DF3 into a quantized value 0, and replaces the value of the bit b0 of the pixel value Xs2 with 0, with reference to the table T1. Stated differently, the embedding and down-sampling unit 107 deletes the value of the bit b0 of the pixel value Xs2, and embeds the coded high order transform coefficient 0 into the bit b0. At this time, the embedding and down-sampling unit 107 does not change the bits other than the bit b0 of the pixel value Xs2 in the pixel values Xs0, Xs1, and Xs2.

As another example, in the case where the high order transform coefficient DF3 is 12, the embedding and down-sampling unit 107 sequentially selects the tables T1, T2, and T3 shown in FIG. 7 because the absolute value of the high order transform coefficient DF3 is 12 or more and not more than 24. More specifically, the embedding and down-sampling unit 107 quantizes the high order transform coefficient DF3 into a quantized value 14 with reference to Tables T1, T2, and T3 first. Next, the embedding and down-sampling unit 107 replaces the value of the bit b0 of the pixel value Xs2 with 1 with reference to the table T1, replaces the value of the bit b0 of the pixel value Xs1 with 1 with reference to the table T2, and replaces the value of the bit b1 of the pixel value Xs2 with 1. Furthermore, with reference to the table T3, the embedding and down-sampling unit 107 replaces the value of the bit b0 of the pixel value Xs0 with Sign (DF3), replaces the value of the bit b1 of the pixel value Xs0 with 0 with reference to the table T2, and replaces the value of the bit b1 of the pixel value Xs1 with 0. In this way, the bits b0 and b1 of the pixel value Xs0, the bits b0 and b1 of the pixel value Xs1, and the bits b0 and b1 of the pixel value Xs2 are respectively deleted, and coded high order transform coefficients (Sign (DF3), 0, 1, 0, 1, and 1 are embedded to the respective bits.

In this way, coded high order transform coefficients are embedded into lower bits including the LSBs of pixel values.

In this Embodiment, coded high order transform coefficients are embedded in a pixel domain. However, it is also good to embed coded high order transform coefficients in a frequency domain immediately before Step S106. In this Embodiment, high order transform coefficients are quantized and variable length coded. However, high order transform coefficients may be either quantized or variable length coded, or may be embedded without being quantized and variable length coded.

In this Embodiment, a decoded image including 4×4 pixels is transformed into a down-sampled decoded image including 3×4 pixels. However, a decoded image including 8×8 pixels may be transformed into a down-sampled decoded image including 6×8 pixels, or having any other size. Alternatively, two-dimensional compression may be further performed on, for example, a decoded image including 4×4 pixels to transform it into a down-sampled decoded image including 3×3 pixels.

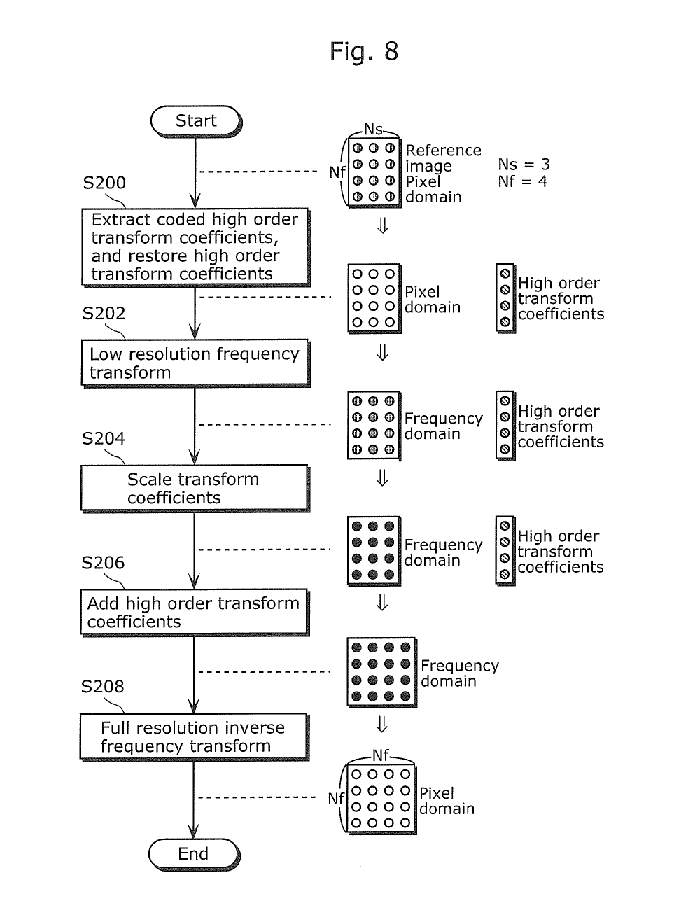

FIG. 8 is a flowchart indicating outline of processing operations performed by an extracting and up-sampling unit 109 according to this Embodiment.

The extracting and up-sampling unit 109 in this Embodiment performs processing operations inverse to the processing operations performed by the embedding and down-sampling unit 107.

More specifically, the extracting and up-sampling unit 109 first extracts coded high order transform coefficients from a reference image that is a down-sampled decoded image in which coded high order transform coefficients are embedded, and then restores the high order transform coefficients from the coded high order transform coefficients (Step S200). In this way, the high order transform coefficients are extracted. Here, the reference image includes Ns×Nf pixels. For example, Ns is 3, and Nf is 4.

Next, the extracting and up-sampling unit 109 performs low resolution frequency transform (specifically, orthogonal transform such as DCT and the like) on the reference image from which the coded high order transform coefficients have been removed, that is, the down-sampled decoded image so as to obtain a group of coefficients of the frequency domain including plural transform coefficients (Step S202). Stated differently, the extracting and up-sampling unit 109 performs low resolution DCT on the down-sampled decoded image including Ns×NI pixels so as to generate a group of coefficients of the frequency domain including Ns×Nf transform coefficients. At this time, the extracting and up-sampling unit 109 performs DCT according to N=Ns and the above Expression 4.

Next, the extracting and up-sampling unit 109 scales the Ns×Nf transform coefficients in the frequency domain in order to perform high frequency inverse frequency transform in the next step to adjust gain of these transform coefficients (Step S204). 1/block size scaling is performed in a combination of DCT and IDCT. Thus, the extracting and up-sampling unit 109 scales each of the transform coefficients in order to adjust the gain before obtaining Ns−point IDCT pixel values of Ns−point DCT low frequency coefficients. In this example, the extracting and up-sampling unit 109 scales each of the transform coefficients using a value calculated according to the following Math. (Expression) 7, as in the case of scaling in Step S104 by the embedding and down-sampling unit 107.

$$\sqrt{\frac{Nf}{Ns}} \qquad [ Math . 7 ]$$

Next, the extracting and up-sampling unit 109 adds the high order transform coefficients obtained in Step S200 to the group of coefficients of the frequency domain scaled in Step S204 (Step S206). This yields the group of coefficients of the frequency domain including Nf×Nf transform coefficients, that is, a decoded image represented in the frequency domain. In the case where transform coefficients having a frequency higher than the frequency of the high order transform coefficients obtained in Step S200 are required, it is to be noted that 0 is used for the transform coefficients.

Lastly, the extracting and up-sampling unit 109 performs full resolution (high resolution) inverse frequency transform (specifically, orthogonal transform such as IDCT or the like) on the group of coefficients in the frequency domain generated in Step S206 so as to obtain a decoded image including Nf×Nf pixels (Step S208). At this time, the extracting and up-sampling unit 109 performs IDCT according to N=Ns and the above Expression 5. In this way, the reference image including Ns×Nf pixels is up-sampled to be a reference image including Nf×Nf pixels by an increase in the resolution in the horizontal direction up to the resolution of the pre-down-sampled decoded image.

The extracting and up-sampling unit 109 in this Embodiment includes an extracting unit and a restoring unit which execute processing in Step S200, a second orthogonal transform unit which executes processing in Step S202, an adding unit which executes processing in Step S206, and a second inverse transform unit which executes processing in Step S208.

Here, each of the above Steps S200 to S208 are described in detail.

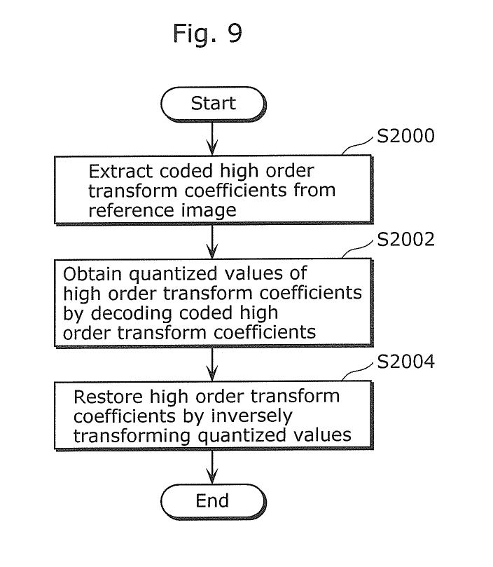

FIG. 9 is a flowchart indicating extracting and restoring of the high order transform coefficients in Step S200 of FIG. 8.

First, the extracting and up-sampling unit 109 extracts coded high order transform coefficients that are variable length codes from a reference image (Step S2000). Next, the extracting and up-sampling unit 109 decodes the coded high order transform coefficients, and thereby obtaining quantized high order transform coefficients, that are, the quantized values of the high order transform coefficients (Step S2002). Lastly, the extracting and up-sampling unit 109 inversely quantizes the quantized values, and thereby restoring the high order transform coefficients from the quantized values (Step S2004).

Next, the method of restoring the high order transform coefficients is described in detail taking a specific example.

For example, in the case where Nf=4 and Ns=3 are satisfied, a low resolution reference image including 3×4 pixels is up-sampled to a high resolution image including 4×4 pixels. The up-sampling is performed only in the horizontal direction, and thus only up-sampling in the horizontal direction is described here. Assuming that three pixel values in the horizontal direction in the low resolution reference image are Xs0, X51, and Xs2, each of the bit strings of the pixel values Xs0, Xs1, and Xs2 is represented as (b7, b6, b5, b4, b3, b2, b1, and b0) in order from the MSB (Most Significant Bit). In addition, it is assumed that the high order transform coefficient to be restored is DF3.

The extracting and up-sampling unit 109 extracts the coded high order transform coefficients embedded in the pixel values Xs0, Xs1, and Xs2 by checking the lower bits of the pixel values Xs0, Xs1, and Xs2 with reference to the tables T1 to T6 shown in FIG. 7, decodes the coded high order transform coefficients, and inversely quantizes the decoded high order transform coefficients.

More specifically, the extracting and up-sampling unit 109 extracts the value of the bit b0 of the pixel value Xs2 with reference to the table T1 first, and determines whether the value of the bit b0 is 1 or 0. When the determination result shows that the value of the bit b0 of the pixel value Xs2 is 0, the extracting and up-sampling unit 109 determines that the absolute value of the high order coded coefficient is smaller than 2 and that the quantized value of the absolute value is 0. In this way, the coded high order transform coefficient 0 is is extracted and decoded.

Furthermore, the extracting and up-sampling unit 109 performs, for example, linear inverse quantization on the quantized value 0 to restore the high order transform coefficient DF3 that is 0.

As another example, the extracting and up-sampling unit 109 extracts the value of the bit b0 of the pixel value Xs2 with reference to the table T1, and determines whether the bit b0 is 1 or 0. When the determination result shows that the bit b0 of the pixel value Xs2 is 1, the extracting and up-sampling unit 109 further extracts the value of the bit b0 of the pixel value Xs1 and the value of the bit b1 of the pixel value Xs2 with reference to the table T2, and determines whether each of the values of these bits is 1 or 0. When the determination results show that the value of the bit b0 of the pixel value Xs1 is 1 and that the value of the bit b1 of the pixel value Xs2 is 1, the extracting and up-sampling unit 109 further refers to the table T3. Next, the extracting and up-sampling unit 109 extracts the value of the bit b1 of the pixel value Xs0 and the value of the bit b1 of the pixel value Xs1, and determines whether each of the values of these bits is 1 or 0. When the determination results show that the value of the bit b1 of the pixel value Xs0 is 0 and that the value of the bit b1 of the pixel value is are 0, the extracting and up-sampling unit 109 determines that the absolute value of DF3 of the high order coded coefficient is 12 or more and smaller than 16 and that the quantized value of the absolute value is 14. Furthermore, the extracting and up-sampling unit 109 extracts the value of the bit b0 of the pixel value Xs0, and determines whether the code indicated by the value is positive or negative. When the determination result shows that the value is positive, the extracting and up-sampling unit 109 determines that the quantized value of the high order coded coefficient DF3 is 14. In this way, each of the coded high order transform coefficients (Sign (DF3), 0, 1, 0, 1, 1) embedded in the bits b0 and b1 of the pixel value Xs0, the bits b0 and b1 of the pixel value Xs1, and the bits b0 and b1 of the pixel value Xs2 is extracted, and decoded into the quantized value 14.

Next, the extracting and up-sampling unit 109 performs, for example, linear inverse quantization on the quantized value 14 to restore each of the high order transform coefficients DF to be 14 that is an intermediate value between 12 and 16.

Here, larger errors may be generated in the pixel values if the coded high order transform coefficients are extracted from the lower bits including the LSBs of pixel values in the low resolution reference image, and all of the respective lower bits of the pixel values are simply transformed to 0. To prevent this, the extracting and up-sampling unit 109 transforms, into a median value, the values of the lower bits including the LSBs from which the coded high order transform coefficients have been extracted. An example is provided assuming that the pixel value of the low resolution reference image is 122, and that coded high order transform coefficients that are variable length codes are embedded in the lower two bits including the LSBs of the pixel values. In this case, the pixel values become 120 if the coded high order transform coefficients are extracted from the lower two bits, and all the bit values are transformed to 0. However, the extracting and up-sampling unit 109 uses the median value 121.5 of 120, 121, 122, and 123 that are possible pixel values depending on the value of the lower two bits as the pixel value after the extraction of the coded high order transform coefficients. Although 1 bit needs to be increased to represent 0.5, 121 or 122 close to the median value may be used if 1 bit is not increased.

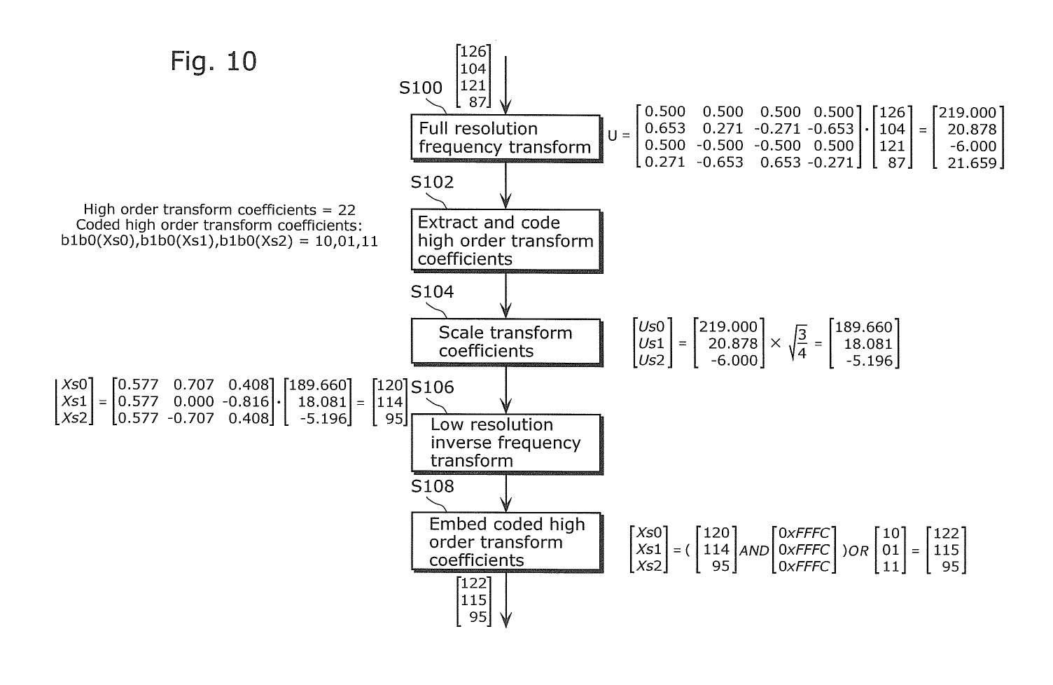

FIG. 10 is a diagram showing a specific example of processing operations performed by the embedding and down-sampling unit 107.

For example, when Nf=4 and Ns=3 are satisfied, the embedding and down-sampling unit 107 down-samples four pixel values {X0, X1, X2, X3}={126, 104, 121, 87} in the horizontal direction of the decoded image and embeds the coded high order transform coefficients therein to transform these four pixel values into three pixel values {Xs0, Xs1, Xs2}={122, 115, 95}.

More specifically, the embedding and down-sampling unit 107 performs frequency transform on the four pixel values {126, 104, 121, 87} in Step S100, and thereby generating a group of four transform coefficients {219.000, 20.878, −6.000, 21.659}. Next, the embedding and down-sampling unit 107 extracts and codes the high order transform coefficient 22 (21.659) from the group of coefficients in Step S102, and thereby generating coded high order transform coefficients composed of a value {1,0} to be embedded in the bits b1 and b0 of the pixel value Xs0, a value {0,1} to be embedded in the bits b1 and b0 of the pixel value Xs1, and a value {1,1} to be embedded in the bits b1 and b0 of the pixel value Xs2.

Furthermore, in Step S104, the embedding and down-sampling unit 107 scales each of the transform coefficients {21.000, 20.878, −6.000} other than the high order transform coefficient 22, and thereby deriving a group of coefficients {Us0, Us1, Us2}={189.660, 18.081, −5.196}. Next, in Step S106, the embedding and down-sampling unit 107 performs inverse frequency transform on the derived group of coefficients, and thereby generating three pixel values {Xs0, Xs1, Xs2}={120, 114, 95}. Next, in Step S108, the embedding and down-sampling unit 107 embeds the coded high order transform coefficients in these pixel values {Xs0, Xs1, Xs2}={120, 114, 95}. More specifically, the embedding and down-sampling unit 107 embeds {1,0} into the bits b1 and b0 of the pixel value Xs0, {0.1} into the bits b1 and b0 of the pixel value Xs1, and {1,1} into the bits b1 and b0 of the pixel value Xs2. In this way, the four pixel values {X0, X1, X2, X3}={126, 104, 121, 87} are transformed into the three pixel values {Xs0, Xs1, Xs2}={122, 115, 95}. A reference image including these three pixel values {Xs0, Xs1, Xs2}={122, 115, 95} in the horizontal direction is stored in the frame memory 108.

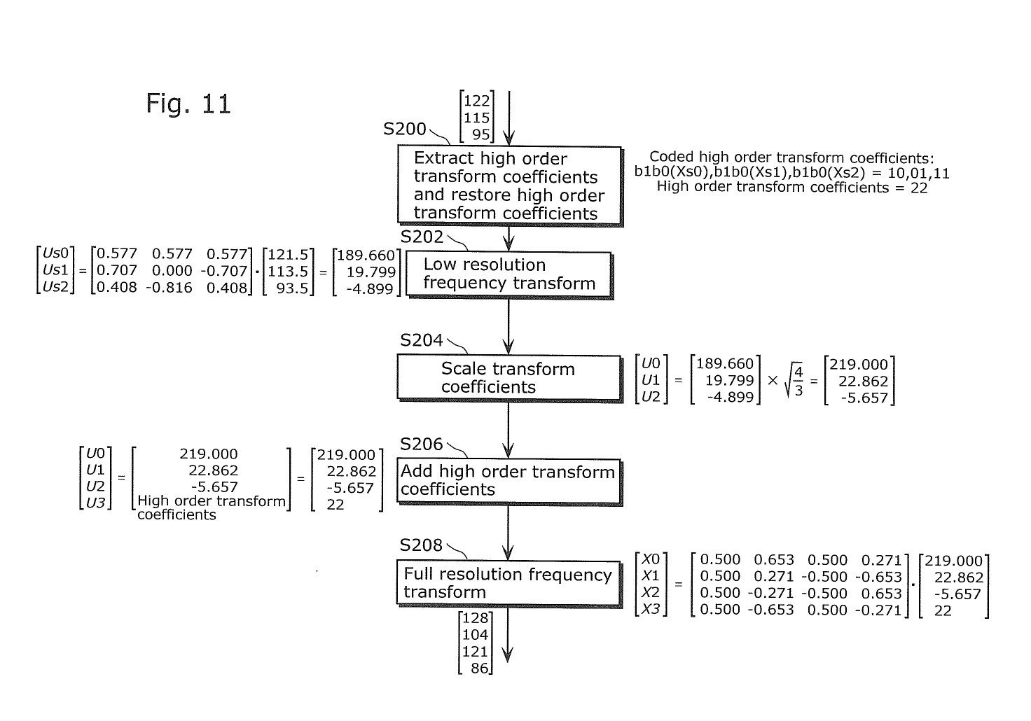

FIG. 11 is a diagram showing a specific example of processing operations performed by the extracting and up-sampling unit 109.

In Step S200, the extracting and up-sampling unit 109 reads out the above three pixel values {Xs0, Xs1, Xs2}={122, 115, 95} from the frame memory 108, and extracts coded high order transform coefficients therefrom. More specifically, the extracting and up-sampling unit 109 extracts {1, 0} from the bits b1 and b0 of the pixel value Xs0, extracts {0, 1} from the bits b1 and b0 of the pixel value Xs1, and extracts {1, 1} from the bits b1 and b0 of the pixel value Xs2. Next, the extracting and up-sampling unit 109 restores the high order transform coefficient 22 from the extracted coded high order transform coefficients with reference to the tables T1 to T6 shown in FIG. 7.

Next, in Step S202, the extracting and up-sampling unit 109 performs frequency transform on the pixel values {Xs0, Xs1, Xs2}={121.5, 113.5, 93.5} from which the coded high order transform coefficients have been extracted, to generate a group of three transform coefficients {Us0, Us1, Us2}={189.660, 19.799, −4.899}. Furthermore, in Step S204, the extracting and up-sampling unit 109 scales these transform coefficients {189.660, 19.799, −4.899}, and thereby deriving a group of coefficients {U0, U1, U2}={219.000, 22.862, −5.657}.

Next, in Step S206, the extracting and up-sampling unit 109 adds the high order transform coefficients 22 restored in Step S200 to the group of coefficients derived in Step S204, and thereby generating a group of four transform coefficients {U0, U1, U2, U3}={219.000, 22.862, −5.657, 22}. Furthermore, in Step S208, the extracting and up-sampling unit 109 performs inverse frequency transform on the group of coefficients {U0, U1, U2, U3}={219.000, 22.862, −5.657, 22}, and thereby generating four pixel values {X0, X1, X2, X3}={128, 104, 121, 86}. In this way, the three pixel values {Xs0, Xs1, Xs2}={122, 115, 95} are transformed into the four pixel values {X0, X1, X2, X3}={128, 104, 121, 86}. As a result, the up-sampled reference image including the four pixel values {X0, X1, X2, X3}={128, 104, 121, 86} in the horizontal direction is used for motion compensation.

In other words, in the case where no high order transform coefficients are embedded contrary to this embodiment, the pixel values {126, 104, 121, 87} of the decoded image are down-sampled and then up-sampled to pixel values {120, 118, 107, 93}, resulting in errors of {−6, 14, −14, 6}. However, this Embodiment can significantly reduce the resulting errors by means that the aforementioned embedding and down-sampling unit 107 and the extracting and up-sampling unit 109 embeds and extracts the high order transform coefficients, and thereby down-sampling and then up-sampling the pixel values {126, 104, 121, 87} of the decoded image to {128, 104, 121, 86} with smaller errors of {2, 0, 0, −1}.

### (Variation)

Here, a Variation of Embodiment 2 is described. An image decoding apparatus according to this Variation includes the functions of the image decoding apparatus 100 in Embodiment 2 and the functions of the image processing apparatus 10 in Embodiment 1. More specifically, the image decoding apparatus according to this Variation has a feature of selectively switching between the first processing mode and the second processing mode for at least one decoded image (input image), as in Embodiment 1. The first processing mode is for processing by either the embedding and down-sampling unit 107 or the extracting and up-sampling unit 109.

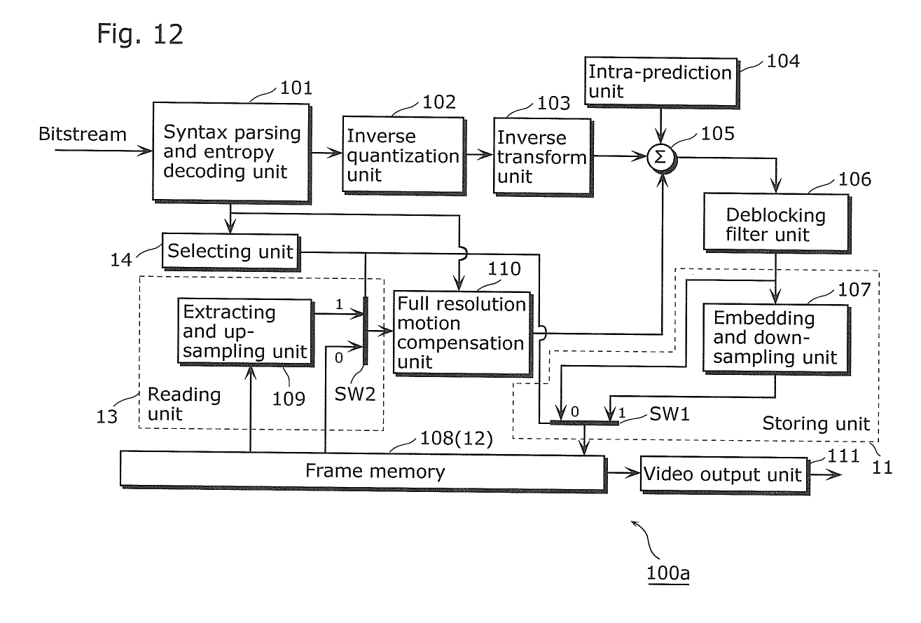

FIG. 12 is a block diagram showing a functional structure of the image decoding apparatus according to this Variation.

The image decoding apparatus 100a according to this Variation conforms to the H.264 video coding standard. The image decoding apparatus 100a includes a syntax parsing and entropy decoding unit 101, an inverse quantization unit 102, an inverse frequency transform unit 103, an intra-prediction unit 104, an adding unit 105, a deblocking filter unit 106, an embedding and down-sampling unit 107, a frame memory 108, an extracting and up-sampling unit 109, a full resolution motion compensation unit 110, a video output unit 111, a switch SW1, a switch SW2, and a selecting unit 14.

In other words, the image decoding apparatus 100a according to this Variation includes all the structural elements of the image decoding apparatus 100 in Embodiment 2, the switch SW1, the switch SW2, and the selecting unit 14. The embedding and down-sampling unit 107 and the switch SW1 make up the storing unit 11, and the extracting and up-sampling unit 109 and the switch SW2 make up the reading unit 13. Accordingly, the storing unit 11 and the reading unit 13, the frame memory 108 (12), and the selecting unit 14 make up the image processing apparatus 10. The image decoding apparatus 100a according to this Variation includes such image processing apparatus 10. Stated differently, the image processing apparatus is configured as the image decoding apparatus 100a. More specifically, the image processing apparatus includes the storing unit 11, the frame memory 12, the reading unit 13, and the selecting unit 14, and further includes a decoding unit required for decoding video and a video output unit 111. The decoding unit is configured with the syntax parsing and entropy decoding unit 101, the inverse quantization unit 102, the inverse frequency transform unit 103, the intra-prediction unit 104, the adding unit 105, the deblocking filter unit 106, and the full resolution motion compensation unit 110.

The syntax parsing and entropy decoding unit 101 parses and decodes header information included in a bitstream representing plural coded images, as in Embodiment 2. Here, the H.264 standard defines header information called SPS (Sequence Parameter Set) that is added to each sequence of plural pictures (coded images). Each SPS includes information indicating the number of reference frames (num_ref_frames). The number of reference frames indicates the number of reference images required in decoding a coded image included in a sequence corresponding to the number of reference frames and the SPS for the coded image. The H.264 standard specifies that 4 is the maximum value allowable as the number of reference frames for a picture in a high definition bitstream. However, the number of reference frames is set to be 2 for most bitstreams. More specifically, in the case where the SPS added to a sequence in a bitstream indicates that the number of reference frames is 4, each of the coded images subjected to inter-prediction coding has been coded using one or two reference images selected from the four reference images. Accordingly, when the number of reference frames indicated by an SPS is many, there is a need to store many reference images into the frame memory 108 and read out the many reference images from the frame memory 108 when decoding the sequence corresponding to the SPS.

The selecting unit 14 obtains the number of reference frames obtained by header information parsing by the syntax parsing and entropy decoding unit 101, from the syntax parsing and entropy decoding unit 101. Next, the selecting unit 14 selectively switches between the first processing mode and the second processing mode in units of a sequence according to the number of the reference frames therefor. More specifically, in the case where an SPS added to the sequence indicates that the number of reference frames is m, the selecting unit 14 selects the same processing (according to either the first or second processing mode) for each of the decoded images in the sequence. For example, the selecting unit 14 switches to the first processing mode for each of the decoded images in the sequence when the number of reference frames is 3, and switches to the second processing mode for each of the decoded images in the sequence when the number of reference frames is 2 or less. Hereinafter, the first processing mode is referred to as a low resolution decoding mode, and the second processing mode is referred to as a full resolution decoding mode.

Furthermore, in the case where the switching unit switches to the low resolution decoding mode, the selecting unit 14 outputs a mode identifier 1 indicating the mode to the switch SW1 and the switch SW2. In the opposite case where the switching unit switches to the full resolution decoding mode, the selecting unit 14 outputs a mode identifier 0 indicating the mode to the switch SW1 and the switch SW2.

When the SW1 obtains the mode identifier 1 from the selecting unit 14, the SW1 outputs, as a reference image, a down-sampled decoded image that is output from the embedding and down-sampling unit 107 to the frame memory 108. The down-sampled decoded image is output instead of the decoded image output from the deblocking filter unit 106. On the other hand, when the SW1 obtains the mode identifier 0 from the selecting unit 14, the SW1 outputs, as a reference image, a decoded image output from the deblocking filter unit 106 to the frame memory 108. The decoded image is output instead of the down-sampled decoded image that is output from the embedding and down-sampling unit 107.

When the switch SW2 obtains the mode identifier 1 from the selecting unit 14, the switch SW2 outputs the down-sampled decoded image (reference image) up-sampled by the extracting and up-sampling unit 109, instead of outputting the decoded image (reference image) stored in the frame memory 108. On the other hand, when the switch SW2 obtains the mode identifier 0 from the selecting unit 14, the switch SW2 outputs the decoded image (reference image) stored in the frame memory 108, instead of outputting the down-sampled decoded image (reference image) up-sampled by the extracting and up-sampling unit 109.

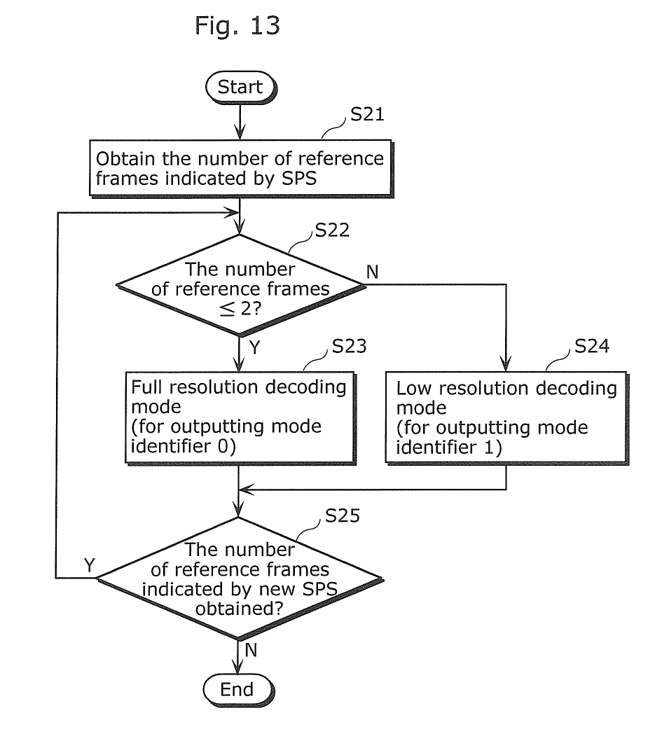

FIG. 13 is a flowchart indicating operations performed by the selecting unit 14.

First, the selecting unit 14 obtains the number of reference frames based on an SPS (Step S21). Furthermore, the selecting unit 14 determines whether or not the number of reference frames is 2 or less (Step S22). Here, when the selecting unit 14 determines that the number of reference frames is 2 or less (Yes in Step S22), the selecting unit 14 switches to the full resolution decoding mode (the second processing mode), and outputs the mode identifier 0 indicating the mode to the switch SW1 and switch SW2 (Step S23).

In this way, each of decoded images is obtained by decoding a corresponding one of coded images included in the sequence corresponding to the SPS, output from the deblocking filter unit 106, and stored in the frame memory 108 as a reference image without being down-sampled. Furthermore, when the reference image that is the decoded image is used in motion compensation performed by the full resolution motion compensation unit 110, the reference image is read out from the frame memory 108 and used in the motion compensation as it is.

Here, when the selecting unit 14 determines that the number of reference frames is not 2 or less (No in Step S22), the selecting unit 14 switches to the low resolution decoding mode (the first processing mode), and outputs the mode identifier 1 indicating the mode to the switch SW1 and switch SW2 (Step S24).

In this way, each of decoded images is obtained by decoding a corresponding one of coded images included in the sequence corresponding to the SPS, output from the deblocking filter unit 106, down-sampled by the embedding and down-sampling unit 107, and stored in the frame memory 108 as a reference image (down-sampled decoded image). Furthermore, when the reference image that is the down-sampled decoded image is used in motion compensation performed by the full resolution motion compensation unit 110, the reference image is read out from the frame memory 108, up-sampled by the extracting and up-sampling unit 109, and used in the motion compensation.

Next, the selecting unit 14 determines whether or not the number of reference frames indicated by a new SPS is obtained (Step S25), and when the determination is positive (Yes in Step S25), the selecting unit 14 repeatedly executes the processing starting with Step S22. On the other hand, when the selecting unit 14 determines that the number of reference frames indicated by a new SPS is not obtained (No in Step S25), the selecting unit 14 terminates the processing of selectively switching the full resolution decoding mode and the low resolution decoding mode.

In this Variation, a decoded image is down-sampled and stored in the frame memory 108 when the switching is performed to the low resolution decoding mode, and thus it is possible to reduce the capacity of the frame memory 108. For example, as in Embodiment 2, the maximum value for the number of reference frames is 4 in the case where the embedding and down-sampling unit 107 down-samples the decoded image to ¾, and thus it is possible to reduce the capacity required for the frame memory 108 from the capacity for storing 4 frames to the capacity for storing 3 frames obtained by 4 frames×(¾). Although the image quality degrades when the switching is performed to the low resolution decoding mode, it is possible to minimize such cases where image quality degrades because there are few practical cases where the numbers of reference frames to be set in SPSs exceed 2.

In this Variation, when the switching is performed to the full resolution decoding mode, the decoded image is stored in the frame memory 108 without being down-sampled, and thus it is possible to surely prevent degradation in the image quality. In this case, the capacity required for the frame memory 108 is the capacity for storing 4 frames since the maximum number for the number of reference frames is 4. However, when the number of reference frames is 2, it is only necessary that the capacity required for the frame memory 108 is the capacity for storing 2 frames. Thus, when the number of reference frames is 3, it is only necessary that the capacity required is for the frame memory 108 is the capacity for storing 3 frames.

Furthermore, in this Variation, as in Embodiment 1, the low resolution decoding mode and the full resolution decoding mode are selectively switched for each sequence, and thus it is possible to balance preventing degradation in the image quality of plural decoded images as a whole and reducing the bandwidth and capacity required for the frame memory 108. Furthermore, even when the switching is performed to the low resolution decoding mode, the decoded image is down-sampled in the embedding and down-sampling processing and then up-sampled in the extracting and up-sampling as in Embodiment 2, and thus it is possible to prevent degradation in the image quality of the decoded image.

In this Variation, the embedding and down-sampling processing and the extracting and up-sampling processing as in Embodiment 2 are employed in order to down-sample and then up-sample the decoded image. However, the processing may not be used, and any other methods for down-sampling and then up-sampling the decoded image may be used. The image decoding apparatus 100a in this Variation conforms to the H.264 video coding standard, and further conforms to any other video coding standards that define parameters indicating the numbers of reference frames determining the capacities of frame memories.

### Embodiment 3

High order transform coefficients are always embedded in Embodiment 2. However, image quality may be enhanced more by avoiding such embedment of high order transform coefficients in the cases where a down-sampled decoded image is flat and includes few edges, that is, the high order transform coefficients are small. This Embodiment shows a method of enhancing image quality in such cases.

An image decoding apparatus in this Embodiment has the same structure as that of the image decoding apparatus 100 shown in FIG. 3. However, the image decoding apparatus is different from the image decoding apparatus in Embodiment 2 in that the embedding and down-sampling unit 107 and the extracting and up-sampling unit 109 performs a part of processing operations differently. Stated differently, the embedding and down-sampling unit 107 in this Embodiment executes embedding processing (Step S108) of coded high order transform coefficients as shown in FIG. 4 in Embodiment 2, that is, processing different from the processing shown in FIG. 6. Furthermore, the extracting and up-sampling unit 109 in this Embodiment executes extracting and restoring processing (Step S200) of coded high order transform coefficients as shown in FIG. 8 in Embodiment 2, that is, processing different from the processing shown in FIG. 9. The other processing performed by the image decoding apparatus in this Embodiment is the same as in Embodiment 2, and thus descriptions thereof are not repeated here.

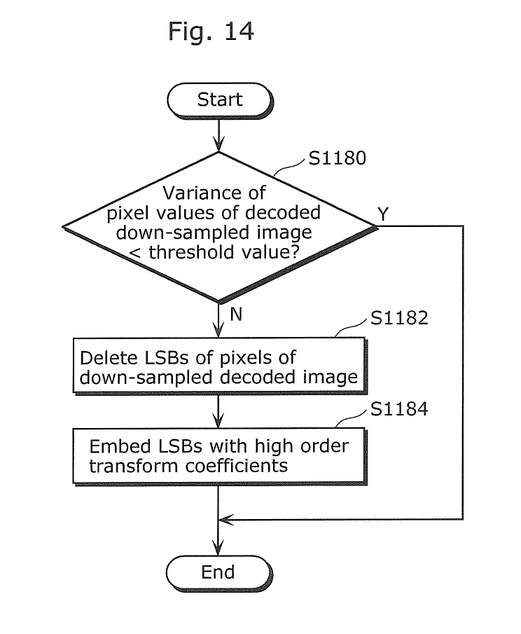

FIG. 14 is a flowchart indicating processing of embedding coded high order transform coefficients performed by an embedding and down-sampling unit 107 in this Embodiment. The embedding and down-sampling unit 107 in this Embodiment has a feature of determining whether or not to execute processing shown in FIG. 6 in Embodiment 2, in advance in Step S1180. The processing in the other steps are the same as in Embodiment 2.

The embedding and down-sampling unit 107 first calculates pixel values included in a down-sampled decoded image, that is, a variance v of low resolution pixel data, and determines whether or not the variance v is smaller than a predetermined threshold (Step S1180). Here, the embedding and down-sampling unit 107 calculates the variance v according to the following Math. (Expression) 8.

$$v = \frac{{\sum }_{i = 1}^{Ns} {( Xsi - μ )}^{2}}{Ns} \qquad [ Math . 8 ]$$

Here, Xs1 denotes a pixel value of a down-sampled decoded image, that is, down-sampled low resolution pixel data, Ns denotes the total number of pixel values included in the down-sampled decoded image, that is the total number of low resolution pixel data, and μ denotes the average value of the low resolution pixel data. Here, the embedding and down-sampling unit 107 calculates the average value μ according to the following Math. (Expression) 9.

$$μ = \frac{{\sum }_{i = 1}^{Ns} Xsi}{Ns} \qquad [ Math . 9 ]$$

In an specific example where low resolution pixel data Xs0, Xs1, and Xs2 are 121, 122, and 123, respectively, the average value μ is 122, and the variance v is 0.666.

When the embedding and down-sampling unit 107 determines that the variance v is equal to or more than the threshold value (N in Step S1180) as a result of the determination in Step S1180, the embedding and down-sampling unit 107 deletes the value represented by the lower bits in number according to the code length of the coded high order transform coefficients in the bit string indicating the pixel value of a down-sampled decoded image, as in the processing indicated in FIG. 6 in Embodiment 2. At this time, the embedding and down-sampling unit 107 deletes the value of the lower bits preferentially starting with the LSBs in the bit string (Step S1182). Next, the embedding and down-sampling unit 107 embeds the lower bits from which the values have been deleted with the coded high order transform coefficients (Step S1184). This yields a down-sampled decoded image in which the coded high order transform coefficients are embedded, that is, a reference image.

On the other hand, when the embedding and down-sampling unit 107 determines that the variance v is smaller than the threshold value (Y in Step S1180), the embedding and down-sampling unit 107 does not embed any high order transform coefficients regarding that the down-sampled decoded image is flat. Accordingly, in this case, the down-sampled decoded image without any embedded coded high order transform coefficients is stored in the frame memory 108.

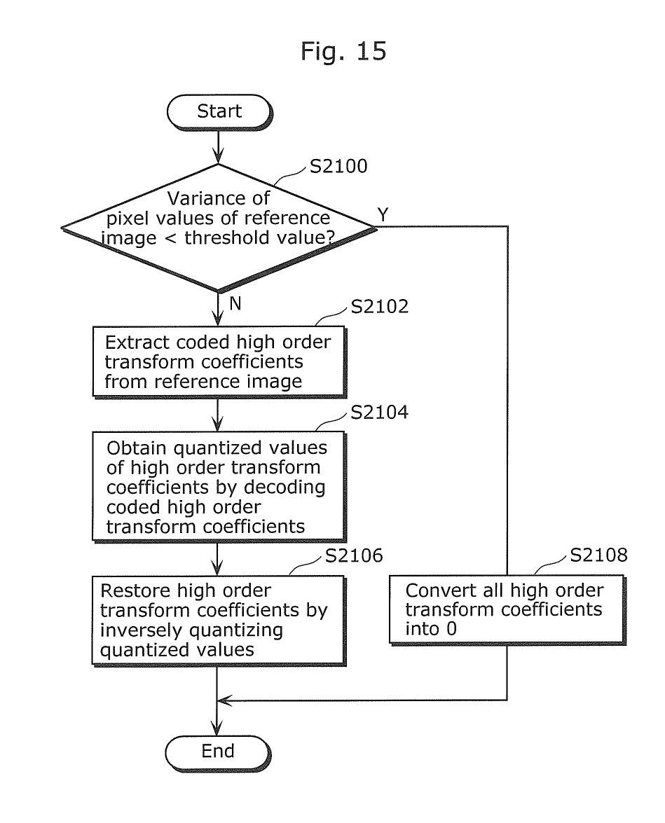

FIG. 15 is a flowchart indicating extracting and restoring coded high order transform coefficients by the extracting and up-sampling unit 109 in this Embodiment. The extracting and up-sampling unit 109 in this Embodiment has a feature of determining whether or not to execute the processing shown in FIG. 9 in Embodiment 2, in advance in Step S2100. Stated differently, the extracting and up-sampling unit 109 in this Embodiment determines whether or not a reference image includes coded high order transform coefficients embedded therein before up-sampling.

More specifically, the extracting and up-sampling unit 109 calculates pixel values included in the reference image, that is, a variance v of the down-sampled low resolution pixel data, and determines whether or not the variance v is smaller than the predetermined threshold value (Step S2100). Here, the extracting and up-sampling unit 109 calculates the variance v according to the above Expression 8.

When the extracting and up-sampling unit 109 determines that the variance v is equal to or more than the threshold value (N in Step S2100), the extracting and up-sampling unit 109 extracts the coded high order transform coefficients from the reference image, as in the processing shown in FIG. 9 in Embodiment 2. Next, the extracting and up-sampling unit 109 decodes the coded high order transform coefficients, and thereby obtaining quantized high order transform coefficients, that are, the quantized values of the high order transform coefficients (Step S2104). Furthermore, the extracting and up-sampling unit 109 inversely quantizes the quantized values, and thereby restoring the high order transform coefficients from the quantized values (Step S2106).

On the other hand, when the extracting and up-sampling unit 109 determines that the variance v is smaller than the threshold value (Y in Step S2100), the extracting and up-sampling unit 109 determines that the reference image does not include any coded high order transform coefficients embedded therein, and outputs 0 as all the high order transform coefficients without restoring the high order transform coefficients as indicated in Step S2102, Step S2104, and Step S2106 (Step S2108).

Even when the reference image includes coded high order transform coefficients embedded therein, a variance is calculated from the pixel values of the reference image including the coded high order transform coefficients, that is, from the low resolution pixel data in Step S2100. In this case, an error is produced between the above variance and the variance calculated in Step S1180 shown in FIG. 14, and thus there may be a case where a wrong determination is made as to whether or not the reference image includes coded high order transform coefficients embedded therein. However, since such a wrong determination is rarely made, there is no practical problem.

### Embodiment 4

Embodiments 2 and 3 aim to reduce the bandwidth and capacity required for the frame memory 108 by applying embedding and is down-sampling processing and extracting and up-sampling processing only in decoding of video (particularly, storing a reference image and reading the reference image for motion compensation). An image decoding apparatus in this Embodiment has a feature of applying embedding and down-sampling processing and extracting and up-sampling processing in Embodiment 2 in output of a down-sampled image by the video output unit, not only in the decoding of the video. In this way, the image decoding apparatus in this Embodiment eliminates the possibility that data embedded into the lower bits including the LSBs of pixels affects the image quality, and thus can achieve both enhancement in the image quality and reduction in the bandwidth and capacity of the frame memory 108.

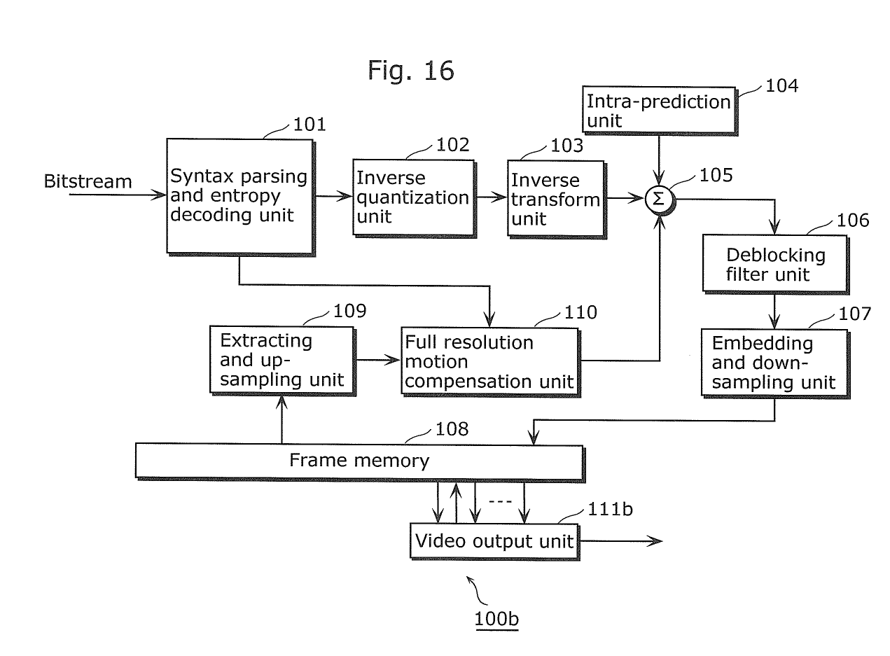

FIG. 16 is a block diagram showing a functional structure of the image decoding apparatus according to this Embodiment.

The image decoding apparatus 100b in this Embodiment supports the H.264 video coding standard. The image decoding apparatus 100b includes: a syntax parsing and entropy decoding unit 101, an inverse quantization unit 102, an inverse frequency transform unit 103, an intra-prediction unit 104, an adding unit 105, a deblocking filter unit 106, an embedding and down-sampling unit 107, a frame memory 108, an extracting and up-sampling unit 109, a full resolution motion compensation unit 110, and a video output unit 111b. In short, the image decoding apparatus 100b in this Embodiment includes the video output unit 111b having the same processing functions as those of the embedding and down-sampling unit 107 and the extracting and up-sampling unit 109, instead of the video output unit 111 of the image decoding apparatus 100 in Embodiment 2.

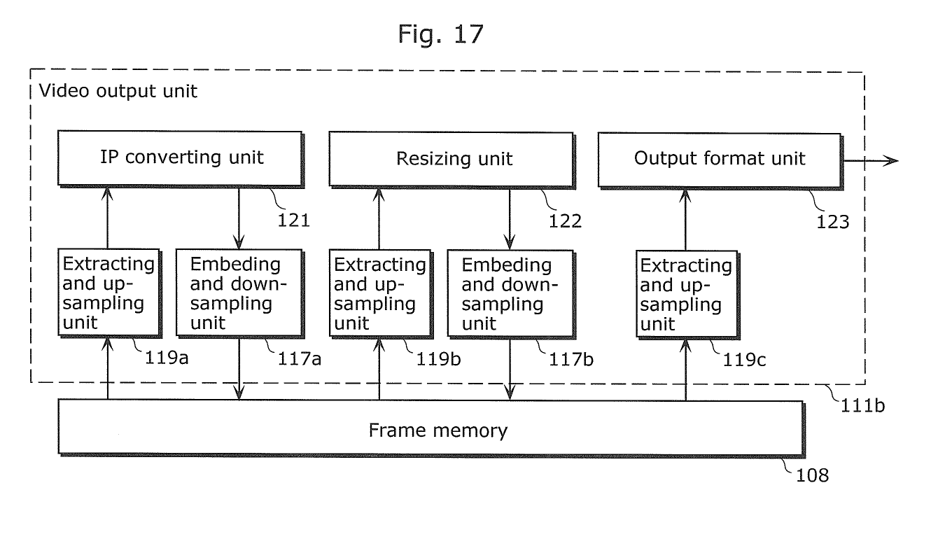

FIG. 17 is a block diagram indicating the functional structure of the video output unit 111b in this Embodiment.

The video output unit 111b in this Embodiment includes embedding and down-sampling units 117a and 117b, extracting and up-sampling units 119a to 119c, an IP converting unit 121, a resizing unit 122, an output format unit 123.

Each of the embedding and down-sampling units 117a and 117b has the same function as that of the embedding and down-sampling unit 107 in Embodiment 2, and executes embedding and down-sampling. Each of the extracting and up-sampling units 119a to 119c has the same function as that of the extracting and up-sampling unit 109 in Embodiment 2, and executes extracting and up-sampling.

The IP converting unit 121 converts an interlace image into an progressive image. Such conversion from an interlace image to a progressive image is referred to as IP converting processing.

The resizing unit 122 up-samples or down-samples the image. More specifically, the resizing unit 122 converts an image having a resolution into an image having a desired resolution for displaying the image on a television screen. For example, the resizing unit 122 converts a full HD (High Definition) image into an SD (Standard Definition) image, and converts an HD image into a full HD image. Such up-sampling or down-sampling of an image is referred to as resizing processing.

The output format unit 123 converts the format of the image into a format for external output. More specifically, in order to display the image data on an external monitor or the like, the output format unit 123 converts the signal format of the image data into either a signal format according to an input using a monitor or a signal format conforming to an interface (such as HDMI: High Definition Multimedia Interface) between the monitor and the image decoding apparatus 100b. This conversion into such a format for external output is referred to as output format converting processing.

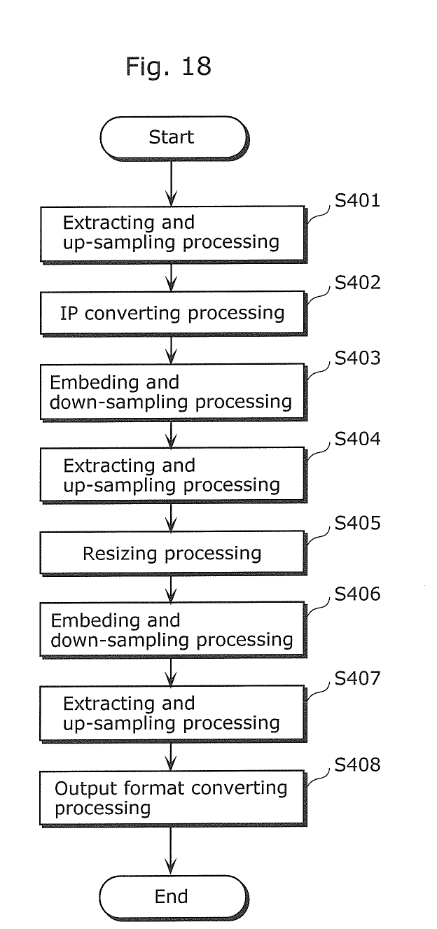

FIG. 18 is a flowchart indicating operations performed by the video output unit 111b in this Embodiment.

First, the extracting and up-sampling unit 119a of the video output unit 111b executes the processing (extracting and up-sampling) shown in FIG. 8 in Embodiment 2 (Step S401). More specifically, the extracting and up-sampling unit 119a reads out a down-sampled decoded image (reference image) that has been decoded, down-sampled, and stored in the frame memory 108, from the frame memory 108. The read out decoded image has been down-sampled by the processing (embedding and down-sampling) shown in FIG. 4 in Embodiment 1. Next, the extracting and up-sampling unit 119a performs the above extracting and up-sampling on the read out down-sampled decoded image.

The IP converting unit 121 performs IP converting processing on the down-sampled decoded image up-sampled by the extracting and up-sampling unit 119a, using the decoded image as a current image to be processed (Step S402). Here, the current image to be processed has a high resolution (that is the same as the original resolution of the decoded image before being down-sampled by the embedding and down-sampling unit 107). When plural down-sampled decoded images are used in the IP converting processing, extracting and up-sampling processing in Step S401 is performed on all of the down-sampled decoded images.

The embedding and down-sampling unit 117a executes the processing (embedding and down-sampling) shown in FIG. 4 in Embodiment 2 on the image on which the IP converting processing has been performed by the IP converting unit 121, and stores the image on which the embedding and down-sampling processing has been performed as a new down-sampled decoded image into the frame memory 108 (Step S403). Through such Steps S401 to S403, the down-sampled decoded image stored in the frame memory 108 is converted from an interlace image into a progressive image maintaining the same resolution.

Next, the extracting and up-sampling unit 119b performs the above extracting and up-sampling processing on the down-sampled decoded progressive image (Step S404). The resizing unit 122 resizes the down-sampled decoded image up-sampled by the extracting and up-sampling unit 119b, using the down-sampled decoded image as a current image to be processed (Step S405). Here, the current image to be processed has a high resolution (that is the same as the original resolution of the decoded image before being down-sampled by the embedding and down-sampling unit 107). When plural down-sampled decoded images are used in the resizing, extracting and up-sampling in Step S404 is performed on all of the down-sampled decoded images. The embedding and down-sampling unit 117b embeds and down-samples the image which has been resized by the resizing unit 122, and stores the image on which the emdedding and down-sampling processing has been performed as a new down-sampled decoded image into the frame memory 108 (Step S406). Through such Steps S404 to 406, the down-sampled decoded image stored in the frame memory 108 is up-sampled or down-sampled.

Next, the extracting and up-sampling unit 119c performs the above extracting and up-sampling processing on the decoded progressive image that has been up-sampled or down-sampled (Step S407). The output format unit 123 performs output format converting processing on the down-sampled decoded image on which the extracting and up-sampling processing has been performed by the extracting and up-sampling unit 119c, using the down-sampled decoded image as a current image to be processed (Step S408). Here, the current image to be processed has a high resolution (that is the same as the original resolution of the image to be processed before being down-sampled by the embedding and down-sampling unit 117b). Furthermore, the extracting and up-sampling unit 119c outputs the image on which the output format converting processing has been performed to the external device (such as a monitor) connected to the image decoding apparatus 100b.

As described above, in this Embodiment, the embedding and down-sampling processing and the extracting and up-sampling processing are applied not only in decoding video but also in the processing (output of video) in the video output unit 111b. Accordingly, it is possible to convert each of images to be stored in the frame memory 108 into a down-sampled image, and process the images having the original resolution as target images throughout the IP converting, resizing, and output format converting processing in the output processing of the video. As a result, it is possible to prevent degradation in the image quality of the images to be output by the video output unit 111b, and concurrently reduce the bandwidth and capacity required for the frame memory 108.

In this Embodiment, the video output unit 111b includes the IP converting unit 121, the resizing unit 122, and the output format unit 123. However, the video output unit 111b does not need to include all of these structural units, and may include any other structural element. For example, it is also possible to include either a structural element that performs processing for enhancing image quality such as low band pass filtering and edge highlighting or a structural element that performs OSD (On Screen Display) processing for superimposing other images, subtitles, and the like. Furthermore, the processing order shown in FIG. 18 may not be followed, and the video output unit 111b may execute each processing according to any other processing order. Each processing may include either one of the processing for enhancing image quality or the OSD processing.

In this Embodiment, the video output unit 111b includes the extracting and up-sampling units 119a to 119c and the embedding and down-sampling unit 117a and 117b, but the video output unit 111b does not need to include all of these structural units. For example, the video output unit 111b may include only the extracting and up-sampling unit 119a among the aforementioned structural units, or may include only the extracting and up-sampling units 119a and 119b and the embedding and down-sampling unit 117a among the aforementioned structural units.

In this Embodiment, the processing algorithms performed by the embedding and down-sampling unit 107 and the extracting and up-sampling unit 119a must correspond to each other, and the processing algorithms performed by the embedding and down-sampling unit 117a and the extracting and up-sampling unit 119b must correspond to each other. Likewise, the processing algorithms performed by the embedding and down-sampling unit 117b and the extracting and up-sampling unit 119c must correspond to each other. However, the processing algorithms performed by the embedding and down-sampling unit 107 and the extracting and up-sampling unit 119a, the processing algorithms performed by the embedding and down-sampling unit 117a and the extracting and up-sampling unit 119b, and the processing algorithms performed by the embedding and down-sampling unit 117b and the extracting and up-sampling unit 119c may be different from or the same as the algorithms for the other pairs.

### (Variation)

Here, a Variation of Embodiment 4 is described.

In Embodiment 4, embedding and down-sampling processing and extracting and up-sampling processing are applied to both decoding of video and output of video. However, in this Variation, embedding and down-sampling processing and extracting and up-sampling processing are applied to output of video only. This allows reduction in the bandwidth and capacity of the frame memory 108 in the output of video without causing degradation in the image quality due to accumulated errors in a system in which such accumulation of errors are noticeable in the decoding of video represented as a bitstream including a long GOP (Group Of Pictures), that is, including a GOP composed of a many number of pictures.

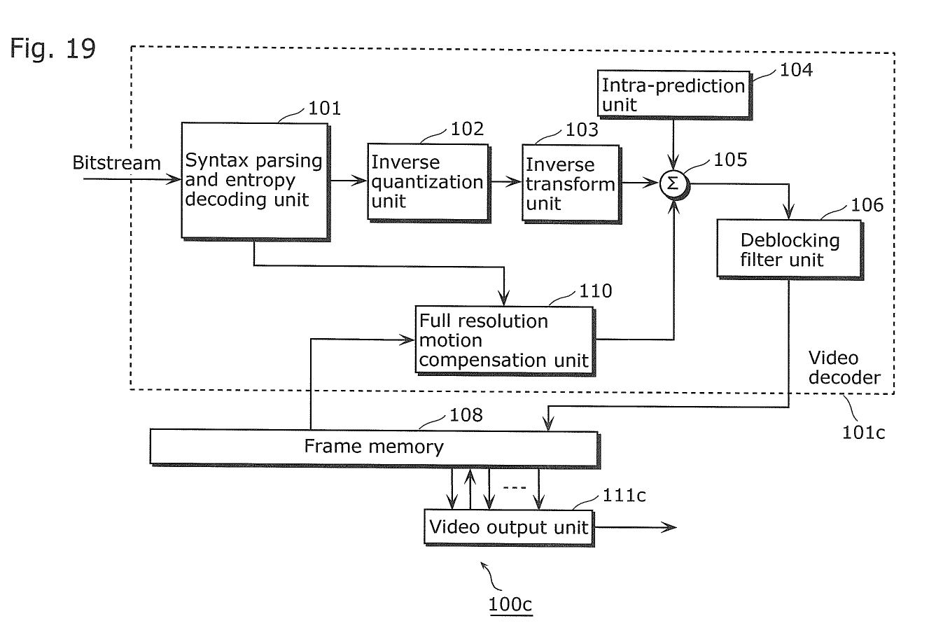

FIG. 19 is a block diagram showing a functional structure of the image decoding apparatus according to this Variation.

An image decoding apparatus 100c according to this Variation conforms to the H.264 video coding standard, and includes a video decoder 101c, a frame memory 108, and a video output unit 111c. The video decoder 101c includes a syntax parsing and entropy decoding unit 101, an inverse quantization unit 102, an inverse frequency transform unit 103, an intra-prediction unit 104, an adding unit 105, a deblocking filter unit 106, and a full resolution motion compensation unit 110. Stated differently, the image decoding apparatus 100c according to this Variation includes a video output unit 111c instead of the video output unit 111b of the image decoding apparatus 100b in Embodiment 4, and does not include the embedding and down-sampling unit 107 and the extracting and up-sampling unit 109 of the image decoding apparatus 100b.

In this Variation, embedding and down-sampling processing and extracting and up-sampling processing are not applied to decoding of video, and thus decoded images that have not been down-sampled are stored as reference images in the frame memory 108. Therefore, the video output unit 111c according to this Variation performs embedding and down-sampling processing and extracting and up-sampling processing on the decoded images that have not been down-sampled in performing video output (IP converting, resizing, and output format converting processing).

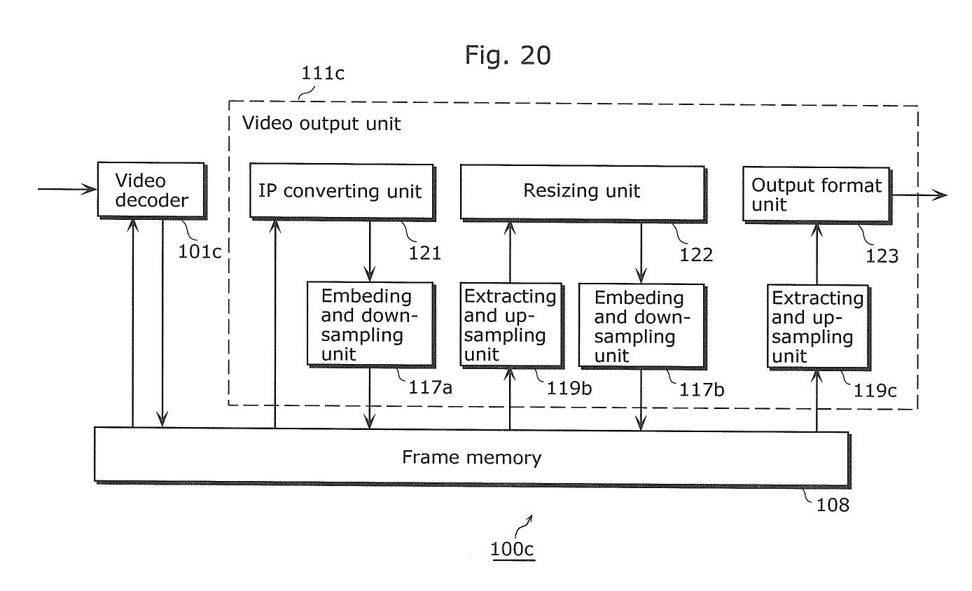

FIG. 20 is a block diagram showing a functional structure of a video output unit 111c according to this Variation.

The video output unit 111c according to this Variation includes an embedding and down-sampling unit 117a, extracting and up-sampling units 119b and 119c, an IP converting unit 121, a resizing unit 122, and an output format unit 123. In short, the video output unit 111c according to this Variation does not include the extracting and up-sampling unit 119a of the video output unit 111b in Embodiment 4.

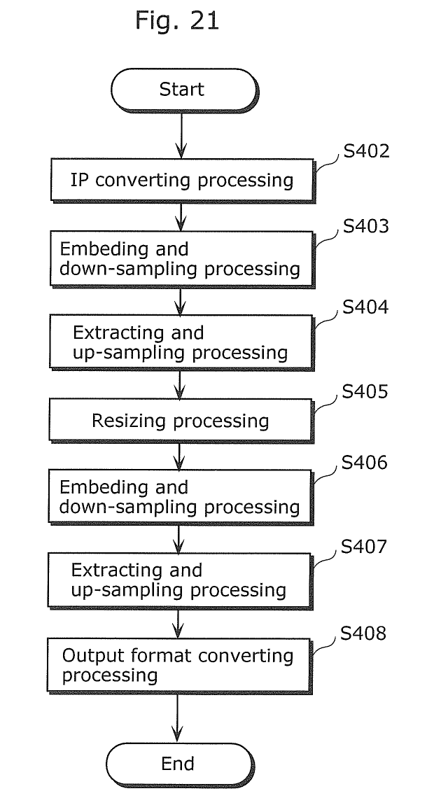

FIG. 21 is a flowchart indicating operations performed by the video output unit 111c according to this Variation.

A decoded image generated by the video decoder 101c is stored as a reference image in the frame memory 108 without being down-sampled. Accordingly, the IP converting unit 121 of the video output unit 111c performs IP converting processing on the decoded image stored in the frame memory 108, using the decoded image as a current image to be processed as it is (Step S402). More specifically, in Embodiment 4, since a down-sampled decoded image obtained by down-sampling the decoded image is stored in the frame memory 108 as the reference image, the video output unit 111b first performs extracting and up-sampling processing on the down-sampled decoded image. However, in this Variation, since the decoded image is stored in the frame memory 108 as the reference image without being down-sampled, the video output unit 111b performs IP converting processing in Step S402 on the decoded image stored in the frame memory 108 without performing extracting and up-sampling processing in Step S401 shown in FIG. 18.

Subsequently, as in Embodiment 4, the video output unit 111c executes the aforementioned Steps S403 to S408 using the resizing unit 122, the output format unit 123, the embedding and down-sampling units 117a and 117b, and the extracting and up-sampling units 119b and 119c.

As descried above, the video decoder 101c in this Variation is intended to perform operations conforming to the standard, and thus is capable of reducing image quality degradation that is likely to occur in an image including a long GOP. Furthermore, the video output unit 111c in this Variation down-samples and then up-samples a decoded image stored in the frame memory 108 by performing embedding and down-sampling processing and extracting and up-sampling processing, and thereby enabling prevention of image quality degradation and concurrently reduction in the bandwidth and capacity required for the frame memory 108.

In this Variation as in Embodiment 4, the video output unit 111c includes the IP converting unit 121, the resizing unit 122, and the output format unit 123. However, the video output unit 111c does not need to include all of these structural units, and may include any other structural element. For example, it is also possible to include either a structural element that performs processing for enhancing image quality such as low band pass filtering and edge highlighting or a structural element that performs OSD processing for superimposing other images, subtitles, and the like. Furthermore, the processing order shown in FIG. 21 may not be followed, and the video output unit 111c may execute each processing according to any other processing order. Each processing may include either one of the processing for enhancing image quality or the OSD processing.

In this Variation as in Embodiment 4, the video output unit 111c includes the extracting and up-sampling units 119b and 119c, and the embedding and down-sampling units 117a and 117b. However, the video output unit 111c does not need to include all of these structural elements. For example, the video output unit 111c may include the embedding and down-sampling unit 117a and the extracting and up-sampling unit 119b only.

In this Variation as in Embodiment 4, the processing algorithms performed by the embedding and down-sampling unit 117a and the extracting and up-sampling unit 119b must correspond to each other, and the processing algorithms performed by the embedding and down-sampling unit 117b and the extracting and up-sampling unit 119c must correspond to each other. However, the processing algorithms performed by the embedding and down-sampling unit 117a and the extracting and up-sampling unit 119b, and the processing algorithms performed by the embedding and down-sampling unit 117b and the extracting and up-sampling unit 119c may be different from or the same as the algorithms for the other pair.

### Embodiment 5

The present invention can be implemented as a system LSI.

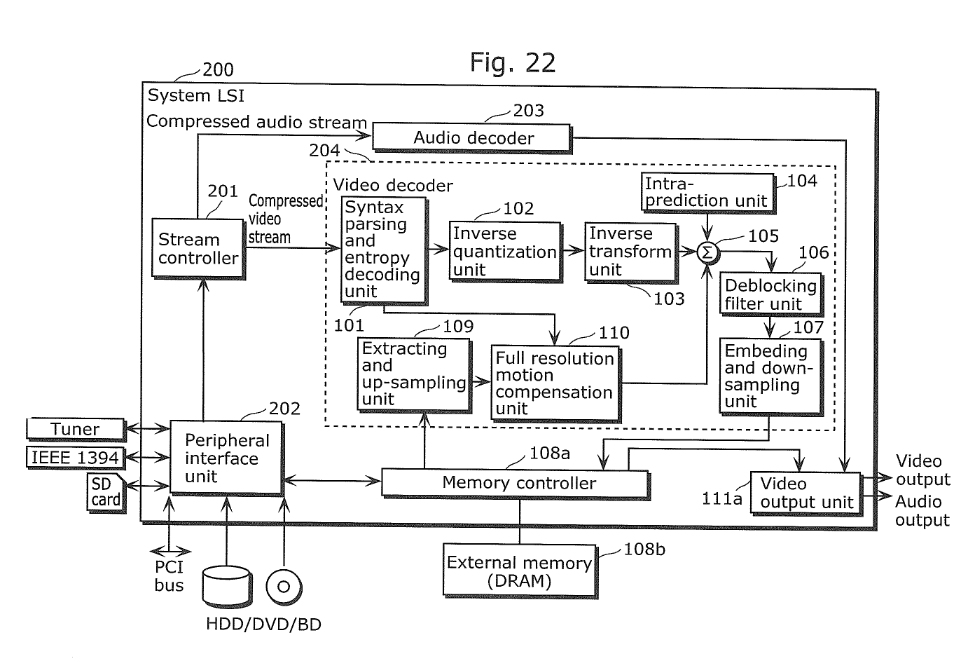

FIG. 22 is a structural diagram showing a structure of a system LSI according to this Embodiment.

The system LSI 200 includes peripheral devices for transferring a compressed video stream and a compressed audio stream as indicated below. The system LSI 200 includes: a video decoder 204 that down-decodes a high definition video represented by the compressed video stream (bitstream); an audio decoder 203 that decodes the compressed audio stream; a video output unit 111a that up-samples or down-samples a reference image stored in an external memory 108b to have a required resolution, outputs the reference image on a monitor, and outputs an audio signal; a memory controller 108a that controls data access between (i) each of the video decoder 204 and the video output unit 111a and (ii) the external memory 108b; a peripheral interface unit 202 that serves as an interface with external devices such as a tuner and a hard disc drive; and a stream controller 201.

The video decoder 204 includes the following structural elements according to Embodiment 2 or 3: a syntax parsing and entropy decoding unit 101, an inverse quantization unit 102, an inverse frequency transform unit 103, an intra-prediction unit 104, an adding unit 105, a deblocking filter unit 106, an embedding and down-sampling unit 107, an extracting and up-sampling unit 109, and a full resolution motion compensation unit 110. Stated differently, in this Embodiment, an image decoding apparatus 100 according to either Embodiment 2 or 3 is configured with the video decoder 204, the frame memory inside the external memory 108b, and the video output unit 111a.

The compressed video stream and compressed audio stream are supplied to the video decoder 204 and audio decoder 203, respectively, from external devices via the peripheral interface unit 202. Examples of such external devices include SD cards, hard disc drives, DVDs, Blu-ray discs (BDs), tuners, and any other external devices connectable to the peripheral interface unit 202 via IEEE1394 or a peripheral device interface (such as PCI) bus. The stream controller 201 supplies the compressed audio stream and the compressed video stream separately to the audio decoder 203 and the video decoder 204. The stream controller 201 is directly connected to the audio decoder 203 and the video decoder 204 in this Embodiment, but the stream controller 201 may be connected thereto via the external memory 108b. The peripheral interface unit 202 and the stream controller 201 may also be connected via the external memory 108b.

The internal structure of the video decoder 204 and operations performed by the video decoder 204 are the same as in Embodiment 2 or 3, and thus detailed descriptions thereof are not repeated here.

In this Embodiment, the frame memory used by the video decoder 204 is disposed in the external memory 108b outside the system LSI 200. The external memory 108b is generally configured with a DRAM (Dynamic Random Access Memory), but any other memory device is possible. The external memory 108b may be included inside the system LSI 200. In addition, plural external memories 108b may be used.

The memory controller 108a establishes necessary access to the external memory 108b by arbitrating access between blocks such as the video decoder 204 and the video output unit 111a that access the external memory 108b.

A decoded image decoded and down-sampled by the video decoder 204 is read out from the external memory 108b and displayed on a monitor by the video output unit 111a. The video output unit 111a performs up-sampling or down-sampling to obtain a required resolution, and outputs the video data in synchronization with the audio signal. The decoded image is obtained by adding coded high order transform coefficients as watermarks to a low resolution decoded image without producing distortion therein. Thus, the minimum requirements for the video output unit 111a are general up-sampling and down-sampling functions only. The video output unit 111 may perform processing for enhancing image quality and IP (Interlace-Progressive) converting processing, in addition to the up-sampling and down-sampling processing.

In this Embodiment as in Embodiments 2 and 3, the video decoder 204 codes at least one high order transform coefficient discarded in the down-sampling process and embeds the at least one high order transform coefficient in a down-sampled decoded image in order to minimize drift errors in the down-sampled decoded image. This embedment is to embed information using digital watermarking, and thus does not produce any distortion in the down-sampled decoded image. Accordingly, this Embodiment does not require any complicated processing for displaying the down-sampled decoded image on the monitor. In short, it is only necessary that the video output unit 111a have simple up-sampling and down-sampling functions.

### (Variation)

Here, a Variation of Embodiment 5 is described. The video output unit of a system LSI according to this Variation has a feature of executing extracting and up-sampling processing and embedding and down-sampling processing, as in the video output unit 111b in Embodiment 4.

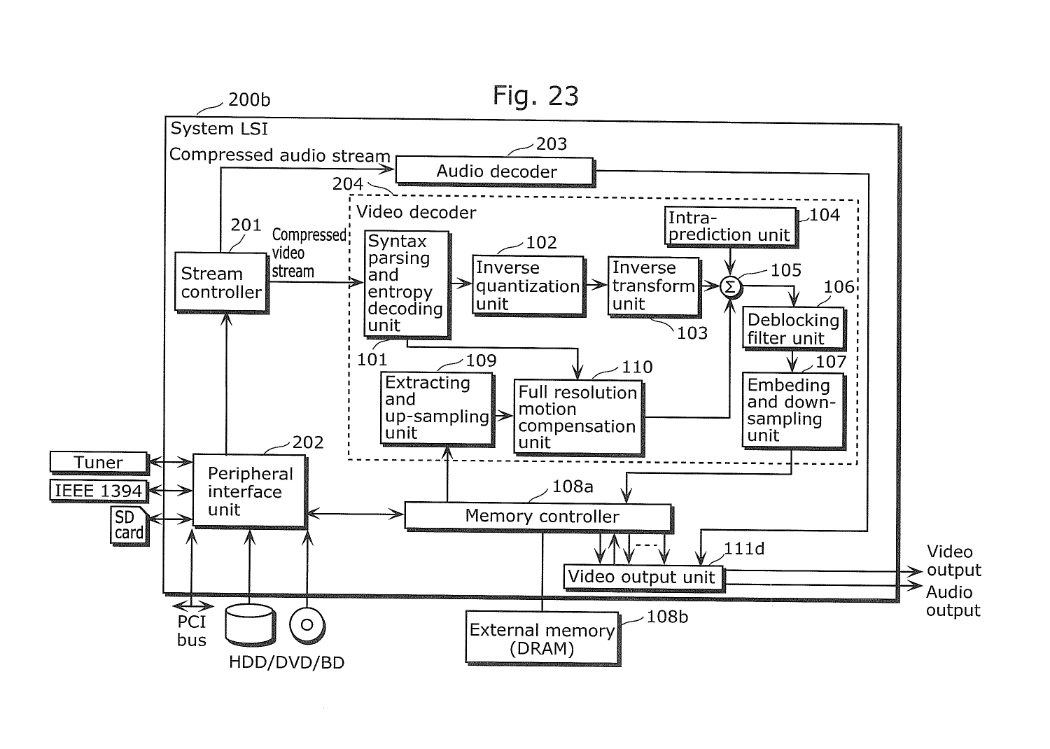

FIG. 23 is a structural diagram showing a structure of the system LSI according to this Variation.

A system LSI 200b according to this Variation includes a video output unit 111d instead of the video output unit 111a. This video output unit 111d outputs an audio signal as performed by the video output unit 111a, and executes the same processing as the processing performed by the video output unit 111b in Embodiment 4. Stated differently, the video output unit 111d executes extracting and up-sampling processing on a down-sampled image stored in the external memory 108b as a reference image when reading out the down-sampled image via the memory controller 108a. The video output unit 111d performs embedding and down-sampling processing on an image on which video output processing has been performed (the processing includes IP converting, resizing, and output format converting processing) when storing the image into the external memory 108b via the memory controller 108a.

In this way, the system LSI 200b according to this Variation can provide the same advantageous effect as in Embodiment 4.

### Embodiment 6

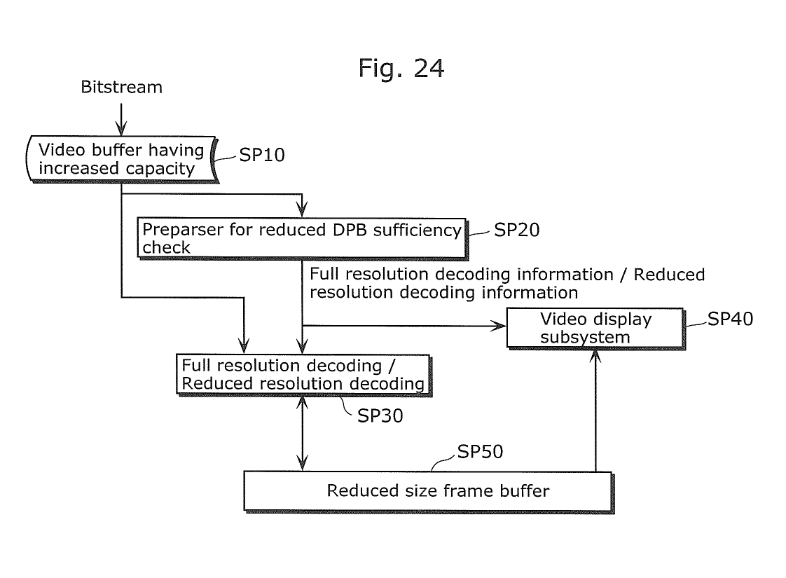

This Embodiment in the present invention includes the following various functional blocks: a video buffer having an increased capacity, a preparser which performs reduced DPB sufficiency checks to determine the resolutions of the frames (a full resolution and a reduced resolution), a video decoder capable of decoding each of pictures at a full resolution or a reduced resolution, a reduced-size frame buffer, and a video display subsystem (FIG. 24).

The video buffer (Step SP10) has a storage capacity that is larger than that of a conventional decoder and is for providing additional coded video data for look-ahead preparsing of the coded video data (Step SP20) before the actual video decoding is performed in Step SP30. The preparser is started by a DTS, ahead of the actual decoding of the bitstream by a time margin provided by the increased buffer size. The actual decoding of the bitstream is delayed from the DTS by the same time margin provided by the increased video buffer. The preparser (Step SP20) parses the bitstream stored in the Step SP10 to determine the decoding mode of each frame (a full resolution or a reduced resolution) based on the number of reference frames used and the reduced-size buffer capacity. Full resolution decoding is selected whenever possible to avoid unnecessary visual distortion. A picture resolution list is updated accordingly. The coded video data is then provided to the adaptive resolution video decoder in Step SP30 to decode the image data according to the resolutions determined in Step SP20. In Step SP30, the image data are up-converted or down-converted whenever necessary to the required resolutions for the pictures involved in the decoding process. The decoded video image data, which is down-converted if required, is stored in the reduced-size frame buffer in Step SP50. Information containing the resolutions of the decoded pictures (determined in Step SP20) is provided to a video display subsystem in Step SP40 to up-convert the image data if necessary for display purposes.

Increased-Size Video Buffer (Step SP10)

In video coding standards, a compliant bit stream must be able to be decoded by a hypothetical reference decoder that is conceptually connected to the output of an encoder and includes at least a predecoder buffer, a decoder, and an output and display unit. This virtual decoder is known as the hypothetical reference decoder (HRD) in H.263, H.264 and the video buffering verifier (VBV) in MPEG. A stream is compliant if it can be decoded by the HRD without buffer overflow or underflow. Buffer overflow happens if more bits are to be placed into the buffer when the buffer is full. Buffer underflow happens if some bits are not in the buffer when the bits are to be fetched from the buffer for decoding and playback.

The carriage and buffer management of H.264 video streams is defined using existing parameters from [Section 2.14.1 of ITU-T H.222.0 Information technology—Generic coding of moving pictures and associated audio information: systems] such as PTS and DTS, as well as information present within an AVC video stream. The timestamps that indicate the presentation time of audio and video are called Presentation Time Stamps (PTS). Those that indicate the decoding time are called Decoding Timestamps (DTS). Each AVC access unit that is present in an elementary stream buffer is removed instantaneously at decoding time that is specified by the DTS, or at the CPB removal time in the case of H.264 [Section 2.14.3 of ITU-T H.222.0 Information technology—Generic coding of moving pictures and associated audio information: systems]. CPB removal time is provided in Annex C [Advanced video coding for generic audiovisual services ITU-T H.264].

In a real decoder system, each of the audio decoder and the video decoder do not perform instantaneously, and their delays must be taken into account in the design of the implementation. For example, if video pictures are decoded in exactly one picture presentation interval 1/P, where P is the frame rate, and compressed video data are arriving at the decoder at a bit rate R, the completion of removing bits associated with each picture is delayed from the time indicated in the PTS and DTS fields by 1/P, and the video decoder buffer must be larger than that specified in the STD model by RIP.

To cite as an example, the maximum Coded Picture Buffer size (CPB) is 30,000,000 bits (3,750,000 bytes) for Level 4.0 of H.264. Level 4.0 is for HDTV use. A real decoder has the video decoder buffer as discussed earlier. The video decoder buffer is larger than a CPB by at least RIP, because of the need to delay by 1/P time the removal of the data which must be present in the buffer during the decoding time.

The preparser (Step SP20) performs preparsing of all the video data available in the buffer before the intended decoding time indicated by the DTS so as to provide the decoder with the information related to the possibility of the full decoding in a reduced memory decoder. The video buffer size is increased from that required by a real decoder by an amount required for preparsing. The preparsing will start at the DTS while the actual decoding is delayed by the additional time used for preparsing. An exemplary usage of the preparsing video buffer is provided below.

The maximum video bit rate for Level 4.0 of H.264, is 24 Mbps. To achieve an additional look-ahead preparsing of 0.333 s, an additional video buffer storage of approximately 8 Megabits (1,000,000 bytes) is required. One frame of such bit rates takes 800,000 bits on average and 10 frames takes 8,000,000 bits on average. A stream controller will retrieve the input streams according to the decoding standards. However, it will remove the streams from the video buffer at a time delayed by 0.333 s from the intended removal time indicated by the DTS. The actual decoding has to be delayed by 0.333 s for such design, so that the preparser can gather more information on the decoding mode of each frame before the actual decoding starts.

Reduced-size Frame Buffer (Step SP50)

Step SP50 provides storage for a current decoding frame and the decoded picture buffer according to standards that use multiple reference frames. In H.264, the decoded picture buffer contains frame buffers, each of which may contain a decoded frame, a decoded complementary field pair or a decoded single (non-paired) field that are marked as “used for reference” (reference pictures) or are held for future output (reordered or delayed pictures).

The DPB decoding mode operations are defined in Annex C.4 of [Advanced video coding for generic audiovisual services ITU-T H.264]. This annex defines picture decoding and output sequences, marking and storage of reference decoded pictures into a DPB, storage of non-reference pictures into a DPB and removal of pictures from the DPB before possible insertion of a current picture, and a bumping process.

Most H.264 streams do not utilize the maximum number of reference frames defined for each profile and level in its coding. For streams coded using only I- and P-picture structure, the number of reference frame used is usually 1 because only one preceding frame is used for reference in the prediction. For streams that are coded using many reference B-frames, the storage of many reference frames in the DPB is required.

As such, one can infer that the memory in the frame buffer can be arranged in various configurations that are helpful for a reduced memory decoder that uses multiple reference frames. When the storage of many reference frames is not required, the decoder can utilize the reduced memory effectively by storing a lower number of reference frames at the full resolution. The reference frames are down-converted and stored in the memory only when the storage of multiple reference frames is required.

To cite as an example, the maximum DPB size for each profile and level is given in the decoding specifications. For example, a DPB conforming to H.264 Level 4.0 is capable of storing 4 full resolution frames of 2048×1024 pixels with the maximum DPB size corresponding to 12,582,912 bytes. In the reduced memory design where the DPB is reduced to the capability of handling only 2 full resolution frames, the frame memory capacity required is thus 3 full resolution frames (2 in DPB and 1 in working buffer). Whenever 4 reference frames are needed in the DPB, 4 frames are stored at the half resolution (4 →2 down-sampling is performed). A savings of 40% (6,291,456 bytes) of frame memory storage can be achieved because the frame memory needs to handle only 3 out of 5 frames at the full resolution.

Preparser for Reduced DPB Sufficiency Check (Step SP20)

The preparser (Step SP20) parses the bitstream stored in the video buffer to determine the decoding mode of each frame (full resolution or reduced resolution). The preparser (Step SP20) performs preparsing of all the video data available in the buffer before the intended decoding time indicated by a DTS so as to provide the decoder with the information related to the possibility of the full decoding in the reduced memory decoder. The video buffer size is increased from that required by a real decoder by an amount required for preparsing. The preparsing will start at the DTS although the actual decoding is delayed by the additional time used for preparsing.

The preparser parses the higher layer information, such as Sequence parameter set (SPS) in H.264 in Step SP200. If the number of reference frames used (num_ref_frames for H.264) are found to be less than or equal to the number of full reference frames which can be handled by the reduced DPB, the decoding mode for the frames according to this SPS is set to be full decoding in Step SP220, and the picture resolution list for video decoding and memory management (Step SP280) is updated accordingly. In Step SP200, if the number of reference frames used is greater than that which the reduced DPB can handle at the full resolution, the lower syntax information (slice layer in case of H.264) is examined in Step SP240 to determine whether or not the full resolution decoding mode can be assigned to the processing of a particular frame. Full resolution decoding is selected whenever possible to avoid unnecessary visual distortion. In Step SP240, it is ensured that (i) the usage of the reference lists in the full DPB and in the reduced DPB are the same, and (ii) the picture display order is correct before assigning full resolution decoding mode to a picture in Step SP260. A reduced resolution decoding mode is assigned otherwise in Step SP260. The picture resolution list buffer is updated accordingly in Step SP280.

Higher Parameter Layer Check (Step SP200)

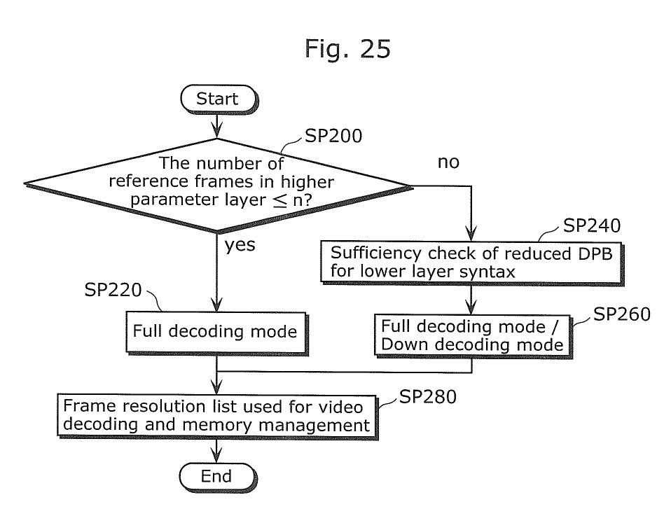

Here, the number of reference frames used is checked for the possibility of reduced DPB operations (FIG. 25). In H.264, the field “num_ref_frame” in the sequence parameter set (SPS) indicates the number of reference frames used for the decoding of pictures before the next SPS. If the number of reference frames used is less than or equal to the number of reference frames which can be contained in the reduced DPB frame memory at the full resolution, the full resolution decoding mode is assigned (Step SP220) and the frame resolution list (Step SP280) is updated accordingly which will be used later for video decoding and memory management by the decoder and display subsystem. If the result of the reduced DPB sufficiency check is false in the Step SP200, the lower layer syntax is further checked by the preparser (Step SP240) for reduced DPB sufficiency.

Sufficiency Check of Reduced DPB for Lower Layer Syntax (Step SP240)

Refer to FIG. 25.

In order to perform DPB management using a reduced physical memory capacity, the following management parameters are stored for each decoded picture in the operational/actual DPB of the decoder (hereinafter referred to as a real DPB):

(i) DPB_Removal_Instance

This parameter indicates timing information for removing a current picture from the DPB. One possible storage scheme is to use the DTS time or PTS time of a later picture to indicate the removal of the current picture from the DPB.

(ii) Full_Resolution_Flag

If full_resolution_flag of a picture is 0, the picture is stored at a reduced resolution. Otherwise (full_resolution_flag is 1), the picture is stored at a full resolution.

(iii) Early_Removal_Flag

This parameter is not used directly in the picture management operation of a real DPB. However, early_removal_flag is used in lower-layer look-ahead processing (Step SP240), and storage of early_removal_flag in the real DPB is necessary for lower-layer look-ahead processing performed on a picture basis. If early_removal_flag of a picture is 0, the picture is removed from the DPB according to DPB management in the decoding standard. Otherwise (early_removal_flag is 1), the picture is removed before that dictated by DPB buffer management in the decoding standard, according to the value indicated by DPB_removal_instance.

In order to perform lower-layer look-ahead processing, two virtual images of DPB are maintained in the look-ahead preparsing.

(i) Reduced DPB

A reduced DPB provides workspace for look-ahead determination of:
whether or not a picture is to be stored at a full resolution or a reduced resolution; and
the removal time of a picture from the DPB (an on-time removal or an early removal based on the DPB buffer management, which is assigned by the preparser).

At the start of look-ahead processing, the real DPB state is copied to the reduced DPB. Then, look-ahead processing is performed for each coded picture and the feasibility of storing a full resolution picture is checked each time the reduced DPB is updated.

At the end of the look-ahead processing, the reduced DPB state is discarded.

ii) Complete DPB

A complete DPB simulates the behavior of the standard-compliant DPB management scheme (subclauses C.4.4 and C.4.5.3 of [Advanced video coding for generic audiovisual services ITU-T H.264] for H.264). The complete DPB is independent of the final decision of Step SP240. The complete DPB is created at the start of decoding and is updated throughout the entire decoding process. The state of the complete DPB is stored at the end of the look-ahead processing of a target picture j and is used subsequently in the look-ahead processing of the next picture (j+1).

Step SP240 performs lower-layer look-ahead processing of a future DPB state as each picture (starting with the target picture j) is decoded and stored. Step SP240 produces the following outputs:
The values of the real DPB management parameters for the target picture j.
The state of the complete DPB at the end of decoding the target picture j.

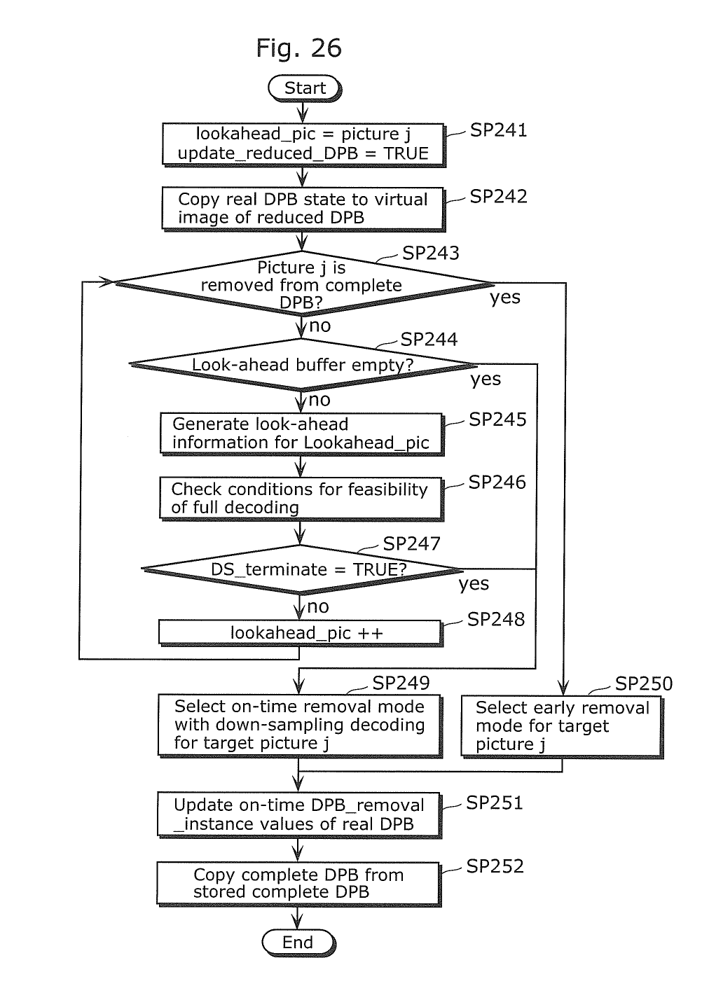

Step SP240 is detailed as indicated below (FIG. 26). Step SP241 sets look-ahead picture information lookahead_pic to the target picture j, and initializes update_reduced_DPB as TRUE. Step SP242 then copies the current state of the real DPB to the reduced DPB.

Following Step SP242, a check of whether or not the target picture j is removed from the complete DPB is performed in Step SP243. If the result in Step SP243 is found to be TRUE, Step SP250 is performed and Step SP240 is terminated. If the result in Step SP243 is found to be false, the process continues to Step SP244.

In Step SP244, the availability of coded picture data in the look-ahead buffer is checked. If the look-ahead buffer is empty, look-ahead processing can no longer be continued. Thus, the look-ahead processing is aborted, and Step SP249 is performed. In Step SP249, the on-time removal mode using a reduced resolution is selected for the target picture j (Step SP260) with Step SP280 updated with a reduced resolution selected for the target picture j, and the following values are assigned in the real DPB:

i) early_removal_flag[j] of real DPB=0.

ii) full_resolution_flag[j] of real DPB=0.

iii) DPB_removal_instance[j] of real DPB=ontime_removal_instance

If Step SP244 outputs FALSE, the look-ahead processing is continued. Step SP245 is then performed to generate look-ahead information as lookahead_pic, which will be used in Step SP246 for examining the feasibility of the full resolution decoding.

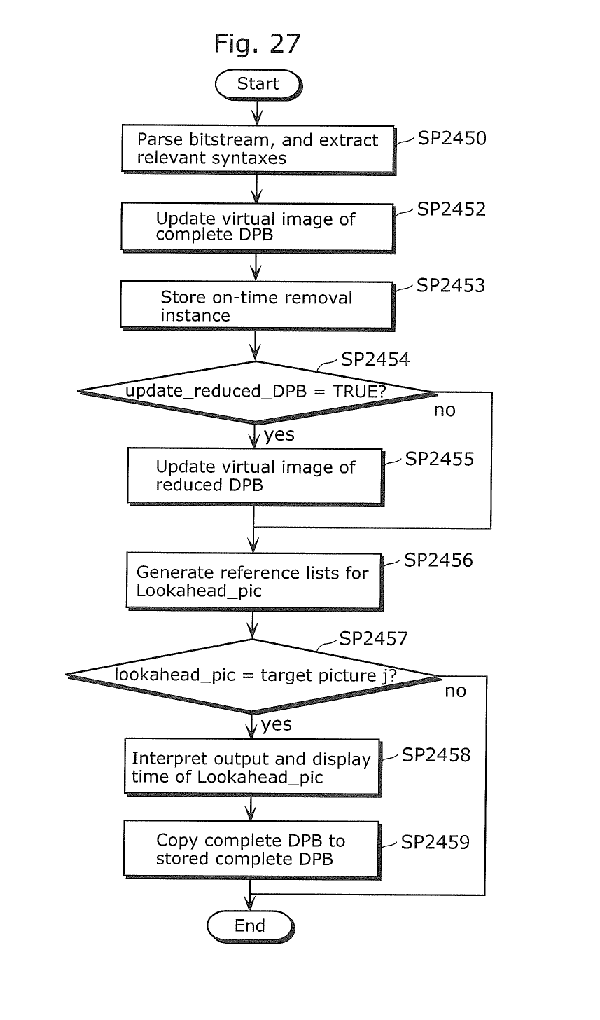

Step SP245 is described below in detail (FIG. 27).

The complete DPB buffer images and the on-time removal information are parsed in the Steps from Step SP2450 to Step SP2453.

In Step SP2450, some of the syntax elements are parsed. In the case of H.264, all the information related to buffering of decoded picture as indicated below is extracted.
num_ref_idx_IX_active_minusi in PPS (Picture Parameter Set), num_ref_idx_active_override_flag in SH (Slice Header), num_ref_idx_IX_active_minus1 in SH;
slice_type in SH;
nal_ref_idc in SH;
All ref_pic_list_reordering( ) syntax elements in SH;
All dec_ref_pic_marking( ) syntax elements in SH;
All syntax elements related to picture output timings, including Video Usability Information (VUI), buffering period Supplemental Enhancement Information (SEI) message syntax elements, and Picture Timing SEI message syntax elements.

TABLE 1
Syntax elements extracted in Step SP2450

| Syntax Elements | Information Extracted |
|---|---|
| slice_type | Picture type (I/P/B) |
| nal_ref_idc | Whether current picture is |
| | reference picture |
| num_ref_idx_IX_active_minus1, | Reference picture lists |
| num_ref_idx_active_override_flag, | |
| ref_pic_list_reordering( ) syntax | |
| elements | |
| dec_ref_pic_marking( ) syntax | Which of available reference |
| elements | pictures are actually referred to |
| | in decoding process of each |
| | picture |
| Video Usability Information (VUI), | Time instance for outputting |
| buffering period Supplemental | and displaying each picture |
| Enhancement Information (SEI) | from DPB |
| message syntax elements, and | |
| Picture Timing SEI message syntax | |
| elements | |

When picture output timing information is not present in an H.264 elementary stream, it may be present in form of Presentation Time Stamp (PTS) and Decoding Time Stamp (DTS) in the transport stream.

Using syntax elements in Table 1, look-ahead information for the complete DPB is generated in Step SP2452. The virtual image of the complete DPB is updated using the DPB buffer management in the decoding standards.

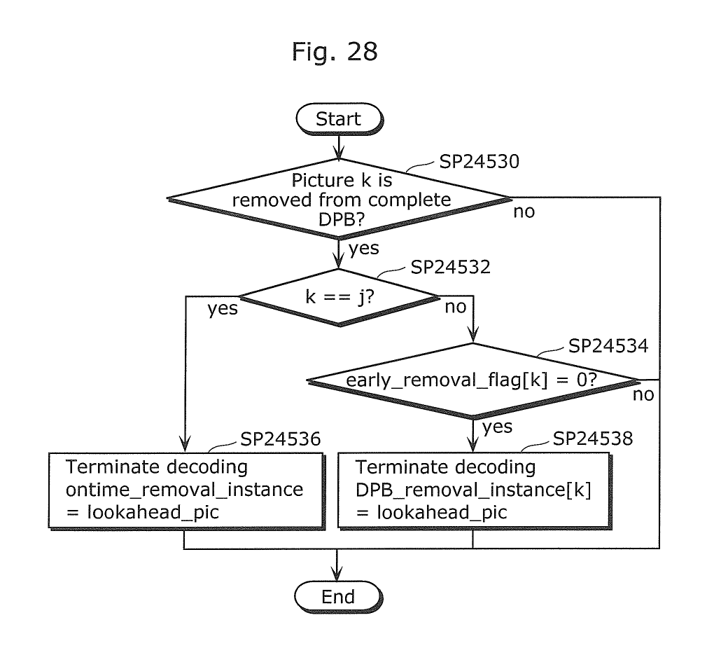

Based on recent updating of the complete DPB in Step SP2452, Step SP2453 stores on-time removal instances into the reduced DPB when necessary. Step SP2453 is detailed below (FIG. 28). Step SP24530 checks whether or not a picture k is recently removed from the complete DPB in Step SP2452. If the result is no, Step SP2453 is terminated. Otherwise (Step SP24530 outputs TRUE), Step SP24532 checks whether or not picture k is the target picture j. If the result is yes, the time instance at the end of lookahead_pic decoding is stored as ontime_removal_instance, as the target picture j is removed on time according to the DPB management. Otherwise (Step SP24532 outputs FALSE), Step SP24534 checks whether or not early_removal_flag of the picture k in the reduced DPB is set to 0. If it is 0, DPB_removal_instance of the picture k in the reduced DPB is set to the instance at the end of lookahead_pic decoding. Otherwise (Step SP24534 outputs FALSE), Step SP2453 is terminated.

Step SP2454 to Step SP2455 updates the reduced DPB if required.

Returning to FIG. 27, Step SP2454 checks whether or not the reduced DPB is to be updated. If Step SP2454 outputs FALSE, updating of the reduced DPB is not done. Effectively, once update_reduced_DPB is set to FALSE (Step SP2465), the reduced DPB status remains unchanged until the end of the look-ahead processing of the target picture j. Otherwise (Step SP2454 outputs TRUE), Step SP2455 updates the virtual image of the reduced DPB. The following conditional assignments are performed when a recently decoded picture is added to the reduced DPB, and Step SP260 is performed with Step SP280 updated accordingly:

(i) early_removal_flag is set to 1 for the recently decoded picture.

(ii) If the available size in the DPB is sufficient for a full resolution picture, full_resolution_flag is set to 1, and the decoded picture is stored into the reduced DPB at the full resolution.

(iii) If the available size in the DPB is insufficient for a full resolution picture, a reduced DPB bumping process is performed to remove a picture with undefined early_removal_flag=1 from the reduced DPB. Next to the bumping process, the following processes are performed.
If the resulting available size in the reduced DPB is sufficient for a full resolution picture, full_resolution_flag is set to 1, and the decoded picture is stored into the reduced DPB at the full resolution.
If the resulting available size in the reduced DPB is insufficient for a full resolution picture, full_resolution_flag is set to 0, and the decoded picture is stored into the reduced DPB at a reduced resolution.

(iv) Pictures are removed from the reduced DPB following rules of the reduced DPB removal process

The reduced DPB removal process is described as follows:

(i) For Pictures with Early_Removal_Flag=0:

These pictures are removed from the reduced DPB at the same instance as their removal from the complete DPB.

(ii) For Pictures with Early_Removal_Flag=1:

Whenever a newly coded picture needs to be stored and the available size in the DPB is not sufficient for a full resolution picture, a reduced DPB bumping process is performed. The reduced DPB bumping process removes a picture with the lowest priority based on a predetermined priority condition. Possible priority conditions include:
Remove the oldest picture (first-in-first-out); —OR—
Remove the picture at the lowest reference level such as lowest nal_ref_idc in H.264; —OR—
Remove a picture of the least-referred-to type, for example, starting with a bi-predictive coded picture (B), then a predictive coded picture (P), and then an intra-coded picture (I).

In Step SP2456, reference picture lists used by lookahead_pic are generated by semantically interpreting the partially decoded bitstream.

Step SP2457 checks whether or not lookahead_pic is the target picture j. If SP2457 outputs TRUE, Step SP2458 and Step SP2459 are performed. Otherwise (SP2457 outputs FALSE), SP245 is terminated.

In Step SP2458, the output and display time of the target picture j is interpreted either from the partially decoded bitstreams or from the transport stream information.

In Step SP2459, the current state of the complete DPB (after the target picture j is decoded and the complete DPB is updated) is stored as a temporary DPB image of the complete DPB. At the end of the look-ahead processing of the target picture j, the stored complete DPB will be copied back to the complete DPB for use in the look-ahead processing for the subsequent pictures (picture (j+1) and so on).

Returning to FIG. 26, Step SP246 analyzes the look-ahead information generated in Step SP245 for checking whether or not the full decoding mode is still possible after decoding lookahead_pic. Two conditions are evaluated in Step SP246 as follows:

Condition 1:

From the instance immediately after the target picture is removed from the reduced DPB until the instance target picture is removed from the complete DPB, the target picture is not present in any reference lists; and

Condition 2:

The target picture is not removed from the reduced DPB before its intended output and display time.

If either of the conditions is found to be FALSE, the DS_terminate is set to TRUE, and full decoding mode is not possible for the examined frame.

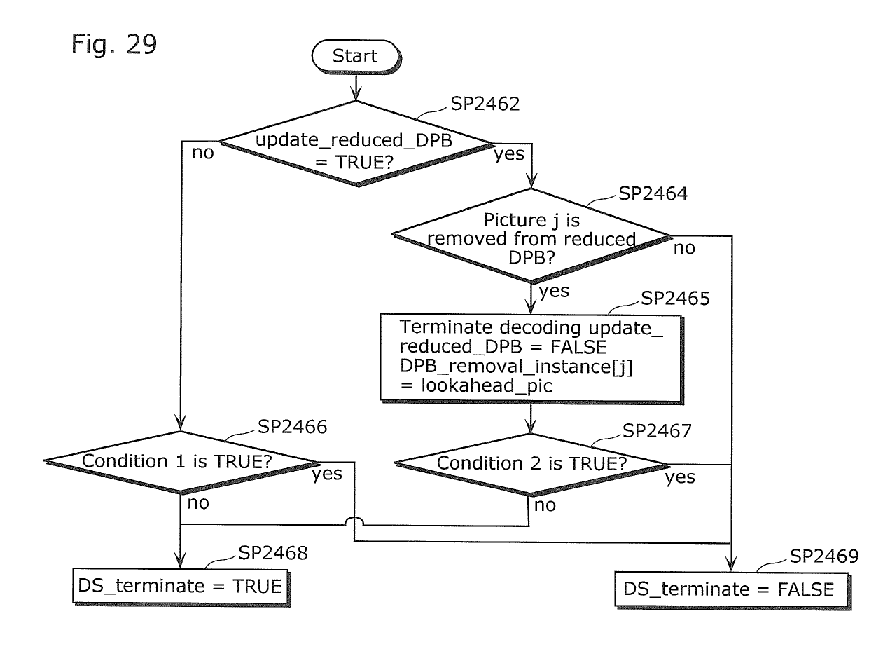

Detailed processing in Step SP246 is described as follows (FIG. 29). Firstly, update_reduced_DPB is checked in SP2462. If update_reduced_DPB is TRUE, Step SP2464 then checks whether or not current lookahead_pic is no longer present in the reduced DPB. If Step SP2464 outputs FALSE, Step SP2469 sets an output flag DS_terminate=FALSE. Otherwise (Step SP2464 outputs TRUE), Step SP2465 sets update_reduced_DPB to FALSE, and sets early_removal_instance to the time instance at the end of lookahead_pic decoding. Then, Step SP2467 evaluates Condition 2. If Condition 2 is found to be TRUE), Step SP2467 sets an output flag DS_terminate=FALSE. Otherwise (Condition 2 is FALSE), Step SP2468 sets output flag DS_terminate=TRUE. Returning to Step SP2462, if update_reduced_DPB is FALSE, Step SP2466 evaluates Condition 1. If Condition 1 is found to be TRUE, Step SP2467 sets an output flag DS_terminate=FALSE. Otherwise (Condition 1 is FALSE), Step SP2468 sets an output flag DS_terminate=TRUE. Step SP246 is terminated when a DS_terminate flag is set to either in Step SP2468.

Returning to FIG. 26, a flag DS_terminate from Step SP246 is checked in Step SP 247 to determine whether or not the look-ahead processing is to be continued or terminated.

If DS_terminate is found to be FALSE in Step SP247, lookahead_pic is incremented by 1 in Step SP248, and the look-ahead process is performed for the next picture in decoding order in Step SP242. If Step SP246 continually outputs DS_terminate=FALSE until the target picture is found in Step SP242 to be recently removed from the virtual image of the complete DPB, the look-ahead processing will reach Step SP250. In Step SP250, the early removal mode is selected for the target picture j and the real DPB values are assigned as indicated below

i) early_removal_flag[j] of real DPB=1.

ii) full_resolution_flag[j] of real DPB=full_resolution_flag[j] of reduced DPB.

iii) DPB_removal_instance[j] of real DPB=DPB_removal_instance[j] of reduced DPB.

On the other hand, if Step SP247 finds DS_terminate to be TRUE, the look-ahead processing loop is terminated. Step SP249 selects the on-time removal mode with a down-sampled resolution to be used for the target picture j, and assigns the following values to the real DPB:

i) early_removal_flag[j] of real DPB=0.

ii) full_resolution_flag[j] of real DPB=0.

iii) DPB_removal_instance[j] of real DPB ontime_removal_instance

A reduced resolution is selected in Step SP260, and the resolution assigned to the frame is updated in Step SP280. Due to the early loop termination in Step SP244 or Step SP247, the look-ahead updating of the complete DPB state may not reach the instance where the target picture j is removed from the complete DPB. In this case, ontime_removal_instance does not contain a correct value in Step SP249. Step SP251 takes care of such occurrences. Step SP251 copies DPB_removal_instances[k] values for every picture k with early_removal_flag[k]=0 from the reduced DPB to the real DPB (DPB_removal_instance[k] of the reduced DPB are assigned in Step SP2453). Effectively, Step SP251 updates DPB_removal_instance of the picture j according to the on-time removal mode during the look-ahead processing of the subsequent pictures (picture (j+1) and the subsequent pictures). The look-ahead mechanism is such that DPB_removal_instance of the picture j according to the on-time removal mode is always assigned before its actual on-time removal instance from the real DPB.

Before terminating the look-ahead processing, Step SP252 copies the complete DPB state from the stored complete DPB for the look-ahead processing of the subsequent target pictures. Then, Step SP240 is terminated.

### Exemplary Illustration of Look-ahead Processing of Step SP240

### Example 1

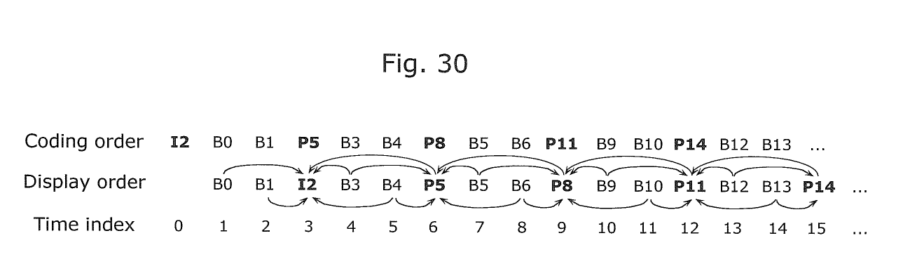

FIG. 30 illustrates a typical picture structure. Each picture is labeled XY where X indicates a picture type and Y indicates a display order. X may be I (an intra-coded picture), P (a predictive coded picture), B (a bi-predictive coded picture not used as a reference picture) or Br (a bi-predictive coded picture used as a reference picture). Picture referencing arrangements are shown by curved arrows. Assuming that a picture I2 is the first picture in the bitstream, a lower layer sufficiency check for the picture I2 proceeds as indicated below.

Look-ahead processing starts with lookahead_pic=12. At the end of decoding the picture I2 (when a time index=0), the picture I2 is stored into both the complete DPB and the reduced DPB. Reduced DPB flags are set as early_removal_flag[I2]=1 and full_resolution_flag[I2]=1 in Step SP2454. From partial decoding, the output time of the picture I2 is found to be when a time index=3. At this time, the picture I2 is not yet removed from the reduced DPB, and thus SP246 sets DS_terminate=FALSE, and lookahead_pic is advanced to B0.

During look-ahead processing of pictures B0 and B1, the states of the complete DPB and the reduced DPB are not changed because the pictures B0 and B1 are immediately displayed without being stored in the DPB. After picture P5 is decoded, both the complete DPB and the reduced DPB are updated. The reduced DPB flags are set as early_removal_flag[P5]=1, and full_resolution_flag[P5]=1 in Step SP2454. Continuing the look-ahead processing, it is recorded that pictures B3 and B4 do not change the states of the complete DPB and the reduced DPB.

After a picture P8 is decoded, both the complete DPB and the reduced DPB are updated. The complete DPB is updated according to standard H.264 processing in subclause 8.2.5.3 of [ADVANCED VIDEO CODING FOR GENERIC AUDIOVISUAL SERVICES ITU-T H.264]. For simplicity, it is assumed in this example that the first-in-first-out rule is used for the reduced DPB bumping process. Since there is no empty space in the reduced DPB, the picture I2 is bumped out when a time index=6 in order for the picture P8 to be stored. This step in turn activates SP2464 for a check under Condition 2. As the picture 12 is bumped out from the reduced DPB at a time index later than its display time index, Condition 2 is TRUE, and DS_terminate is set to FALSE. The look-ahead processing then continues for a picture B6.

During the look-ahead processing of the picture B6, it is found that the picture I2 is not used as a reference picture in decoding the picture B6. Therefore, Condition 1 is found to be TRUE in Step SP2466, and DS_terminate is set to FALSE. The look-ahead processing then continues in a similar manner to those for a picture B7 through a picture B10.

During the look-ahead processing of a picture P14, it is found that Condition 1 remains TRUE during decoding of the picture P14 (DS_terminate=FALSE), and the picture I2 is finally removed from the complete DPB at the end of the decoding of the picture P14. Hence, Step SP242 in turn terminates the look-ahead loop, and Step SP250 assigns the early removal mode to the target picture I2.

TABLE 2
Look-ahead processing for picture I2

| | Reference pictures | | | | | | | | | | | | | |
|---|---|---|---|---|---|---|---|---|---|---|---|---|---|---|
| | used for decoding | | Time index | DPB image after decoding | | | | | | | | | | |
| look- | lookahead_pic | | after decoding | lookahead_pic | | | | | | | | Cond | Cond | |
| ahead_pic | List 0 | List 1 | lookahead_pic | Complete-DPB | | | | | Reduced-DPB | | | 1 | 2 | Remark |
| I2 | — | — | 0 | I2 | — | — | — | W | I2 | — | W | | | I2 output time index = 3 |
| B0 | — | I2 | 1 | I2 | — | — | — | W | I2 | — | W | | | |
| B1 | — | I2 | 2 | I2 | — | — | — | W | I2 | — | W | | | |
| P5 | I2 | — | 3 | I2 | P5 | — | — | W | I2 | P5 | W | | | |
| B3 | I2 | P5 | 4 | I2 | P5 | — | — | W | I2 | P5 | W | | | |
| B4 | I2 | P5 | 5 | I2 | P5 | — | — | W | I2 | P5 | W | | | |
| P8 | P5 | — | 6 | I2 | P5 | P8 | — | W | P5 | P8 | W | | T | I2 is removed from reduced-DPB; |
| | | | | | | | | | | | | | | Stop updating reduced-DPB; |
| | | | | | | | | | | | | | | Check condition 2; |
| B6 | P5 | P8 | 7 | I2 | P5 | P8 | — | W | | | | T | | Start checking condition 1 |
| B7 | P5 | P8 | 8 | I2 | P5 | P8 | — | W | | | | T | | |
| P11 | P8 | — | 9 | I2 | P5 | P8 | P11 | W | | | | T | | |
| B9 | P8 | P11 | 10 | I2 | P5 | P8 | P11 | W | | | | T | | |
| B10 | P8 | P11 | 11 | I2 | P5 | P8 | P11 | W | | | | T | | |
| P14 | P11 | — | 12 | P5 | P8 | P11 | P14 | W | | | | T | | I2 is removed from complete-DPB; |
| | | | | | | | | | | | | | | terminate look-ahead processing |

### Exemplary Illustration of Look-ahead Processing of Step SP240

### Example 2

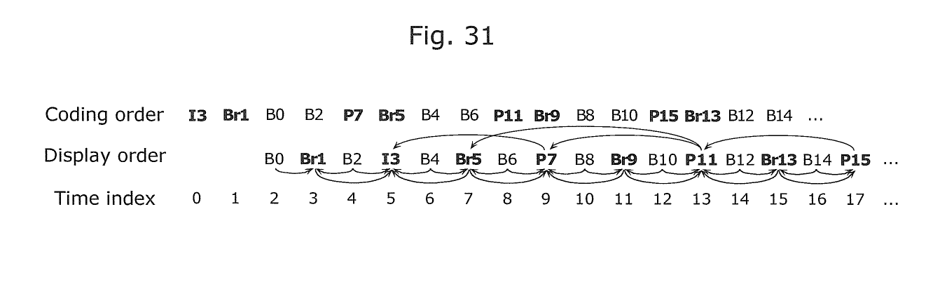

FIG. 31 illustrates another typical picture structure. It is assumed in this example that picture I3 is the first picture in the bitstream. In this second picture structure, it is observed that certain B-pictures (B1, B6, B10, . . . ) are not used as reference pictures but need to be stored in the DPB, due to the fact that these pictures are not immediately displayed after their decoding is finished. Therefore, both the complete DPB and the reduced DPB must be able to store these non-reference pictures in addition to the reference pictures. The look-ahead processing for several pictures is described as indicated below.

Look-Ahead Processing for Picture I3

When a time index=0, a picture I3 is stored into the empty complete to DPB and the reduced DPB. Reduced DPB flags are set as early_removal_flag[D]=1 and full_resolution_flag[I3]=1. The output time of the picture I3 is decoded to be when a time index=5. The look-ahead processing continues for the subsequent pictures (Pictures Br1, B0, B2, and so on). When the look-ahead processing reaches the picture B2, it is found that the picture I3 is to be bumped out of the reduced DPB when a time index=3 so that the picture B2 can be stored into the reduced DPB. This means that the picture I3 cannot be displayed at the intended time corresponding to when a time index=5, and Condition 2 is not satisfied. Hence, the look-ahead processing is terminated at Step SP247 and the picture I3 is selected to use the on-time removal mode.

Look-Ahead Processing for Picture Br1

At the start of the look-ahead processing on a picture Br1, the real DPB state is copied into the reduced DPB. Then, when a time index=1, the recently decoded Br1 is stored into the complete DPB and the reduced DPB. Reduced DPB flags are set as early_removal_flag[Br1]=1 and full_resolution_flag[Br1]=1. The output time of the picture Br1 is decoded to be when a time index=3. The look-ahead processing continues for the subsequent pictures. When the look-ahead processing reaches the picture B2, it is found that the picture Br1 is to be bumped out of the reduced DPB when the time index=3. Since this matches the intended output instance of the picture Br1, Condition 2 is satisfied. The look-ahead processing then continues to a picture P7. During decoding the picture P7, the picture Br1 is not used as a reference picture, and therefore Condition 1 is satisfied. In this example, it is defined that a DPB management command is issued in the bitstream to remove the picture Br1 from the DPB at the end of decoding the picture P7. Hence, when a time index=4, the picture Br1 is removed from the complete DPB. The look-ahead processing is then terminated in Step SP242, and the picture Br1 is selected to use the early removal mode.

Look-Ahead Processing for Picture B0

At the start of look-ahead processing on a picture B0, the real DPB state is copied into the reduced DPB. Then, when a time index=2, partial decoding in Step SP245 finds that the picture B0 does not need to be stored in the DPB. Hence, the look-ahead processing is terminated in Step SP242 without any changes to the complete DPB and the reduced DPB. At the end of physical/actual decoding of the picture B0, the picture B0 is immediately sent for output and display without being stored in the real DPB.

Look-Ahead Processing for Picture B2

At the start of look-ahead processing on a picture B2, the real DPB state is copied into the reduced DPB. Then, when a time index=2, partial decoding in Step SP245 finds that the picture B2 needs to be stored in the DPB until when a time index=4. The picture Br1 is then bumped out from the reduced DPB, and the picture B2 is stored into the reduced DPB. The look-ahead processing continues for a picture P7. At the end of decoding the picture P7 (when a time index=4), the picture B2 is bumped out of the reduced DPB, and the picture P7 is stored into the reduced DPB. Time index for bumping out the picture B2 from the reduced DPB matches the time index for removing the picture B2 from the complete DPB, hence Condition 2 is satisfied. The picture B2 is not used as a reference picture, hence Condition 1 is satisfied. Therefore, the early removal mode is selected for the picture B2.

Look-Ahead Processing for Picture P7

At the start of look-ahead processing on the picture P7, the state of the real DPB is copied into the reduced DPB. Then, when a time index=4, the recently decoded picture P7 is stored into the complete DPB and the reduced DPB (B2 is bumped out of the reduced DPB). Reduced DPB flags are set as early_removal_flag[P7]=1 and full_resolution_flag[P7]=1. The output time of the picture P7 is decoded to be when a time index=9. The look-ahead processing continues for a picture Br5. At the end of decoding the picture Br5, it is found that the picture P7 is to be bumped out of the reduced DPB when a time index=5. This means that the picture P7 cannot be displayed at the intended time corresponding to when a index=9, and Condition 2 is not satisfied. Hence, the look-ahead processing is terminated in Step SP248, and the picture P7 is selected to use the on-time removal mode.

Look-Ahead Processing for Picture Br5

To illustrate a situation where Condition 1 is not satisfied, picture referencing of a picture P11 is modified to include the picture Br5 (FIG. 31). At the start of look-ahead processing on the picture Br5, the state of the real DPB is copied into the reduced DPB. Then, when a time index=1, the recently decoded picture Br5 is stored into the complete DPB and the reduced DPB. Reduced DPB flags are set as early_removal_flag[Br5]=1 and full_resolution_flag[Br5]=1. The output time of the picture Br5 is decoded to be when a time index=7. The look-ahead processing continues for the subsequent pictures.

When the look-ahead processing reaches a picture B6, it is found that the picture Br5 is to be bumped out of the reduced DPB when a time index=7. Since this matches the intended output instance of the picture Br5, Condition 2 is satisfied. The look-ahead processing then continues for a picture P11. During the decoding of the picture P11, it is found that the picture Br5 is used as a reference picture by the picture P11, and therefore Condition 1 is not satisfied. The look-ahead processing is then terminated in Step SP248, and the picture Br5 is selected to use the on-time removal mode.

Look-ahead processing for the subsequent pictures can be worked out in a similar manner.

From the above exemplary descriptions, it can be observed that look-ahead processing enables the decoder to perform adaptive switching between the full resolution decoding and a reduced resolution decoding in the reduced memory video decoder at the picture level. In the case of the picture structure in Example 1, one can infer that all reference pictures can be stored at the full resolution in the reduced-size DPB. For the picture structure in example 2, some reference pictures can be stored in the full resolution DPB. Storing reference pictures in the full resolution reference pictures whenever possible allows the reduced memory decoder to have reduced error drift compared to error drift caused in the case of a conventional reduced memory video decoder, and thereby obtaining decoded images having a better visual quality.

TABLE 3
Look-ahead processing for picture I3

| | Reference pictures | | | | | | | | | | | | | |
|---|---|---|---|---|---|---|---|---|---|---|---|---|---|---|
| | used for decoding | | Time index | DPB image after decoding | | | | | | | | | | |
| look- | lookahead_pic | | after decoding | lookahead_pic | | | | | | | | Cond | Cond | |
| ahead_pic | List 0 | List 1 | lookahead_pic | Complete-DPB | | | | | Reduced-DPB | | | 1 | 2 | Remark |
| I3 | — | — | 0 | I3 | — | — | — | W | I3 | — | W | | | I3 output time index = 5 |
| Br1 | — | I3 | 1 | I3 | Br1 | — | — | W | I3 | Br1 | W | | | |
| B0 | — | Br1 | 2 | I3 | Br1 | — | — | W | I3 | Br1 | W | | | |
| B2 | Br1 | I3 | 3 | I3 | Br1 | B2 | — | W | Br1 | B2 | W | | F | I3 is removed from reduced-DPB |

TABLE 4
Look-ahead processing for picture Br1

| | Reference pictures | | | | | | | | | | | | | | |
|---|---|---|---|---|---|---|---|---|---|---|---|---|---|---|---|
| | used for decoding | | Time index | DPB image after decoding | | | | | | | | | | | |
| look- | lookahead_pic | | after decoding | lookahead_pic | | | | | | | | | Cond | Cond | |
| ahead_pic | List 0 | List 1 | lookahead_pic | Complete-DPB | | | | | Reduced-DPB | | | | 1 | 2 | Remark |
| Br1 | — | I3 | 1 | I3 | Br1 | — | — | W | I3 | Br1 | — | W | | | Br1 output time index = 3 |
| B0 | — | Br1 | 2 | I3 | Br1 | — | — | W | I3 | Br1 | — | W | | | |
| B2 | Br1 | I3 | 3 | I3 | Br1 | B2 | — | W | I3 | B2 | — | W | | T | Br1 is removed from reduced-DPB |
| P7 | I3 | — | 4 | I3 | P7 | — | — | W | | | | | T | | Br1 is removed from complete-DPB |

TABLE 5
Look-ahead processing for picture B0

| | Reference pictures | | | | | | | | | | | | | | |
|---|---|---|---|---|---|---|---|---|---|---|---|---|---|---|---|
| | used for decoding | | Time index | DPB image after decoding | | | | | | | | | | | |
| look- | lookahead_pic | | after decoding | lookahead_pic | | | | | | | | | Cond | Cond | |
| ahead_pic | List 0 | List 1 | lookahead_pic | Complete-DPB | | | | | Reduced-DPB | | | | 1 | 2 | Remark |
| B0 | — | Br1 | 2 | I3 | Br1 | B2 | — | W | I3 | Br1 | — | W | T | T | B0 output time index = 2; |
| | | | | | | | | | | | | | | | B0 is immediately output without |
| | | | | | | | | | | | | | | | storing in DPB |

TABLE 6
Look-ahead processing for picture B2

| | Reference pictures | | | | | | | | | | | | | | |
|---|---|---|---|---|---|---|---|---|---|---|---|---|---|---|---|
| | used for decoding | | Time index | DPB image after decoding | | | | | | | | | | | |
| look- | lookahead_pic | | after decoding | lookahead_pic | | | | | | | | | Cond | Cond | |
| ahead_pic | List 0 | List 1 | lookahead_pic | Complete-DPB | | | | | Reduced-DPB | | | | 1 | 2 | Remark |
| B2 | Br1 | I3 | 3 | I3 | Br1 | B2 | — | W | I3 | B2 | — | W | | | B2 output time index = 4 |
| P7 | I3 | — | 4 | I3 | P7 | — | — | W | I3 | P7 | — | W | T | T | B2 is removed from reduced-DPB; |
| | | | | | | | | | | | | | | | B2 is removed from complete-DPB |

TABLE 7
Look-ahead processing for picture P7

| | Reference pictures | | | | | | | | | | | | | | |
|---|---|---|---|---|---|---|---|---|---|---|---|---|---|---|---|
| | used for decoding | | Time index | DPB image after decoding | | | | | | | | | | | |
| look- | lookahead_pic | | after decoding | lookahead_pic | | | | | | | | | Cond | Cond | |
| ahead_pic | List 0 | List 1 | lookahead_pic | Complete-DPB | | | | | Reduced-DPB | | | | 1 | 2 | Remark |
| P7 | I3 | — | 4 | I3 | P7 | — | — | W | I3 | P7 | — | W | | | P7 output time index = 9 |
| Br5 | I3 | P7 | 5 | I3 | P7 | Br5 | — | W | I3 | Br5 | — | W | | F | P7 is removed from reduced-DPB |

TABLE 8
Look-ahead processing for picture Br5

| | Reference pictures | | | | | | | | | | | | | | |
|---|---|---|---|---|---|---|---|---|---|---|---|---|---|---|---|
| | used for decoding | | Time index | DPB image after decoding | | | | | | | | | | | |
| look- | lookahead_pic | | after decoding | lookahead_pic | | | | | | | | | Cond | Cond | |
| ahead_pic | List 0 | List 1 | lookahead_pic | Complete-DPB | | | | | Reduced-DPB | | | | 1 | 2 | Remark |
| Br5 | I3 | P7 | 5 | I3 | P7 | Br5 | — | W | I3 | P7 | Br5 | W | | | Br5 output time index = 7 |
| B4 | I3 | Br5 | 6 | I3 | P7 | Br5 | — | W | I3 | P7 | Br5 | W | | | |
| B5 | Br5 | P7 | 7 | I3 | P7 | Br5 | B5 | W | I3 | P7 | B6 | W | | T | Br5 is removed from reduced-DPB |
| P11 | Br5, P7 | — | 8 | P7 | Br5 | P11 | — | W | | | | | F | | |

Full Resolution/Reduced Resolution Decoder (Step SP30)

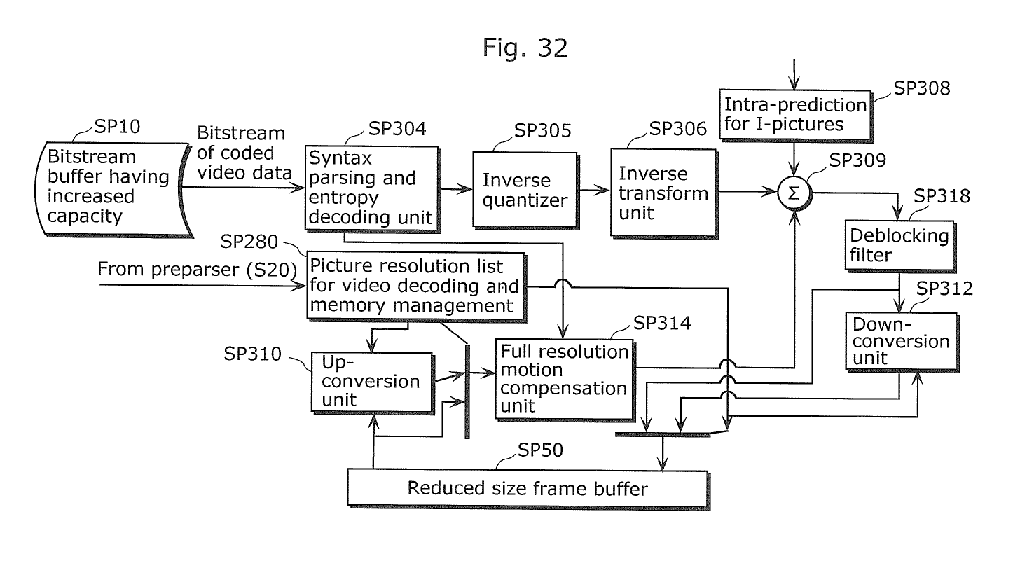

Refer to FIG. 32. In this step, the video stream is decoded based on the resolutions of the decoding picture and the reference pictures predetermined in Step SP20.

The video bitstream is passed from the buffer having an increased capacity (Step SP10) to the syntax parsing and entropy decoding unit (Step SP304). Entropy decoding may include either CAVLD or CABAC. The inverse quantizer is coupled to the syntax parsing and entropy decoding unit to inversely quantize the entropy decoded coefficients (Step SP305). The frame buffer (Step SP50) stores video pictures having resolutions determined in Step SP20. The resolution assigned to each frame is either a predetermined down-conversion ratio, or the full resolution. Information related to the resolutions of the reference frames are provided to Step SP30 by Step SP20 in Step SP280. In the case of images decoded at reduced resolutions, the image data is either stored in down-sampled form representative of the image having a reduced resolution or in a compressed format in Step SP50. Full resolution images are stored in their original form (Step SP50). If the reference frame of MC used has a reduced resolution, the up-convertor retrieves the down-converted video pixels and reconstructs the pixels at the full resolution for MC in Step SP310 (either image up-sampling or decompression of compressed data is performed depending on the down-conversion mode used). Otherwise, the reference frame is fetched and provided to the motion compensation (MC) unit as it is. The data is provided to the MC unit via the data selector present at the input of the MC unit. If the reference frame has a reduced resolution, the up-converted image is selected for inputs to the MC unit. Otherwise, the image data fetched from the frame buffer (Step SP50) is selected as it is for inputs to the MC unit. The MC unit performs image prediction based on the pixels at the full resolution to obtain the prediction pixels based on the decoded parameters (Step SP314). The IDCT block receives the inversely quantized coefficients and transforms these coefficients to obtain transformed pixels (Step SP306). Intra-prediction is performed if required using data from the neighboring blocks (Step SP308). The intra-predicted values, if present, are added to the motion compensated pixels to obtain the prediction pixel values (Step SP309). The transformed pixels and the prediction pixels are then summed up to obtain the reconstructed pixels (Step SP309). The deblocking filtering process is performed if required to obtain the final reconstructed pixels (Step SP318). From Step SP280, if the decoding frame has a reduced resolution, the reconstructed pixels are down-converted (Step SP312) by either a compressor or an image down-sampler, and stored into the frame buffer. If the decoding frame has the full resolution, the reconstructed pixels are stored as it is to the frame buffer. The data selector present at the input to the reduced frame buffer selects the full resolution data when the decoding picture has the full resolution, and otherwise selects the down-converted image data.

Down-conversion Unit (Step SP312) and Up-conversion Unit (Step SP310)

H.264 video decoding is sensitive to possible noise introduction in reference image information that may be lost due to the usage of intra-prediction. Even though decoding at a reduced resolution is only performed when necessary in Embodiments, the error introduced in the down-conversion should be minimized to produce decoded images having a good visual quality.

In the preferred Embodiment, the down-sampling process is performed using a technique for embedding a part of the high order transform coefficients discarded in the down-sampling process in the down-sampled data. The up-sampling process extracts and uses the embedded information in the down-sampled data to recover the part of the high order transform coefficients lost in the down-sampling process in the down-sampled data.

The down-sampling and up-sampling process may involve, reversible orthogonal frequency transform such as Fourier transform (DFT), Hadamard transform, Karhunen Leve transform (KLT), discrete cosine transform (DCT) and Legendre transform. In this Embodiment, DCT/IDCT basis functions are used in the down-sampling and up-sampling processes.

Alternatively, other optimal down-conversion technique may be used for such up-conversion and down-conversion. Examples of the alternative compression and decompression techniques are provided in the background art [Video Memory Management for MPEG Video Decode and Display System, Zoran Corporation, U.S. Pat. No. 6,198,773 B1, Mar. 6, 2001].

Down-Sampling Unit (Step SP312)

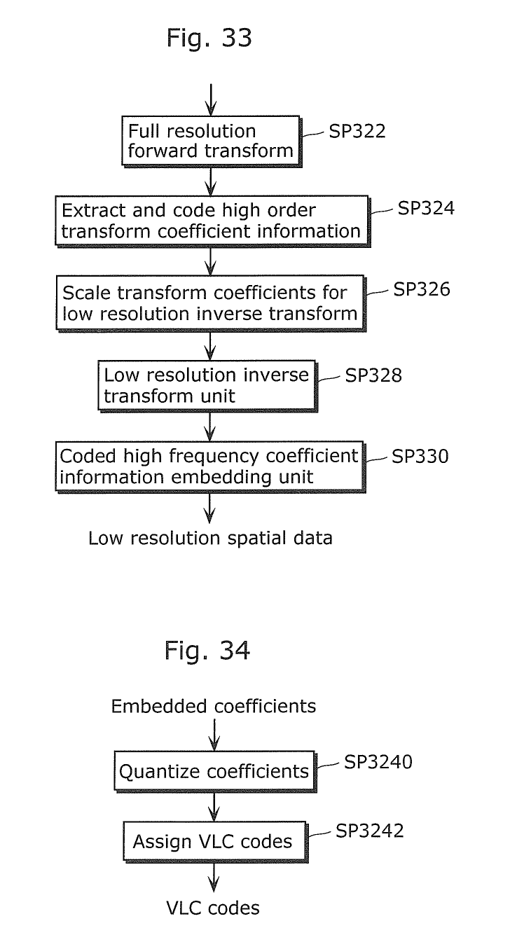

FIG. 33 is an overview flowchart relating to the down-sampling unit that generates reduced resolution images according to this Embodiment in the present invention. The full resolution spatial data (size NF) and the intended down-sampled data size (NS) are passed as inputs to the Step SP322.

Step SP322—Full Resolution Forward Transform

DCT and IDCT Kernel K

The N×N two dimensional DCT is defined as the earlier provided Expression 1.

In the above Expression, x, and y are spatial coordinates in the sample domain, and u and v are coordinates in the transform domain. See the earlier provided Expression 2.

The mathematical real number IDCT is defined as the earlier provided Expression 3.

In the implementation of an IDCT circuit, the matrix operations are used instead of using the mathematical equation. The transform kernel is defined, and the direct DCT and IDCT computations are just matrix multiplying operations. From Expressions 1 and 2, we can derive the DCT/IDCT transform kernel, K(m, n) (m=[0,N], n=[0,N]), according to the following Math. (Expression) 10.

$$K ( m , n ) = \sqrt{\frac{2}{N}} cos \frac{( 2 n + 1 ) m π}{2 N} \qquad [ Math . 10 ]$$

The DCT coefficients (U) at the full resolution (size NF×NF) are obtained by matrix multiplying the forward DCT (FDCT) kernel K (Expression 10 where N=NF) to the transpose of the spatial data at the full resolution (Step SP322). It can be expressed as U=KF.XT, where X denotes the spatial data at the full resolution.

Step SP324—Extract and Code High Order Transform Coefficients

NF high order transform coefficients results from the DCT operations. The number of transform coefficients to be discarded is NF−NS, and the high order transform coefficients that can be coded ranges from NS+1 to NF.

The high order transform coefficients are first quantized before they are coded (Step SP3240 of FIG. 34). The high order transform coefficients can be coded using either linear quantization scales or non-linear quantization scales. The rule to observe in the quantization scheme design is that the amount of overall information of the down-sampled pixels after embedment must always be greater than the amount of information before the embedment.

VLCs are then assigned to the quantized high order transform coefficients (Step SP3242 of FIG. 34). In this Embodiment in the present invention, the lengths of VLCs are progressively increased to code bigger quantized transform coefficients. This is because embedding VLCs in the reduced resolution data would result in impairment in the reduced resolution contents. It is thus only justifiable to use longer VLCs to embed bigger transform coefficients, so that the gains from the embedment are positive. The key rule to observe in the design of a VLC coding table for the quantized coefficients is that the amount of overall information of the down-sampled pixels after embedment must always be greater than the amount of information before the embedment for every set of VLC code and quantized coefficient.

Step SP326—Transform Coefficient Scaling for Reduced Resolution Inverse Transform

Before taking the NS-point IDCT of the NF-point DCT low frequency coefficients, the coefficients must be scaled because of the 1/blocksize scaling in the DCT-IDCT pair [Reference: Minimal Error Drift in Frequency Scalability for Motion-Compensated DCT Coding, Robert Mokry and Dimitris Anastassiou, IEEE Transactions on Circuits and Systems for Video Technology].

$$\sqrt{\frac{{N}_{F}}{{N}_{s}}} \qquad [ Math . 11 ]$$

The DCT coefficients are then scaled down by a factor of the above Expression prior to IDCT.

Step SP328—Reduced Resolution Inverse Transform Unit

The IDCT is performed by multiplying the inverse transform kernel used for decimation (Expression 10 where N=Ns) to the inverse transform kernel of the DCT coefficients selected and scaled for low resolution inverse transform (Step SP330). It can be expressed as Xs=KsT.U.

Step SP330—Coded High Order Transform Coefficient Information Embedding Unit

This Embodiment uses a spatial watermarking technique. Alternatively, watermarking may be performed in the transform domain. To ensure effectiveness of the embedment scheme, the embedment scheme must ensure that the amount of the overall information after embedment of high order transform coefficient information is greater than the amount of information before the embedment.

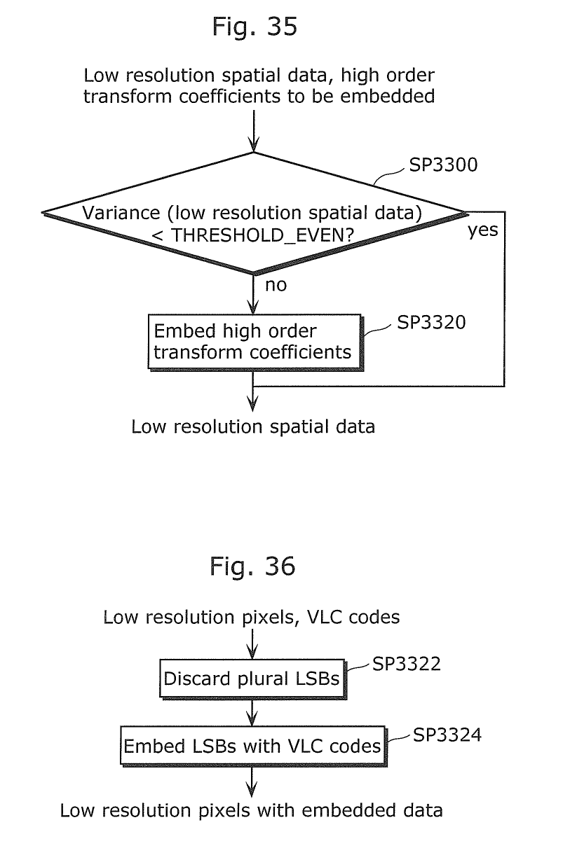

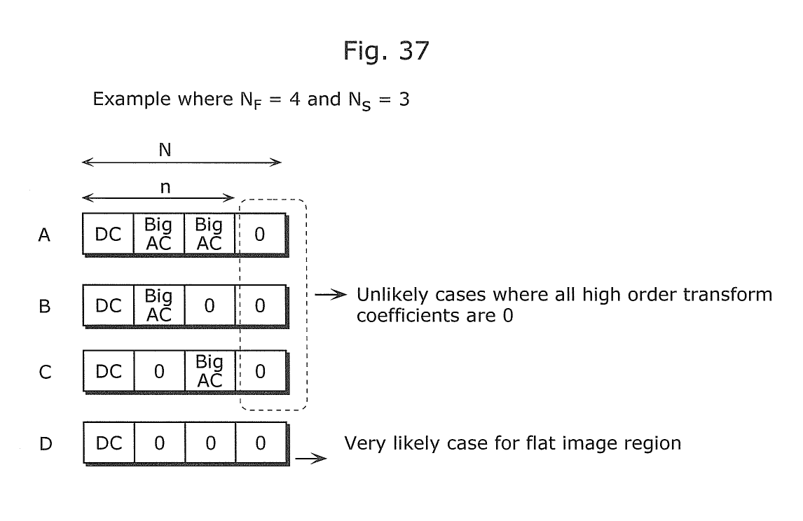

The variance of the reduced resolution spatial data is checked (Step SP3300 of FIG. 35). If the variance is very low, the pixel values are highly similar to their surrounding pixels (even region). The variance of the low resolution pixels is computed using the following Math. (Expression) 12

$$Variance = \frac{{\sum }_{i = 1}^{{N}_{s}} {( {x}_{i} - μ )}^{2}}{{N}_{s}} \qquad [ Math . 12 ]$$

Ns is the number of low resolution pixels, and p is the mean of the low resolution pixels given by the following Math. (Expression) 13

$$μ = \frac{{\sum }_{i = 1}^{{N}_{s}} {x}_{i}}{{N}_{s}} \qquad [ Math . 13 ]$$

For example, for a 3 pixels having values 121, 122, 123 respectively, the p is 122, and the variance is 0.666.

If the variance is smaller than a predetermined threshold THRESHOLD_EVEN, the reduced resolution spatial data is output without embedding any high order transform coefficient. If the result in Step SP3300 is found to be false, high order transform coefficients are embedded in Step SP3320. Spatial watermarking of Step SP3320 is performed on first truncating LSBs of the reduced resolution pixels (Step SP3322) by masking the affected LSBs to 0 (FIG. 36), followed by embedding the LSBs with VLC codes obtained in Step SP3242 using the OR mathematical function.

The spatially watermarked reduced resolution spatial data are sent to the external memory buffer and stored for future reference use.

Step SP342—Decode Embedded High Order Coefficient Information

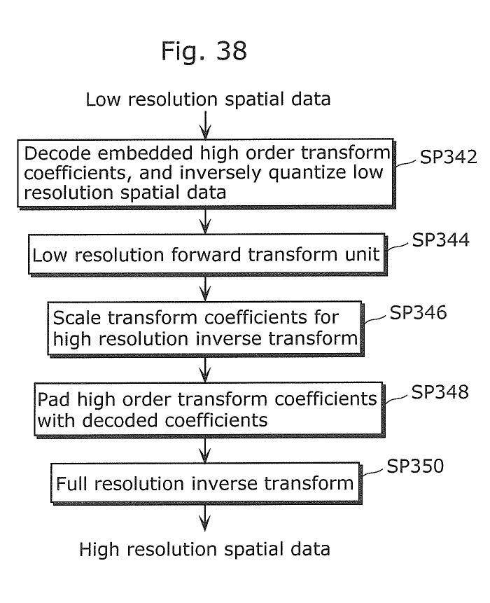

Refer to FIG. 38. The embedded high order transform coefficient information of a line of NS spatial resolution data is decoded using the LSBs of the reduced resolution data in Step SP310 according to the coding and spatial watermarking schemes used.

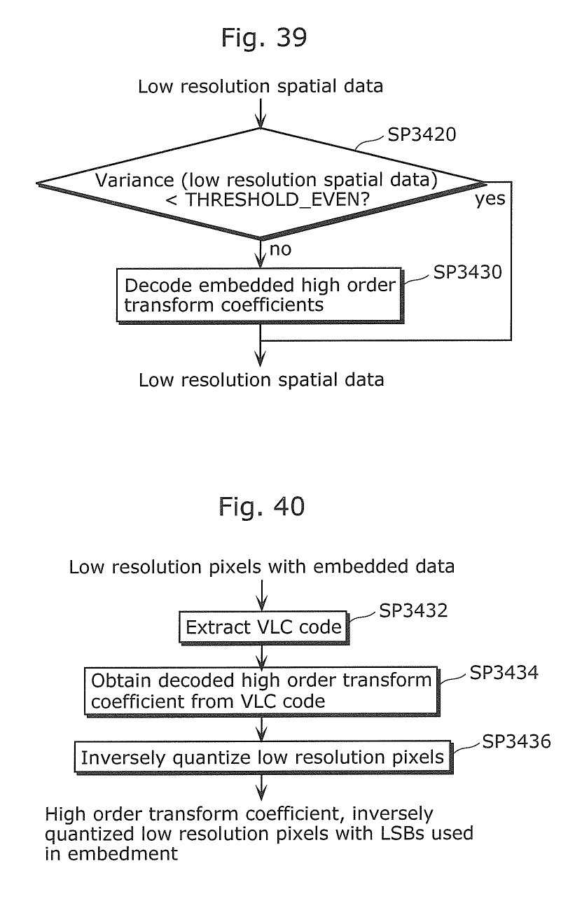

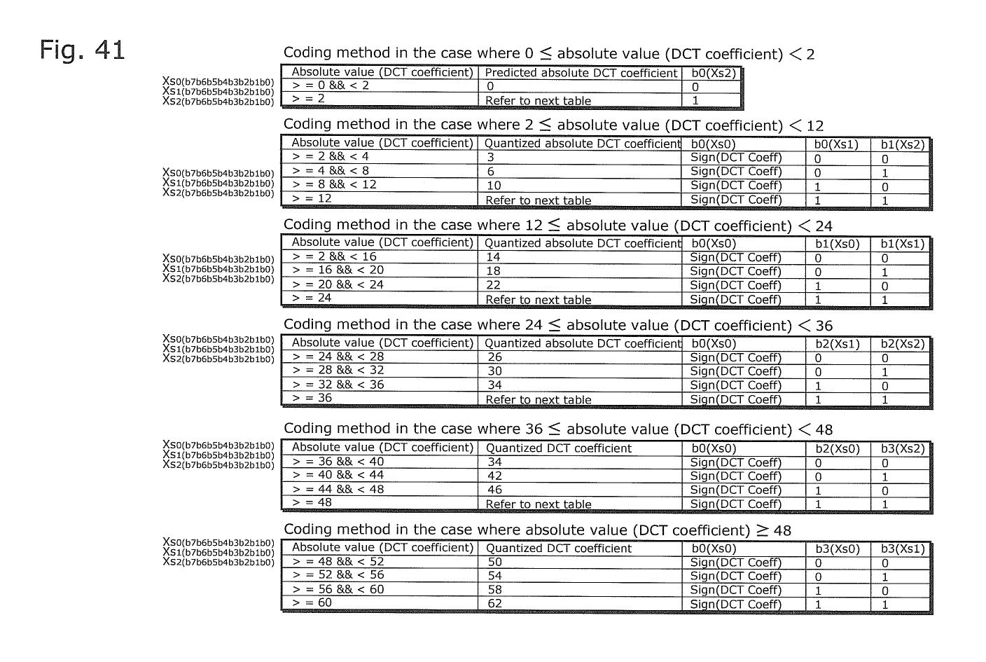

In Step SP3420 (FIG. 39), the variance of the reduced resolution spatial data are checked to be less than THRESHOLD_EVEN.

If the result is found to be true, no information is embedded in the reduced resolution spatial data because the region is more likely to be an even region. If the result is found to be false, the LSBs are VLC decoded (Step SP3430). The variable length decoding is performed in Step SP3432 to extract the embedded VLC codes. The extracted VLC codes are checked in the predefined lookup VLC table to obtain the quantized high order transform coefficients (Step SP3434). The reduced resolution pixels are subsequently inversely quantized by first masking the LSBs used for embedment to 0, followed by adding half of the values equivalent to those of the LSBs used for VLC embedment (Step SP3436) before they are passed to Step SP344.

Step SP344—Reduced Resolution Forward Transform

The reduced resolution transform coefficients of the spatial input are obtained next in Step SP344 by performing a reduced resolution forward transform. This operation can be expressed as U=KS.XST, where XS denotes the spatial data in the down-sampled domain and KS denotes the reduced resolution DCT transform kernel.

Step SP346—Up-Scaling of DCT Coefficients

Before taking the NE-point IDCT of the NS-point DCT low frequency coefficients, the coefficients must be scaled because of the 1/blocksize scaling in the DCT-IDCT pair [Reference: Minimal Error Drift in Frequency Scalability for Motion-Compensated DCT Coding, Robert Mokry and Dimitris Anastassiou, IEEE Transactions on Circuits and Systems for Video Technology].

$$\sqrt{\frac{{N}_{F}}{{N}_{s}}} \qquad [ Math . 14 ]$$

The DCT coefficients are then scaled up by a factor of the above Expression prior to IDCT.

Step SP348—Padding of High Order Transform Coefficients Estimated

In Step SP348, the high order transform coefficients decoded in Step SP344 are then padded as the higher DCT coefficients to those obtained in Step SP346. The higher DCT coefficients which are not involved in the embedment of the high order transform coefficients are padded to 0.

Step SP350—Full Resolution IDCT

In Step SP350, the IDCT is performed by multiplying the inverse transform kernel used for decimation (Expression 10 where N=NF) with the inverse transform kernel of the selected full resolution DCT coefficients obtained in Step SP348.

\hat{X}_{F}=K_{F}^{T}·Û_{F} [Math. 15]

It can be expressed as the above Expression.

\hat{X}_{F} [Math. 16]

The above denotes the reconstructed spatial data at the full resolution.

Û_{F} [Math. 17]

The above denotes the reconstructed DCT coefficients in Step SP348, and KF denotes the reduced resolution DCT transform kernel.

Video Display Subsystem (STEP SP40)

The video display subsystem (Step SP40) uses the frame resolution information provided in Step SP20 and the display order information provided in Step SP30 to display the video at a suitable resolution and in correct order. The video display subsystem retrieves the picture data from the frame buffer for display purposes according to the picture display order. If the display picture is compressed, the corresponding decompressor is used to convert the data into data having a full resolution. If the display picture is down-sampled, it can be scaled by a generic image up-scaling function up to the full resolution using a post processing unit. If the image has the full resolution, it is displayed as it is.

Simplified Implementation Of Adaptive Full Resolution/Reduced Resolution Video Decoder without Preparser

An alternative simplified implementation which does not require the use of a preparser to determine the resolution of the frames is provided in this Embodiment.

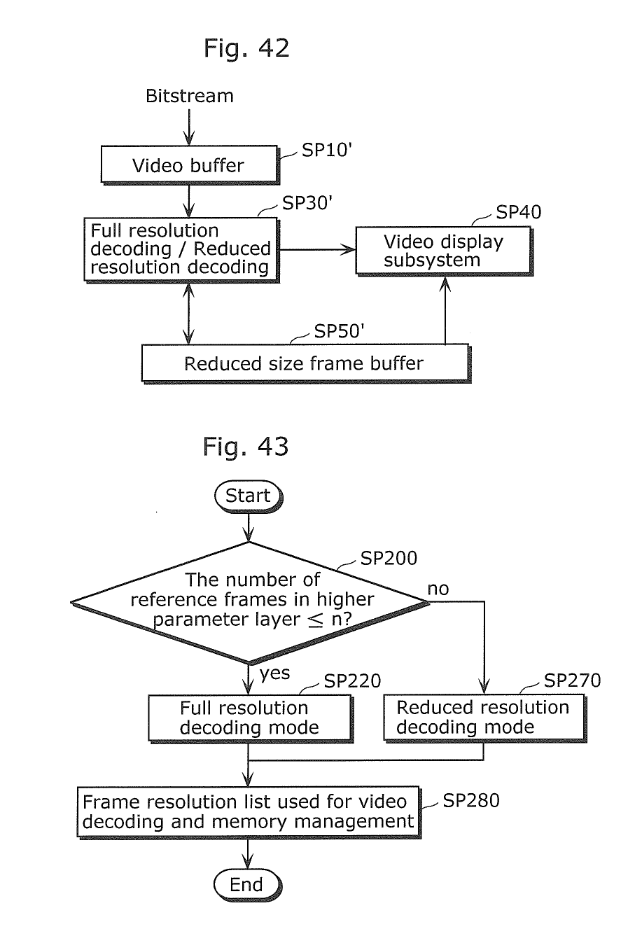

Refer to FIG. 42. In this Embodiment, the video buffer having a size that is no bigger than that of a conventional decoder (Step SP10′) provides compressed video data to the adaptive full resolution/reduced resolution video decoder in Step SP30′. In Step SP30′, the syntax parsing and entropy decoding unit checks the upper layer parameters for the number of reference frames used in the decoding sequence. If the number of reference frames used is found to be less than or equal to the number of full reference frames which can be handled by the reduced-size frame buffer (Step SP50′), full resolution decoding is performed in Step SP30′. Otherwise, reduced resolution decoding is performed in Step SP30′. The decoded image data is then stored in the reduced-size frame buffer in Step SP50′. The decoded data is sent to the video display subsystem (Step SP40) which up-converts the fetched data to data having the correct resolution if necessary for display purposes.

Video Buffer for Simplified Alternative Implementation (Step SP10′)

In this alternative simplified implementation in FIG. 42, the video buffer size in Step SP10′ is not bigger than that required for a conventional decoder because the parsing parameters for determining whether the full resolution decoding or the reduced resolution decoding can be performed in the main decoding loop. Look-ahead parsing is not required because only the higher layer parameters are parsed before the decoding of the pictures, which have the parameter set defined in the higher layer parameters. The alternative simplified implementation, however, has less effectiveness compared to the full implementation, as the lower layer parameters which affect the DPB operations are not checked to determine the number of frames required for every frame. For example, the higher layer parameter may indicate the maximum use of 4 reference frames. However, in the frame decoding, the actual number of reference frames used may only be 2 for most of the pictures.

Reduced-Size Frame Buffer (Step SP50′)

The size of the reduced-size frame buffer is identical to that defined in Step SP50 for the alternative simplified implementation. However, the frame buffer DPB management is much simplified compared to that of Step SP50 because the reduced-size frame buffer stores the frames either at the full resolution or in a reduced size for pictures defined in the higher parameter layer (Sequence Parameter Set in the case of H.264).

Full Resolution/Reduced Resolution Decoder of Alternative Simplified Implementation (STEP SP30′)

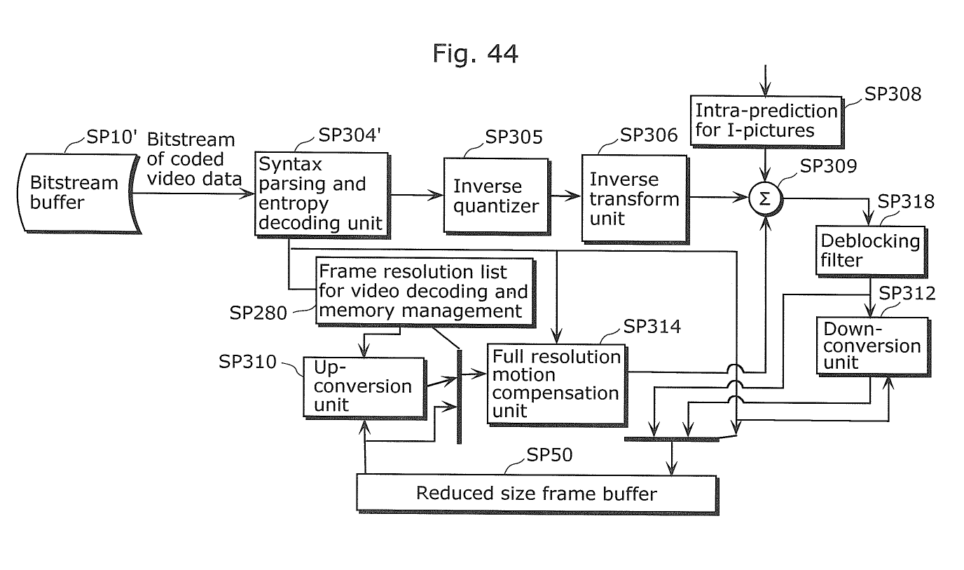

Refer to FIG. 44. The operations in Step SP30′ differ from Step SP30 in the resolution of the decoding frame determined in the Step SP30 without using a preparser.

Refer to FIG. 44. The video bitstream is passed from the bitstream buffer (Step SP10′) to the syntax parsing and entropy decoding unit (Step SP304′). Entropy decoding may include either CAVLD or CABAC. Step SP304′, Step SP200, Step SP220, Step SP270 and Step SP280 (FIG. 43) are performed to determine the decoding mode of the pictures defined by the higher layer parameter (SPS in the case of H264). Here, only the upper layer parameters are parsed to determine the number of reference frames used in the bitstream sequence. The inverse quantizer is coupled to the syntax parsing and entropy decoding unit to inversely quantize the entropy decoded coefficients (Step SP305). The frame buffer (Step SP50) stores video pictures having resolutions determined in Step SP20. The resolution assigned to each frame is either a predetermined down-conversion ratio, or the full resolution. In the case of images decoded at reduced resolutions, the image data is either stored in down-sampled form representative of the image having a reduced resolution or in a compressed format in Step SP50. Full resolution images are stored in their original form (Step SP50). If the reference frame for MC has a reduced resolution, the up-convertor retrieves the down-converted video pixels and reconstructs the pixels at the full resolution for Motion Compensation (MC) in Step SP310 (either image up-sampling or decompression of compressed data is performed depending on the down-conversion mode used). Otherwise, the reference frame is fetched and provided to the MC unit as it is. The data is provided to the motion compensation unit via the data selector present at the input of the MC unit. If the reference frame has a reduced resolution, the up-converted image is selected for inputs to the MC unit, otherwise, the image data fetched from the frame buffer (Step SP50) is selected as it is for inputs to the MC unit. The MC unit performs image prediction based on the pixels at the full resolution to obtain the prediction pixels based on the decoded parameters (Step SP314). The IDCT block receives the inverse quantized coefficients and transforms these coefficients to obtain transformed pixels (Step SP306). Intra-prediction is performed if required using data from the neighbouring blocks (Step SP308). The intra-predicted values, if present, are added to the motion compensated pixels to obtain the prediction pixels values (Step SP309). The transformed pixels and the prediction pixels are then summed up to obtain reconstructed pixels (Step SP309). A deblocking filtering process is performed if required to obtain the final reconstructed pixels (Step SP318). From Step SP280, if the decoding frame has a reduced resolution, the reconstructed pixels are down-converted (Step SP312) by either a compressor or an image down-sampler and stored into the frame buffer. If the decoding frame has the full resolution, the reconstructed pixels are stored as it is to the frame buffer. The data selector present at the input to the reduced frame buffer selects the full resolution data if the decoding picture has the full resolution and selects the down-converted image data otherwise.

Upper Parameter Layer Check (Step SP200, Step SP220, Step SP270, Step SP280)

Refer to FIG. 43. Here, the number of reference frames used is checked for the possibility of reduced DPB operations in Step SP200. In H.264, the field “num_ref_frame” in the sequence parameter set (SPS) indicates the number of reference frames used for the decoding of pictures before the next SPS. If the number of reference frames used is less than or equal to that which the reduced DPB frame memory can contain at the full resolutions, the full resolution decoding mode is assigned (Step SP220). Accordingly, the frame resolution list (Step SP280) is updated which will be used later for video decoding and memory management by the decoder and display subsystem. If the result of a reduced DPB sufficiency check is false in Step SP200, the reduced resolution decoding mode is assigned (Step SP270). The frame resolution list (Step SP280) is updated accordingly.

Table 1 provides the assignments of the resolutions of the decoding pictures for an exemplary video decoder with the reduced-size buffer for storing 2 reference frames at the full resolution.

TABLE 9
Exemplary decoding resolutions for reduced frame buffer having size
corresponding to 2 full frames at full resolution

| | Decoding resolution | Decoding resolution |
|---|---|---|
| num_ref_frame | mode | (fraction of full resolution) |
| 1 | Full resolution | 1 |
| 2 | Full resolution | 1 |
| 3 | Reduced resolution | ⅔ |
| 4 | Reduced resolution | ½ |

In Step SP200, a reduced resolution is assigned if the number of reference frames used is found to be 4 exceeding the number of reference frames that can by handled by the reduced-size frame buffer, and the decoded image are down-converted to half of the full resolution so that the frame buffer can store 4 reduced resolution image data. Otherwise, if the number of reference frames used is found to be 2 or less, the full decoding mode is assigned to the reduced-size frame buffer to specify storage of the reference frames at the full resolutions.

Exemplary System LSI in the Present Invention

Exemplary System LSI with Preparser

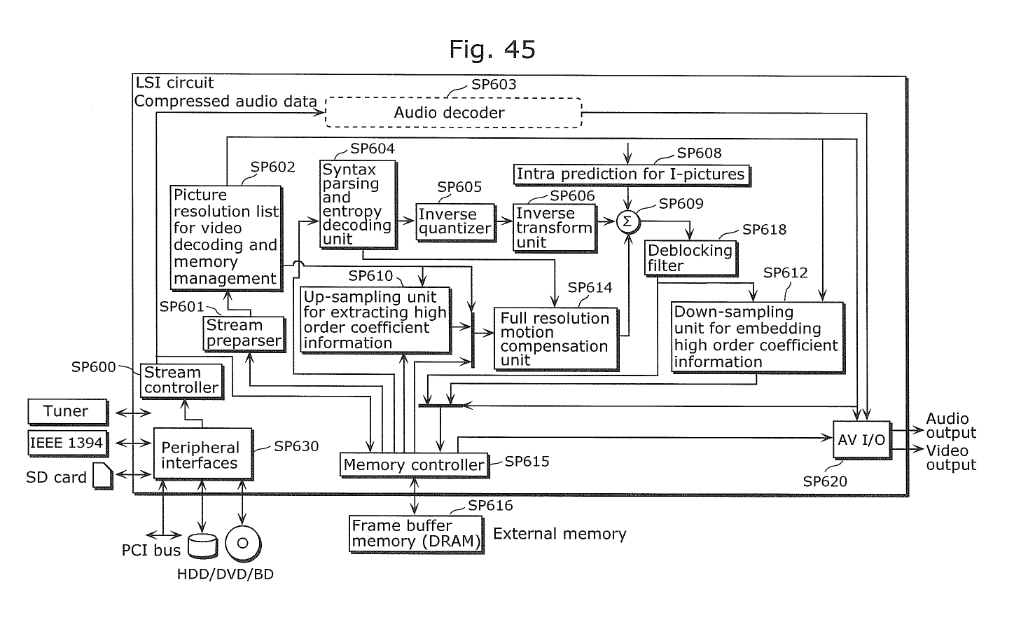

Each of the apparatuses and processes of the exemplary Embodiments can be implemented as a system LSI, for example, as schematically shown in FIG. 45. (Note that the functionalities in the dotted box are only briefly described as they are beyond the scope of the present invention, and are only provided for completeness of the explanations.)

The system LSI includes: peripheral interfaces for transferring input compressed video streams to the area designated for a video buffer in the external memory; a preparser that determines and assigns the video decoding mode (a full resolution decoding mode or a reduced resolution decoding mode) for every picture, based on a reduced DPB sufficiency check; a video decoder LSI that decodes a compressed HDTV video data at resolutions assigned by the preparser; a picture decoding mode and picture address buffer that provides the decoding information of the related frames; an external memory having a reduced memory capacity for storing the decoded reference pictures and the input video stream; an AV I/O unit that scales the down-sampled data to the desired resolution if necessary; and a memory controller that controls the data accesses between the video decoder, the AV I/O unit and the external data memory, according to the information in the picture decoding mode and picture address buffer.

The input compressed video and audio streams are provided to the decoders via the peripheral interfaces (Step SP630) from external sources, such as SD card, a Hard disk drive, a DVD, a Blu-ray Disc (BD), a Tuner, the IEEE 1394 firewall, or any other source that may be used for connection to the peripheral interfaces via a Peripheral Component Interconnect (PCI) bus.

The stream controller performs two main functions, namely, (i) demultiplexing the audio and video stream for the audio decoder (Step SP603) and the video decoder, and (ii) regulating the retrieval of the input streams from the peripherals to the external memory (DRAM) (Step SP616), which has storage space dedicated for the video buffer according to the decoding standards. In the H.264 standards, the procedure for placing and removing portions of a bitstream is given in Section C.1.1 and C.1.2. The storage space dedicated for the video buffer must conform to the video buffer requirements of the decoding standards. For example, the maximum Coded Picture Buffer size (CPB) is 30,000,000 bits (3,750,000 bytes) for Level 4.0 of H.264. Level 4.0 is for HDTV use.

As described in the main Embodiment, the video buffer is increased in size to provide the decoder with extra buffer capacity for look-ahead preparsing. The maximum video bit rate for Level 4.0 of H.264, is 24 Mbps. To achieve an additional look-ahead preparsing with a delay of 0.333 s, additional video buffer storage of approximately 8 Megabits (1,000,000 bytes) is required. One frame of such bit rates takes 800,000 bits on average, and 10 frames takes 8,000,000 bits on average. The stream controller will retrieve the input streams according to the decoding standards. However, it will remove the streams from the video at a time delayed by 0.333 s from the intended removal time. This is because the actual decoding is delayed by 0.333 s so that the preparser can gather more information on the decoding mode of each frame before the actual decoding starts.

In addition to storing the maximum video buffer, the external DRAM stores the DPB. The maximum DPB size is 12,582,912 bytes for Level 4.0 of H.264. Together with a working buffer for pictures having 2048×1024 pixels, a total of 15,727,872 bytes is required for the external memory for frame memory storage. The external memory can be used for storage of other decoding parameters such as motion vector information which is used for motion compensation of co-located macroblocks.

In the design of the LSI system, the increase of video buffer size should be much less than the memory reduction achieved by using a reduced DPB. The DPB of H.264 Level 4.0 is capable of storing 4 full resolution frames. In the reduced memory design where the DPB is reduced to have a capability of handling only 2 full resolution frames, the frame memory capacity corresponds to 3 full resolution frames (2 in the DPB, and 1 in the working buffer). Whenever 4 reference frames are needed in the DPB, the 4 frames are stored at the half resolution (4→2 down-sampling is performed). A savings of 40% (6,291,456 bytes) of frame memory storage can be achieved because the frame memory needs to handle only 3 out of 5 frames having the full resolutions. The savings in the memory capacity is much higher than the increase in the video buffer size given earlier (1,000,000 bytes), and make the increase in video buffer justifiable.

To achieve a better image quality, the decoder can sacrifice a reduction in the frame memory storage of the DPB by reducing the DPB size by a smaller ratio. For example, the DPB can be designed to handle 3 full resolution frames instead of 4 at a reduced savings of 20% in the frame memory storage (3,145,728 bytes). The reduced frame memory is capable of storing only 4 out of 5 full resolution frames. Whenever 4 frames are needed in the reduced DPB, the frame memory stores the 4 frames at the resolution reduced by 25% (4→3 down-sampling is performed). It can be seen that the savings in the frame memory corresponds to 3,245,728 bytes that outweighs the increase in the video buffer size of 1,000,000 bytes by a big margin.

The preparser (Step SP601) parses the bitstream stored in the video buffer to determine the decoding mode of each frame (the full resolution or a reduced resolution). The preparser is started by the DTS, ahead of the actual decoding of the bitstream by a time margin provided by the increased buffer size. The actual decoding of the bitstream is delayed from the DTS by the same time margin provided by the increased video buffer. The preparser parses the higher layer information, such as Sequence parameter set (SPS) in AVC. If the number of reference frames used (num_ref_frames for H.264) are found to be less than or equal to the number of full reference frames which can be handled by the reduced DPB, the decoding mode for the frames according to this SPS are set to be the full decoding, and the picture resolution list for video decoding and memory management (Step SP602) is updated accordingly. If the number of reference frames used is greater than the number of frames having a full resolutions which can be handled by the reduced DPB, the lower syntax information (slice layer in the case of AVC) is examined to determine whether or not the full resolution decoding mode can be assigned to the processing of a particular frame. Full resolution decoding is selected whenever possible to avoid unnecessary visual distortion. The preparser ensures that (i) the usage of reference lists in the full DPB and in the reduced DPB are the same, and that (ii) the picture display order is correct before the full resolution decoding mode is assigned to a picture. Otherwise, the reduced resolution decoding mode is assigned. The picture resolution list is updated accordingly.

The syntax parsing and entropy decoding unit fetches the input compressed video from the external memory storage space designated as a video buffer (Step SP604) according to the DTS with a fixed delay for preparsing. The parameters for the decoder are parsed. Entropy decoding includes context-adaptive variable length decoding (CAVLD) and context-adaptive based arithmetic coding (CABAC) for H.264 decoders. The inverse quantizer then inversely quantizes the entropy decoded coefficients (Step SP605). Full resolution inverse transform is then performed (Step SP606).

The external memories commonly used are Double Data Rate (DDR) Synchronous Dynamic Random Access memories (SDRAMs). The read access and write access to the external buffer memory are controlled by the memory controller (Step SP615) that performs direct memory access (DMA) between the buffer or local memory in the LSI circuit and the external memory.

In motion compensation (Step SP614), the resolution of the reference frame used is obtained by reading the information in the picture resolution list. If the decoding mode of a reference frame is for using a reduced resolution, the memory controller (Step SP615) fetches the relevant pixels data from the external memory (Step SP616) and provides these data to the buffers of the up-sampling unit (Step SP610) using the motion vector and the starting address of the reference picture provided in the picture decoding mode and address buffer. Up-sampling is then performed to generate the up-sampled pixels for inverse motion compensation unit according to the up-sampling process described in Step SP310 where the embedded high order coefficient information are used. If the decoding mode of the reference frame is for using the full resolution, the memory controller (Step SP615) fetches the relevant pixel data from the external memory and provides these data to the buffers of the motion compensation unit (Step SP614).

The motion compensation unit performs image prediction at the full resolution to obtain prediction pixels. The inverse discrete cosine transform unit receives the inversely quantized coefficients and transforms these coefficients to obtain transformed pixels. If an intra-prediction block is present, intra-prediction is performed (Step SP608) using data from the neighboring blocks. The intra-predicted values, if present, are added to the inversely motion compensated pixels to obtain the prediction pixel values (Step SP609). The transformed pixels and the prediction pixels are then summed up to obtain reconstructed pixels (Step SP609). A deblocking filter process is performed if necessary to obtain the final reconstructed pixels (Step SP618). The picture decoding mode of the picture currently decoded is checked with reference to the picture decoding mode and picture address buffer. If the picture decoding mode for the picture is for using a reduced resolution, down-sampling (Step SP612) is performed with embedment of high order transform coefficients in the down-sampled data. The down-sampling unit is described in Step SP312 in the preferred Embodiment. The down-sampled data with high coefficient information embedded in the reduced resolution data are then transferred to the external memory (Step SP616) via the memory controller (Step SP615). If the picture decoding mode for the decoding picture is for using the full resolution, the down-sampling unit (Step SP612) is skipped and the reconstructed image data at the full resolution is sent to the external memory (Step SP616) via the memory controller (Step SP615).

The AV I/O unit (Step SP620) reads the information provided in the picture resolution list. The image data of the picture to be displayed is sent from the external memory (Step SP616) in display order depicted by the CODEC via the memory controller (Step SP615) to the input buffer of the AV I/O. The AV I/O unit then up-converts video data into video data having the desired resolution if necessary (based on the picture decoding mode), and outputs the video data in synchronization with the audio output. Only a generic AV I/O upscaling function is required to up-sample the reduced resolution pictures in this system because the reduced resolution data is spatially watermarked without distortion in the visual content having a reduced resolution.

The present invention avoids storage of reference frames not required in decoding of a current frame adaptively at the picture level, and performs full resolution decoding whenever possible to achieve a good visual quality by a video decoder with a reduced memory. If reduced resolution processing is performed, the present invention ensures that error propagation due to the reduced resolution is reduced to the minimum by embedding high order inverse transform coefficients in the reduced resolution data in a manner ensuring that the information gain in the embedment process is always greater than the information loss in the embedment process.

Alternative Simplified Exemplary System LSI without Preparser

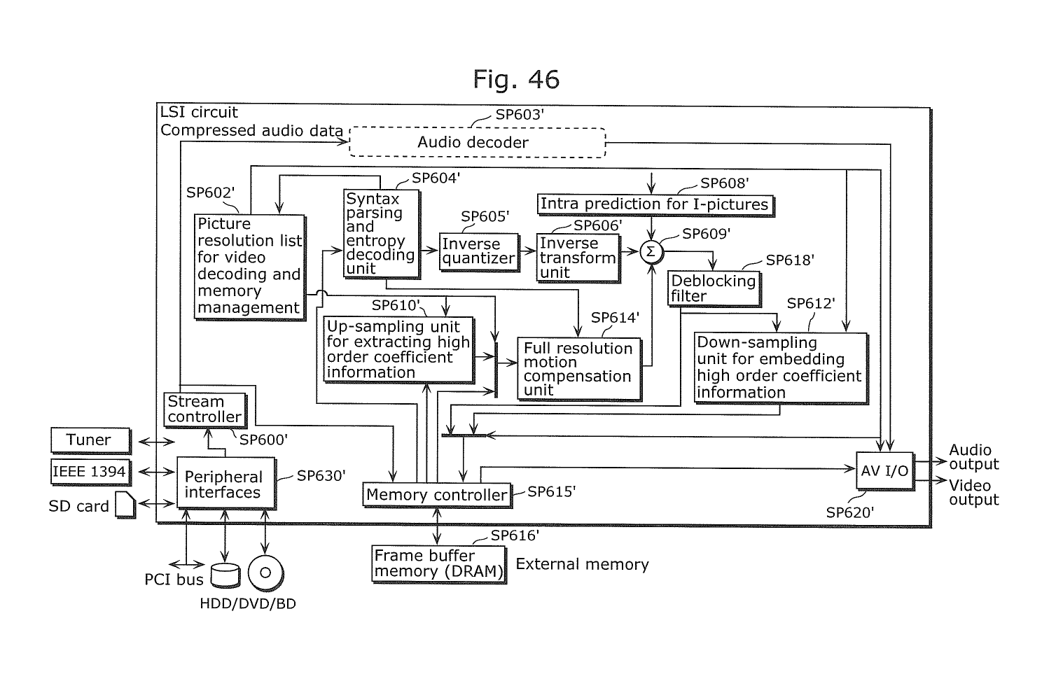

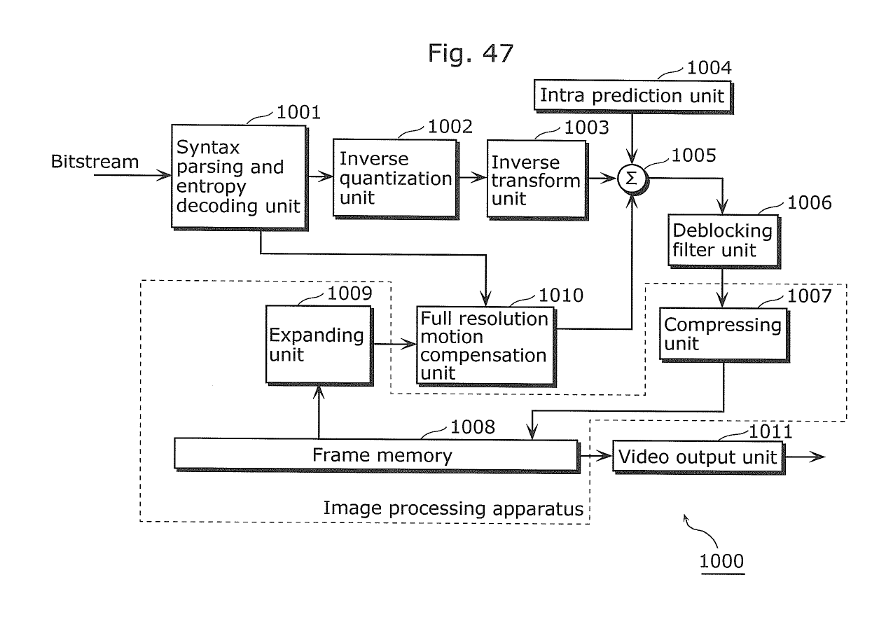

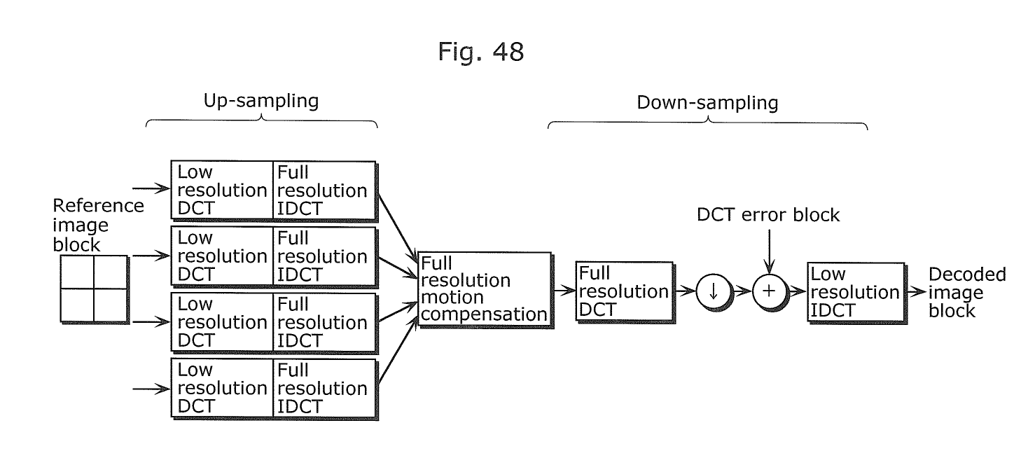

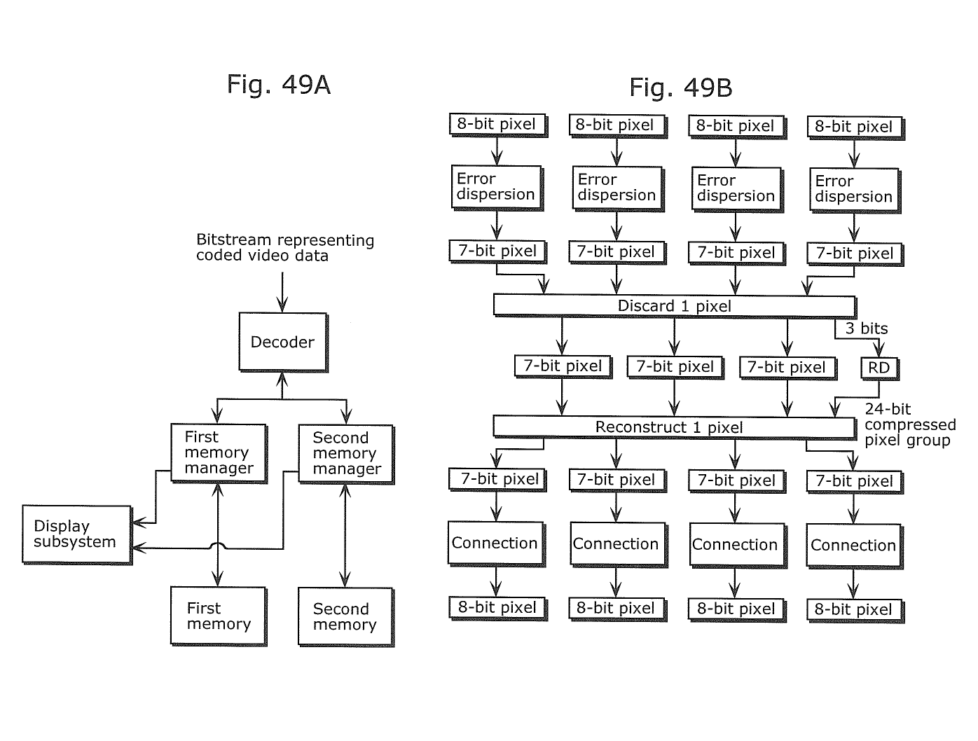

An exemplary alternative system LSI implementation that does not include a preparser is shown in FIG. 46. In this Embodiment, the syntax parsing and entropy decoding unit (Step SP604′) provides picture decoding resolutions to the picture resolution list (Step SP602′) instead of using a preparser. Step SP604′ checks the higher parameter layer for the number of reference frames to be used. In an H.264 decoder, the field “num_ref_frame” is checked in the SPS layer. Step SP240 (a sufficiency check of the reduced DPB for lower layer syntaxes) and Step SP260 are skipped in this exemplary alternative implementation. This alternative system is a simplified implementation that eliminates the need of having a preparser. However, in this system, the effectiveness of the present invention is reduced because only the higher layer parameters are examined.

Image processing apparatuses according to the present invention have been described above in Embodiments 1 to 6 and the Variations thereof. However, the present invention is not limited thereto. For example, the present invention may be implemented by arbitrarily combining technical details of Embodiments 1 to 6 and the Variations thereof within a consistent range, and may be implemented by modifying Embodiments 1 to 6 in various ways.

For example, in Embodiments 2 to 5, the embedding and down-sampling unit 107 and the extracting and up-sampling unit 109 performs discrete cosine transform (DCT), but any other transform may be used which is Fourier transform (DFT), Hadamard transform, Karhunen-Loeve transform (KLT), Legendre transform, or the like.

In Variation of Embodiment 2, the first processing mode and the second processing mode are switched in units of a sequence, based on the numbers of reference frames included in SPSs. However, such switching may be performed based on other information or another unit of processing (for example, a picture).

Specifically, each of the apparatuses according to Embodiments 1 to 6 and the Variations thereof is a computer system configured with a microprocessor, a ROM (Read Only Memory), a RAM (Random Access Memory), a hard disk unit, a display unit, a set of keyboards, a mouse, and the like. The RAM or hard disc unit includes a computer program recorded therein. Each apparatus executes the functions by means that the microprocessor operates according to the computer program. Here, the computer program is made using a combination of plural instruction codes each indicating an instruction to the computer in order to achieve predetermined functions.

Furthermore, a part or all of the structural units that constitute each of the apparatuses in Embodiments 1 to 6 and the Variations thereof may be configured in a single system LSI (Large Scale Integration). The system LSI is a super multi-functional LSI manufactured by integrating plural structural units on a single chip, and specifically is a computer system configured to include a microprocessor, a ROM, a RAM, and the like. The RAM includes a computer program recorded therein. The system LSI executes the functions by means that the microprocessor operates according to the computer program. The name used here is system LSI, but it may also be called IC, LSI, super LSI, or ultra LSI depending on the degree of integration. Moreover, ways to achieve integration are not limited to the LSI, and a special circuit or general purpose processor can also achieve the integration. A Field Programmable Gate Array (FPGA) that can be programmed after manufacturing an LSI or a reconfigurable processor that allows the connection or re-configuration of the circuit cells inside the LSI can be used for the same purpose.

In the future, the LSI may be replaced as a result of advancement in technology for manufacturing semiconductors or appearance of a circuit integration technology derived therefrom. The derived technology may be used to integrate the structural units. Application of biotechnology is one such possibility.

In addition, a part or all of the structural elements that constitute each of the apparatuses according to Embodiments 1 to 6 and Variations thereof may be configured with an IC card or a single module that can be attachable/detachable to/from each apparatus. The IC card or module is a computer system configured with a microprocessor, a ROM, a RAM, and the like. The IC card or module may include the aforementioned super multi-functional LSI. The IC card or module executes the functions by means that the microprocessor operates according to the computer program. The IC card or module may be tamper-resistant.

Furthermore, the present invention may be implemented as the above-described methods. Furthermore, the present invention may be implemented as computer programs causing computers to execute these methods, and as digital signals representing the computer programs.

Furthermore, the present invention may be implemented as computer-readable recording media on which the computer programs or digital signals are recorded. Examples of such recording media include flexible discs, hard discs, CD-ROMs (Compact Disk Read Only Memories), MOs (Magneto-Optical disk (disc)), DVDs (Digital Versatile Discs), DVD-ROMs, DVD-RAMs, BDs (Blu-ray Discs), and semiconductor memories. Furthermore, the present invention may be implemented as digital signals recorded on these recording media.

Furthermore, the present invention may be intended to distribute the computer programs or digital signals via electrical communication circuits, wireless or wired communication circuits, networks represented by the Internet, data broadcasting, and the like.

Furthermore, the present invention may be implemented as computer systems each including a microprocessor and a memory. The memory may include such a computer program recorded therein, and the microprocessor may operate according to the computer program.

Furthermore, the present invention may be executed by an independent computer system by means that such a program or digital signal recorded on a recording medium is transferred, or by means that such a program or digital signal is transferred via a network or the like.

### INDUSTRIAL APPLICABILITY

An image processing apparatus according to the present invention provides an advantageous effect of being able to reduce the bandwidth and capacity required for a frame memory, and concurrently prevent degradation in image quality. The image processing apparatus is applicable to, for example, personal computers, DVD/BD players, and televisions.

### REFERENCE SIGNS LIST

100 Image decoding apparatus
101 Syntax parsing and entropy decoding unit
102 Inverse quantization unit
103 Inverse frequency transform unit
104 Intra-prediction unit
105 Adding unit
106 Deblocking filter unit
107 Embedding and down-sampling unit
108 Frame memory
109 Extracting and up-sampling unit
110 Full resolution motion compensation unit
111 Video output unit

1. An image processing apparatus which sequentially processes a plurality of input images, said image processing apparatus comprising:
a selecting unit configured to selectively switch between a first processing mode and a second processing mode, for at least one input image;
a frame memory;
a storing unit configured to (i) down-sample one of the at least one input image by deleting predetermined frequency information included in the one of the at least one input image, and store the one of the at least one input image as a down-sampled image into said frame memory when said selecting unit switches to the first processing mode, and (ii) store the one of the at least one input image into said frame memory without down-sampling the one of the at least one input image when said selecting unit switches to the second processing mode; and
a reading unit configured to (i) read out the down-sampled image from said frame memory and up-sample the down-sampled image when said selecting unit switches to the first processing mode, and (ii) read out the input image that is not down-sampled from said frame memory when said selecting unit switches to the second processing mode.

2. The image processing apparatus according to claim 1, further comprising
a decoding unit configured to generate a decoded image by decoding a coded image included in a bitstream, with reference to, as a reference image, either the down-sampled image read out and up-sampled by said reading unit or the input image read out by said reading unit,
wherein said storing unit is configured to:
down-sample the decoded image generated by said decoding unit and used as the input image and store the decoded image as the down-sampled image into said frame memory when said selecting unit switches to the first processing mode; and
store the decoded image generated by said decoding unit and used as the input image into said frame memory without down-sampling the decoded image when said selecting unit switches to the second processing mode, and
said selecting unit is configured to selectively switch to either the first processing mode or the second processing mode, based on information related to the reference image and included in the bitstream.

3. The image processing apparatus according to claim 2,
wherein said storing unit is configured to replace a part of data indicating pixel values of the down-sampled image with embedded data indicating at least a part of the deleted frequency information when storing the down-sampled image into said frame memory, and
said reading unit is configured to up-sample the down-sampled image by extracting the embedded data from the down-sampled image, restoring the deleted frequency information based on the embedded data, and adding the deleted frequency information to the down-sampled image from which the embedded data has been extracted.

4. The image processing apparatus according to claim 3,
wherein said storing unit is configured to decrease the number of pixels in a horizontal direction of the input image by down-sampling the input image in the horizontal direction, and
said reading unit is configured to increase the number of pixels in the horizontal direction of the down-sampled image by up-sampling the reference image in a horizontal direction.

5. The image processing apparatus according to claim 3,
wherein said storing unit is configured to replace, with the embedded data, a value indicated by one or more bits including at least an LSB (Least Significant Bit) in the data indicating the pixel value of the down-sampled image.

6. The image processing apparatus according to claim 3,
wherein said storing unit includes:
a first orthogonal transform unit configured to transform the input image from a pixel domain to a frequency domain;
a deleting unit configured to delete predetermined high frequency components as the frequency information from the input image of the frequency domain;
a first inverse orthogonal transform unit configured to transform the input image from which the high frequency components have been deleted, from a frequency domain to a pixel domain; and
an embedding unit configured to replace a part of the data indicating the pixel values of the input image transformed by said first inverse orthogonal transform unit with the embedded data indicating at least a part of the deleted high frequency components.

7. The image processing apparatus according to claim 6,
wherein said reading unit includes:
an extracting unit configured to extract the embedded data included in the down-sampled image;
a restoring unit configured to restore the high frequency components from the extracted embedded data;
a second orthogonal transform unit configured to transform the down-sampled image from which the embedded data has been extracted from a pixel domain to a frequency domain;
an adding unit configured to add the high frequency components to the down-sampled image of the frequency domain; and
a second inverse orthogonal transform unit configured to transform the down-sampled image to which the high frequency components have been added from a frequency domain to a pixel domain.

8. The image processing apparatus according to claim 7,
wherein said storing unit further includes
a coding unit configured to generate the embedded data by performing variable length coding on the high frequency components that are deleted by said deleting unit, and
said restoring unit is configured to restore the high frequency components from the embedded data by performing variable length decoding on the embedded data.

9. The image processing apparatus according to claim 7,
wherein said storing unit further includes
a quantization unit configured to generate the embedded data by quantizing the high frequency components that are deleted by said deleting unit, and
said restoring unit is configured to restore the high frequency components from the embedded data by inversely quantizing the embedded data.

10. The image processing apparatus according to claim 7,
wherein said extracting unit is configured to extract the embedded data indicated by the at least one predetermined bit in the data composed of a bit string indicating the pixel value of the down-sampled image, and set the pixel value from which the embedded data has been extracted to a median value within a possible range for the bit string, according to a value of the at least one predetermined bit, and
said second orthogonal transform unit is configured to transform the down-sampled image having the pixel value set to the median value from a pixel domain to a frequency domain.

11. The image processing apparatus according to claim 3,
wherein said storing unit is configured to determine, based on the down-sampled image, whether or not the part of the data indicating the pixel values of the down-sampled image should be replaced with the embedded data, and when determining that the replacement should be performed, replace the part of the data indicating the pixel values of the down-sampled image with the embedded data, and
said reading unit is configured to determine, based on the down-sampled image, whether or not the embedded data should be extracted, and when determining that the extraction should be performed, extract the embedded data from the down-sampled image and add the frequency information to the down-sampled image from which the embedded data has been extracted.

12. The image processing apparatus according to claim 7,
wherein said first and second orthogonal transform units are configured to transform the image from the pixel domain to the frequency domain by performing discrete cosine transform on the image, and
said first and second inverse orthogonal transform units are configured to transform the image from the frequency domain to the pixel domain by performing inverse cosine transform on the image.

13. The image processing apparatus according to claim 12,
wherein a transform target size in the discrete cosine transform and the inverse discrete cosine transform is a 4×4 size.

14. The image processing apparatus according to claim 3,
wherein said decoding unit includes:
an inverse frequency transform unit configured to generate a difference image by performing inverse frequency transform on the coded image;
a motion compensation unit configured to generate a prediction image of the coded image by performing motion compensation with reference to the reference image; and
an adding unit configured to generate the decoded image by adding the difference image and the prediction image.

15. An image processing method of sequentially processing a plurality of input images, said image processing method comprising:
selectively switching between a first processing mode and a second processing mode, for at least one input image;
(i) down-sampling one of the at least one input image by deleting predetermined frequency information included in the one of the at least one input image, and storing the one of the at least one input image as a down-sampled image into a frame memory when said switching is performed to the first processing mode, and (ii) storing the one of the at least one input image into the frame memory without down-sampling the one of the at least one input image when said switching is performed to the second processing mode; and
(i) reading out the down-sampled image from the frame memory and up-sampling the down-sampled image when said switching is performed to the first processing mode, and (ii) reading out the input image that is not down-sampled from the frame memory when said switching is performed to the second processing mode.

16. A program for sequential processing of a plurality of input images, said program causing a computer to execute:
selectively switching between a first processing mode and a second processing mode, for at least one input image;
(i) down-sampling one of the at least one input image by deleting predetermined frequency information included in the one of the at least one input image, and storing the one of the at least one input image as a down-sampled image into a frame memory when the switching is performed to the first processing mode, and (ii) storing the one of the at least one input image into the frame memory without down-sampling the one of the at least one input image when the switching is performed to the second processing mode; and
(i) reading out the down-sampled image from the frame memory and up-sampling the down-sampled image when the switching is performed to the first processing mode, and (ii) reading out the input image that is not down-sampled from the frame memory when the switching is performed to the second processing mode.

17. An integrated circuit which sequentially processes a plurality of input images, said integrated circuit comprising:
a selecting unit configured to selectively switch between a first processing mode and a second processing mode, for at least one input image;
a storing unit configured to (i) down-sample one of the at least one input image by deleting predetermined frequency information included in the one of the at least one input image, and store the one of the at least one input image as a down-sampled image into said frame memory when said selecting unit switches to the first processing mode, and (ii) store the one of the at least one input image into said frame memory without down-sampling the one of the at least one input image when said selecting unit switches to the second processing mode; and
a reading unit configured to (i) read out the down-sampled image from said frame memory and up-sample the down-sampled image when said selecting unit switches to the first processing mode, and (ii) read out the input image that is not down-sampled from said frame memory when said selecting unit switches to the second processing mode.
